(19) United States
(12) Patent Application Publication
(10) Pub. No.: US 2024/0203066 A1
(43) Pub. Date: Jun. 20, 2024

(54) METHODS FOR IMPROVING USER ENVIRONMENTAL AWARENESS

(71) Applicant: Apple Inc., Cupertino, CA (US)

(72) Inventors: Ieyuki KAWASHIMA, Pleasanton, CA (US); Benjamin HYLAK, San Francisco, CA (US); Garrett L. WEINBERG, Santa Cruz, CA (US); Joshua R. FORD, San Francisco, CA (US); Maxime UZAN, San Francisco, CA (US); Pavel V. DUDRENOV, San Francisco, CA (US); Katherine W. KOLOMBATOVICH, San Francisco, CA (US); Giancarlo YERKES, San Francisco, CA (US); Lee S. BROUGHTON, Santa Cruz, CA (US)

(21) Appl. No.: 18/473,239

(22) Filed: Sep. 23, 2023

Related U.S. Application Data
(60) Provisional application No. 63/376,961, filed on Sep. 23, 2022.
(60) Provisional application No. 63/506,095, filed on Jun. 4, 2023.

(51) Int. Cl. G06T 19/00; G06F 3/01; G06F 3/04847; G06F 3/0485; G06T 7/70; G06V 40/10; G06V 40/20; G10L 25/78

(52) U.S. Cl. CPC G06T 19/006; G06F 3/013; G06F 3/04847; G06F 3/0485; G06T 7/70; G06V 40/103; G06V 40/20; G10L 25/78

(57) ABSTRACT

In some embodiments, a computer system displays virtual content illustrating an area of likely interaction, and displays immersive virtual content. In some embodiments, a computer system reduces visual prominence of immersive virtual content and displays an area of likely interaction. In some embodiments, a computer system generates alerts associated with physical objects in an environment of a user. In some embodiments, a computer system changes the visual prominence of people in a three-dimensional environment based on one or more attention-related factors.

### CROSS-REFERENCE TO RELATED APPLICATIONS

This application claims the benefit of U.S. Provisional Application No. 63/376,961, filed Sep. 23, 2022, and U.S. Provisional Application No. 63/506,095, filed Jun. 4, 2023, the contents of which are herein incorporated by reference in their entireties for all purposes.

### TECHNICAL FIELD

This relates generally to computer systems that provide computer-generated experiences, including, but no limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with content in a three-dimensional environment. Such methods and interfaces may complement or replace conventional methods for interacting with content in a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system displays virtual content illustrating an area of likely interaction, and displays immersive virtual content. In some embodiments, a computer system ceases display of immersive virtual content, and displays the area of likely interaction. In some embodiments, a computer system generates an alert for a physical object that is obscured by virtual content based on attention. In some embodiments, a computer system reduces the visual prominence of virtual content for people in a physical environment based on attention.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7D illustrate examples of a computer system displaying virtual content illustrating an area of likely interaction, and displaying immersive virtual content in accordance with some embodiments.

FIGS. 8A-8F is a flowchart illustrating an exemplary method displaying virtual content illustrating an area of likely interaction, and displaying immersive virtual content in accordance with some embodiments.

FIGS. 9A-9E illustrate examples of a computer system reducing visual prominence of immersive virtual content and displaying an area of likely interaction in accordance with some embodiments.

FIGS. 10A-10G is a flowchart illustrating a method of reducing visual prominence of immersive virtual content and displaying an area of likely interaction in accordance with some embodiments.

FIGS. 11A-11E illustrate examples of a computer system generating alerts associated with physical objects in an environment of a user in accordance with some embodiments.

FIGS. 12A-12D is a flowchart illustrating a method of generating alerts associated with physical objects in an environment of a user in accordance with some embodiments.

FIGS. 13A-13H illustrate examples of a computer system changing the visual prominence of people in a three-dimensional environment based on one or more attention-related factors in accordance with some embodiments.

FIGS. 14A-14H is a flowchart illustrating a method of changing the visual prominence of people in a three-dimensional environment based on one or more attention-related factors in accordance with some embodiments.

### DESCRIPTION OF EMBODIMENTS

The present disclosure relates to user interfaces for providing a computer generated (CGR) experience to a user, in accordance with some embodiments.

The systems, methods, and GUIs described herein provide improved ways for an electronic device to facilitate interaction with and manipulate objects in a three-dimensional environment.

In some embodiments, a computer system detects an input corresponding to a request to display of virtual content at a level of immersion greater than a threshold level of immersion. In some embodiments, the computer system displays a visual indication corresponding to a region of likely interaction with the virtual content. In some embodiments, the input includes movement of a user of the computer system into a region of the user's physical environment corresponding to the visual indication. In some embodiments, the computer system maintains display of a portion of a representation of the user's environment while displaying the virtual content at the level of immersion greater than the threshold level of immersion.

In some embodiments, a computer system detects an input corresponding to a request to reduce visual prominence of virtual content. In some embodiments, the input includes movement of a user of the computer system out of a region of the user's physical environment in which the computer system expects likely interaction with the virtual content. In some embodiments, the reducing of visual prominence includes ceasing display of the virtual content.

In some embodiments, a computer system displays virtual content that obscures a physical object in the physical environment of the user. In some embodiments, in accordance with a determination that the physical object is likely to conflict with the user's range of movement, the computer system generates an alert indicating the presence of the physical object. In some embodiments, based on the attention of the user directed to the alert, the computer system reduces, maintains, or increased the prominence of the alert.

In some embodiments, a computer system displays virtual content that obscures a person in a physical environment of the computer system. In some embodiments, the computer system breaks through the virtual content to allow visibility of the person through the virtual content. In some embodiments, the computer system changes the visibility of the person through the virtual content based on attention of the user and/or person.

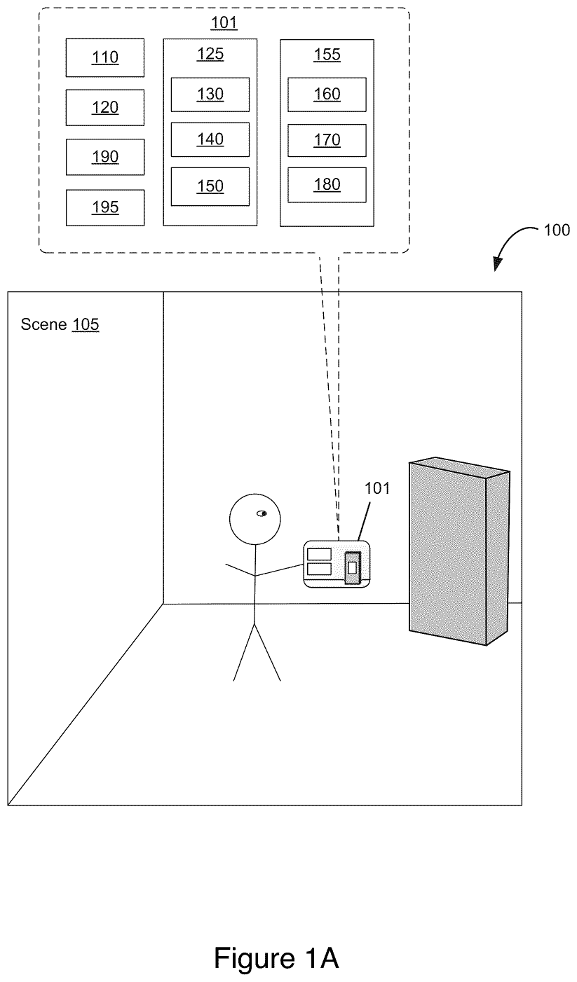

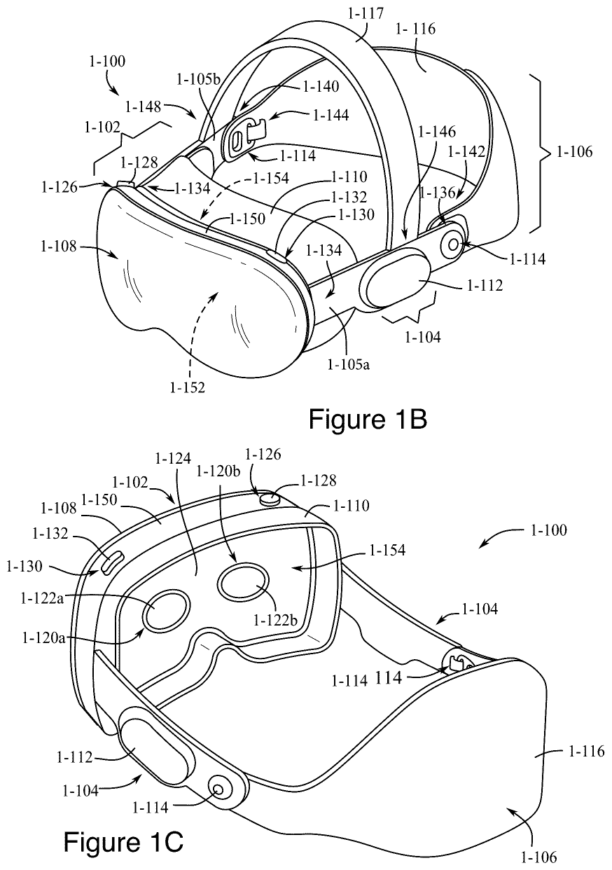

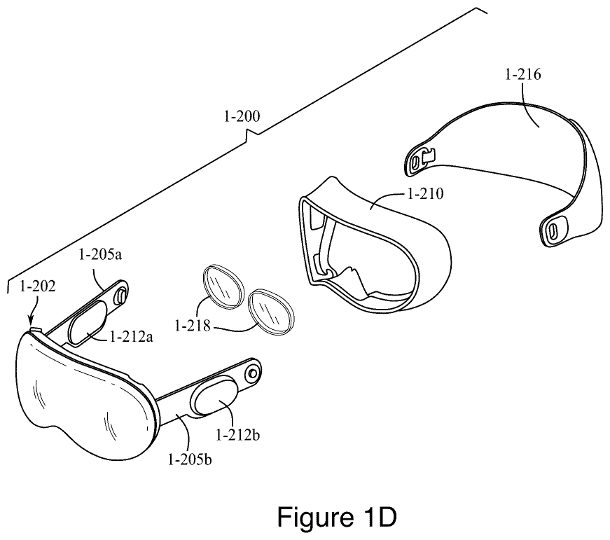

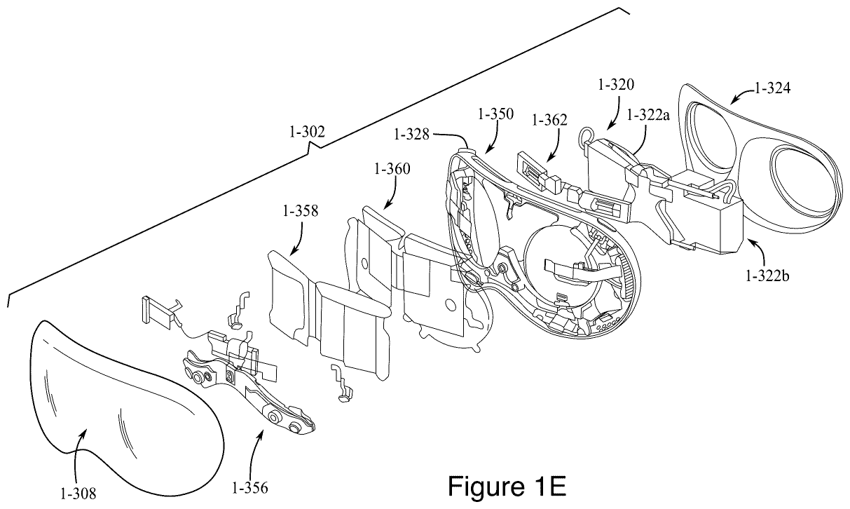

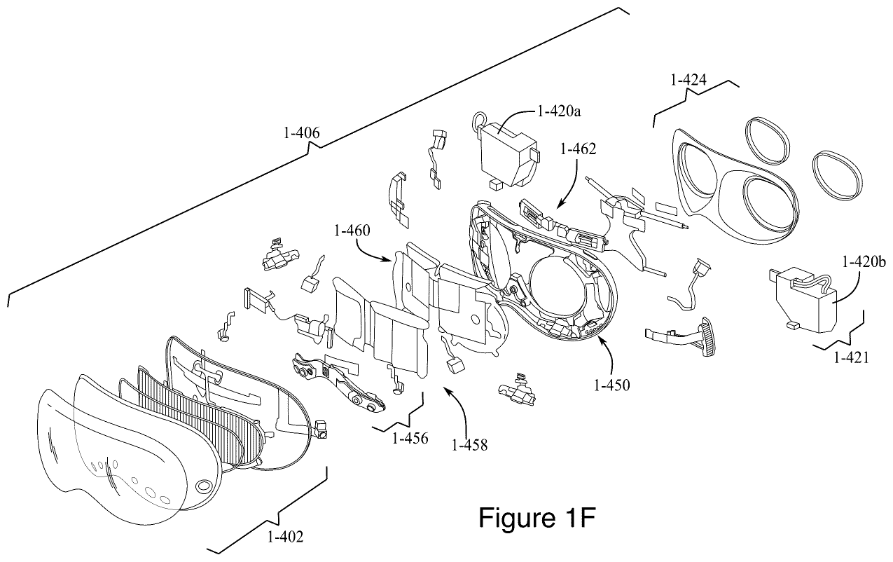

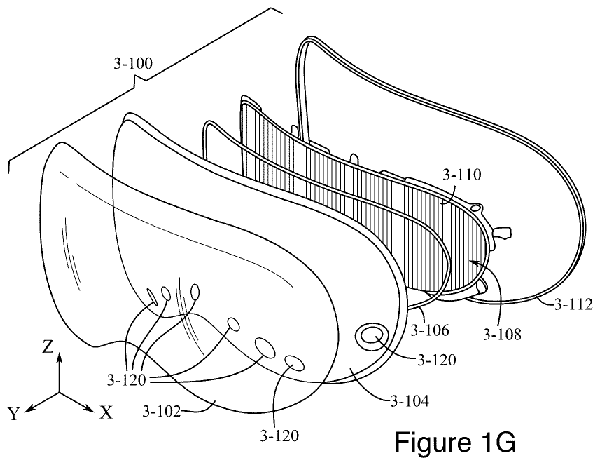

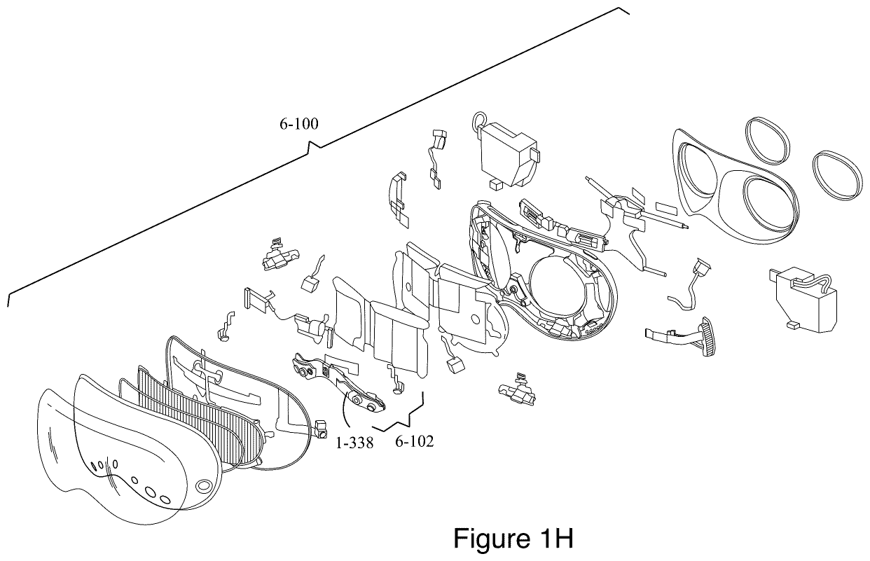

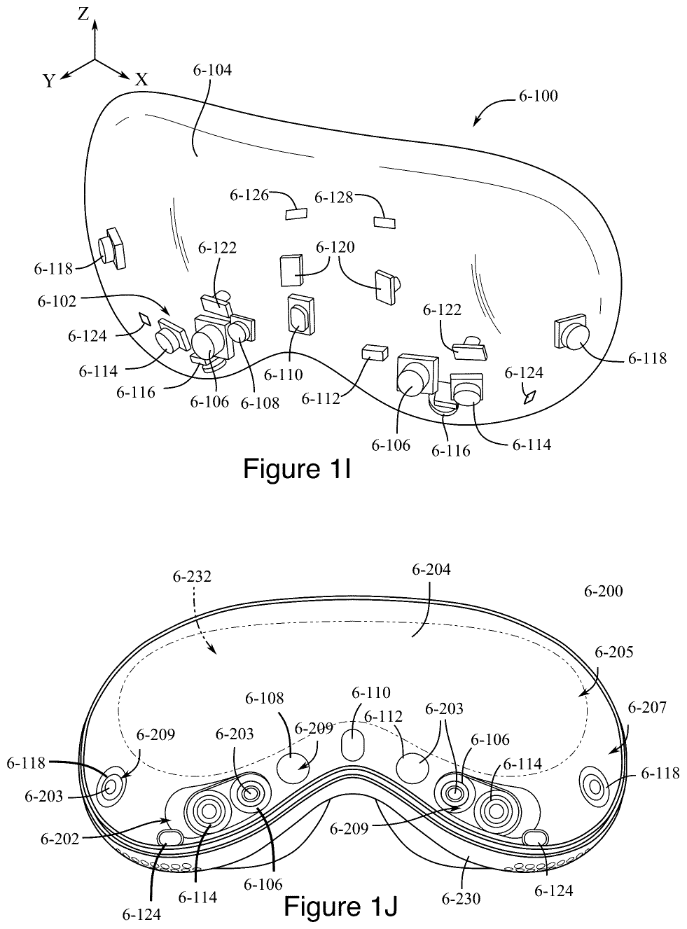

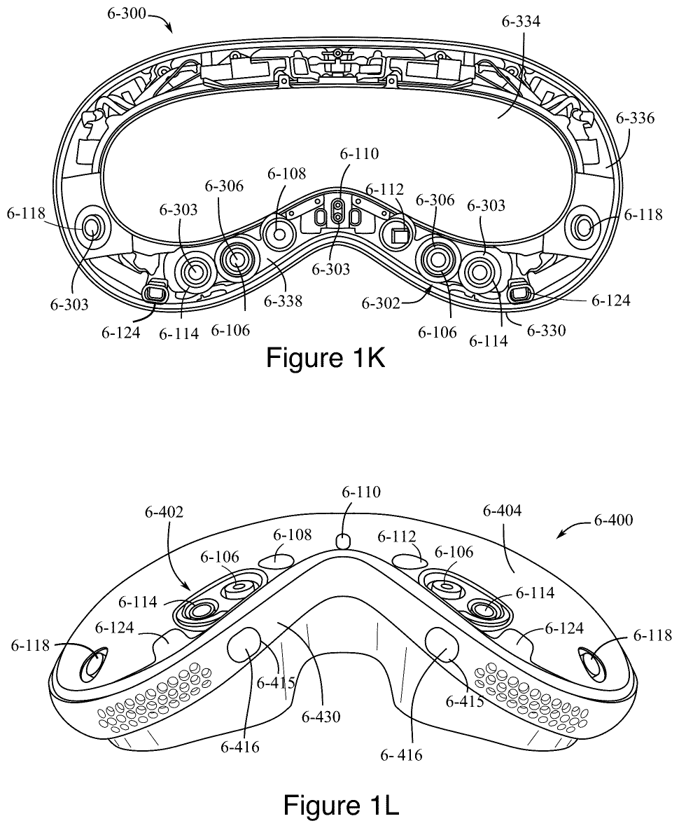

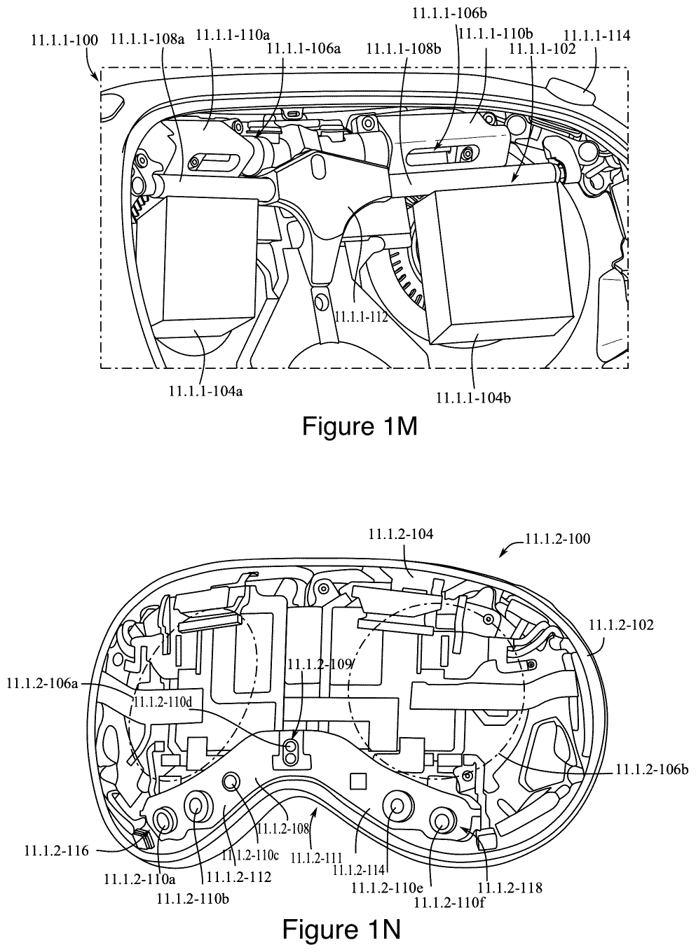

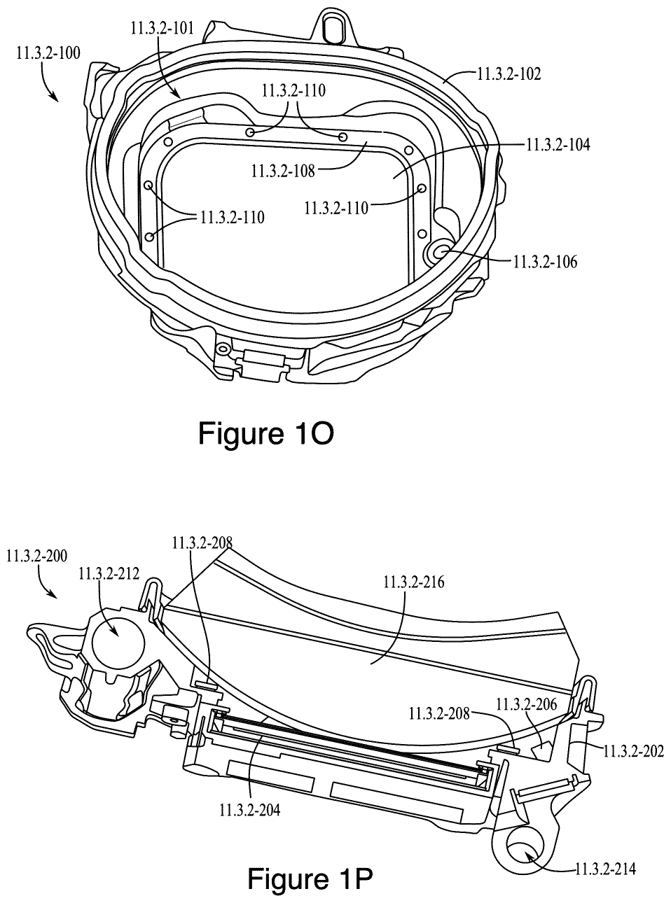

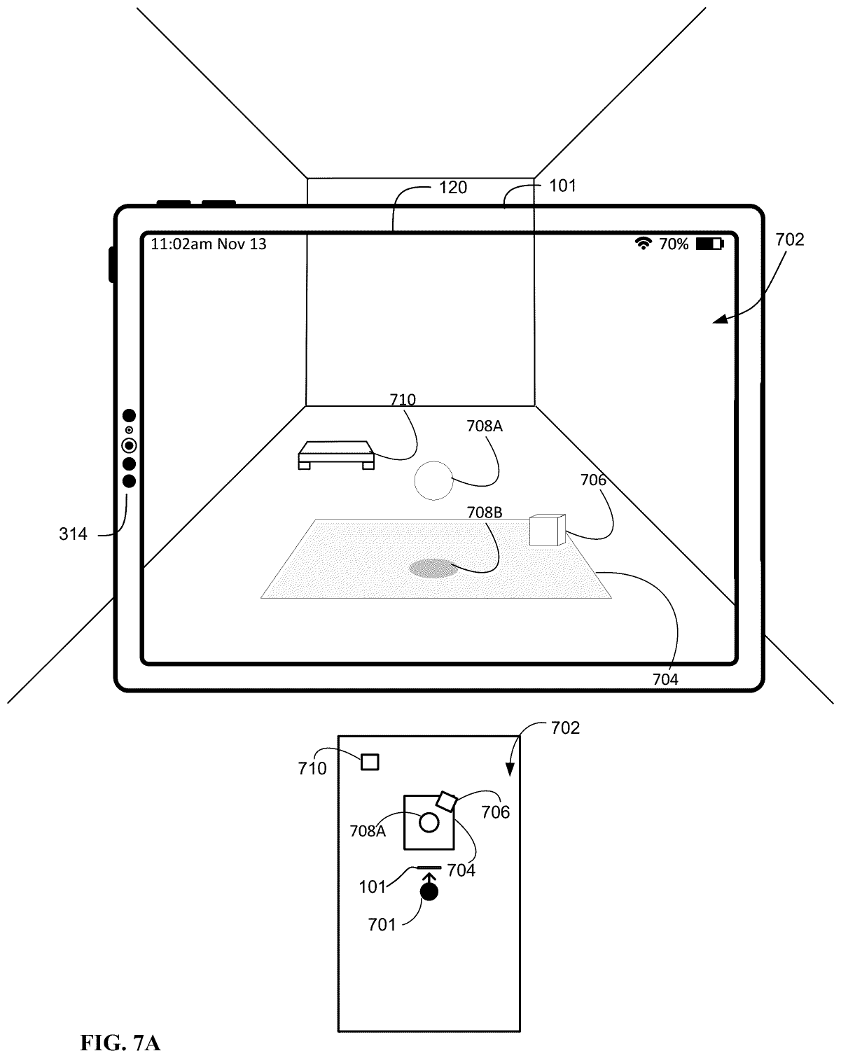

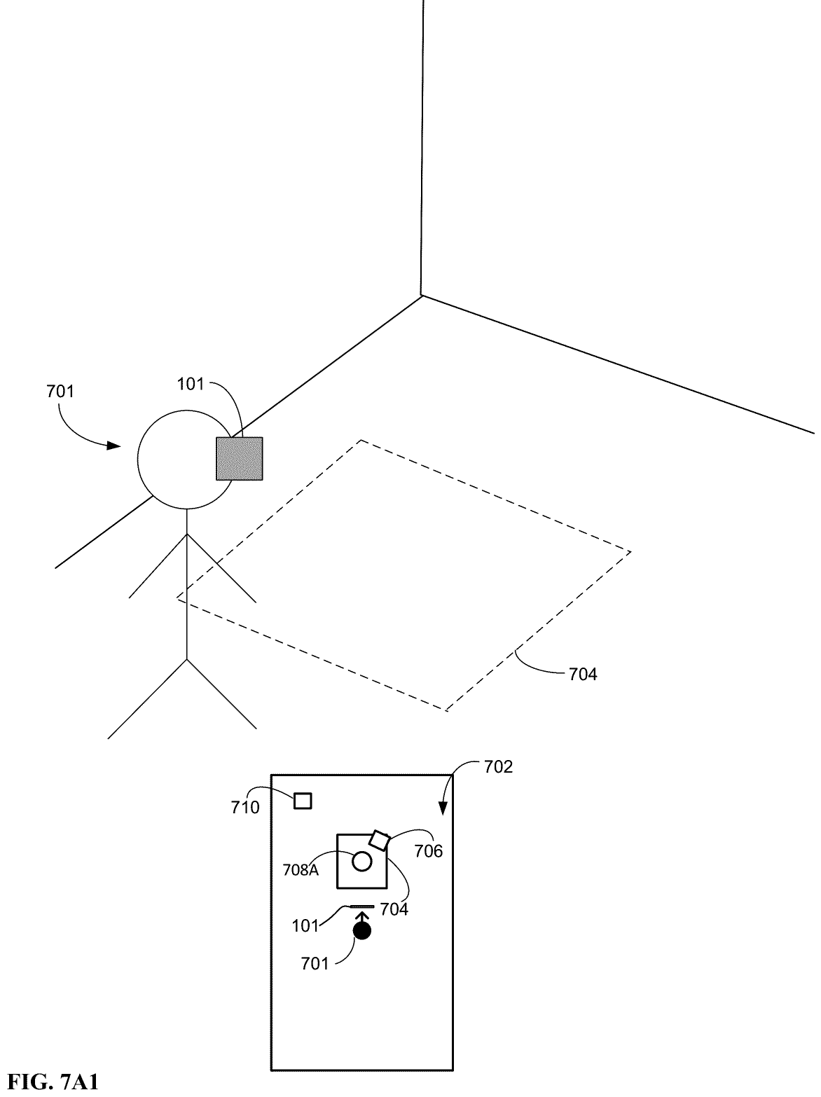

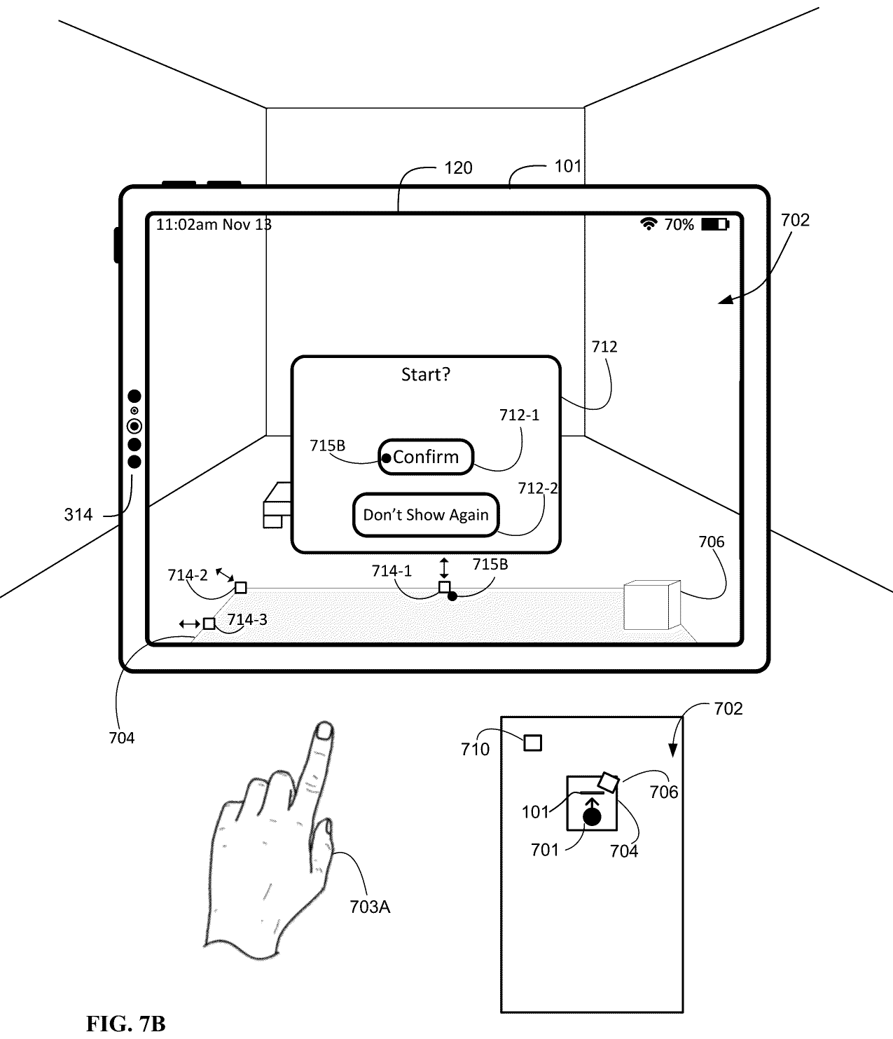

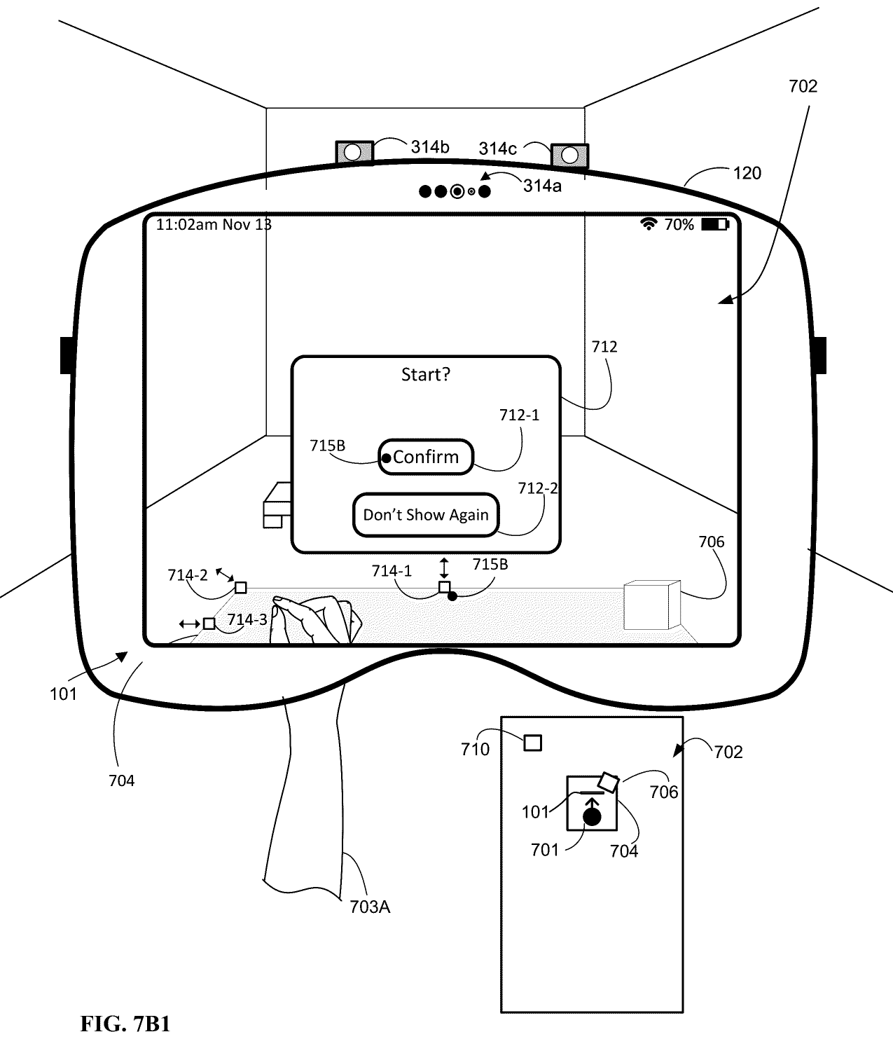

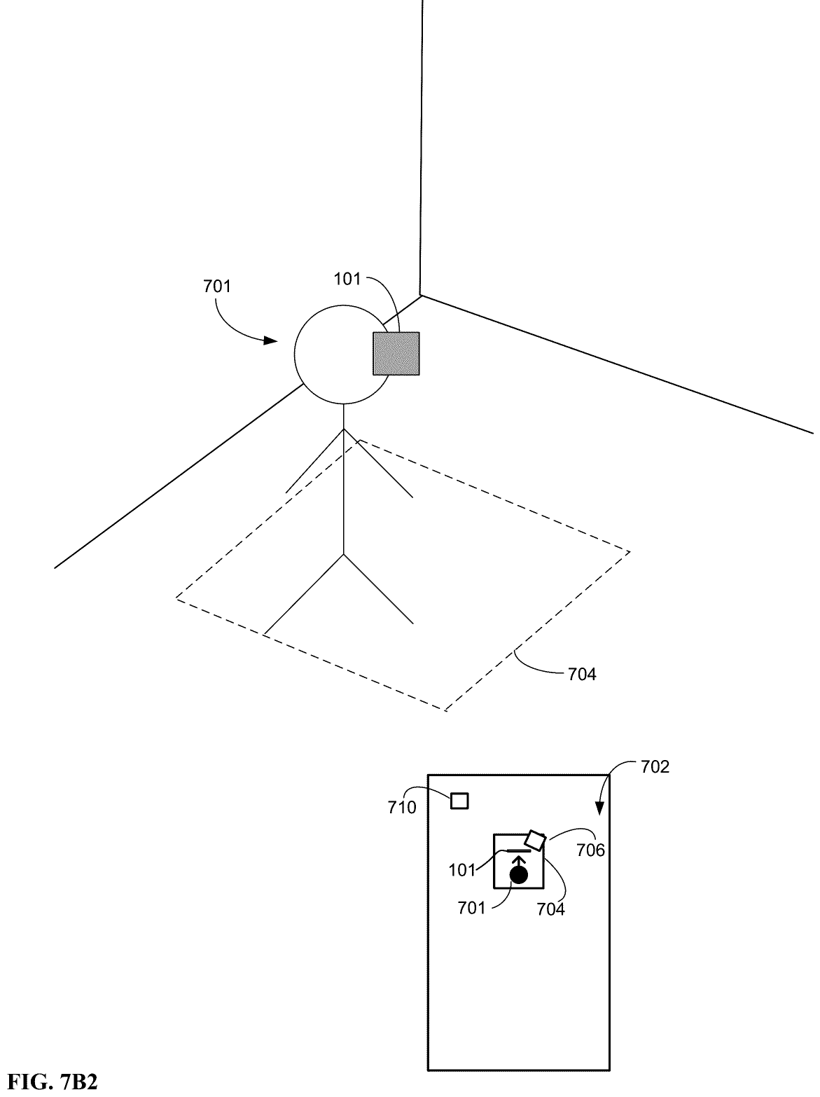

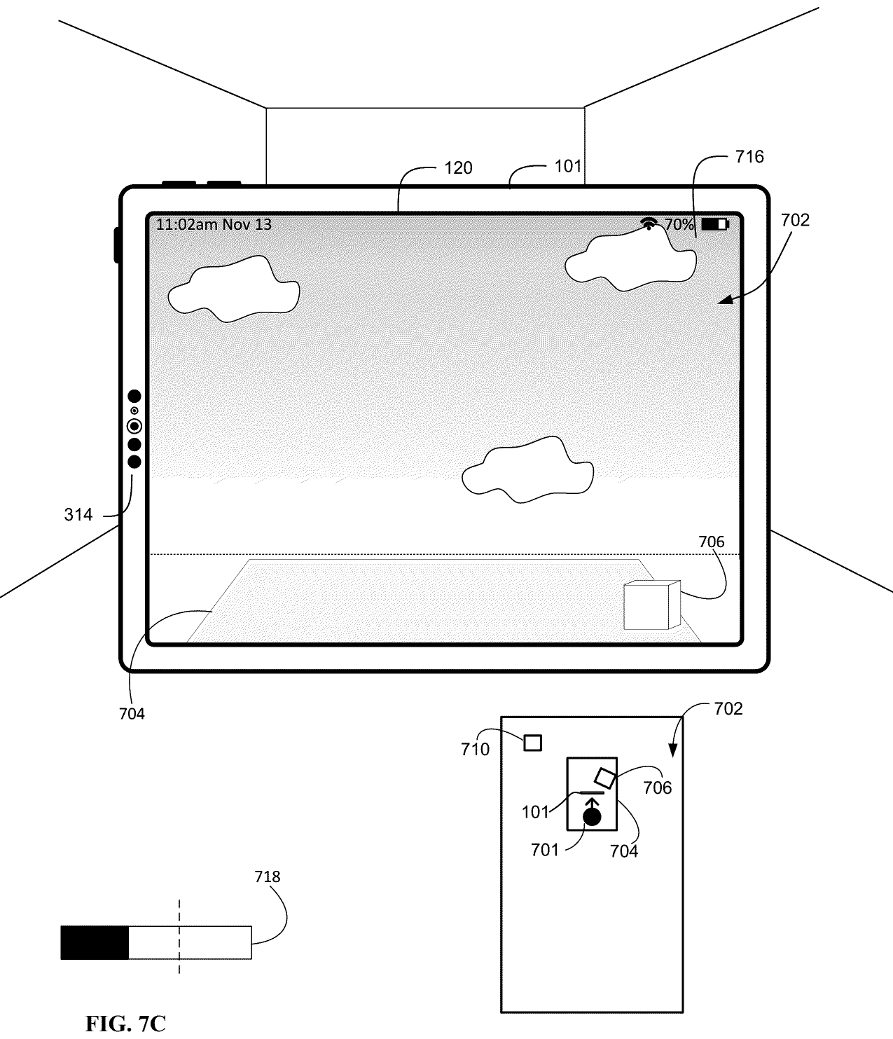

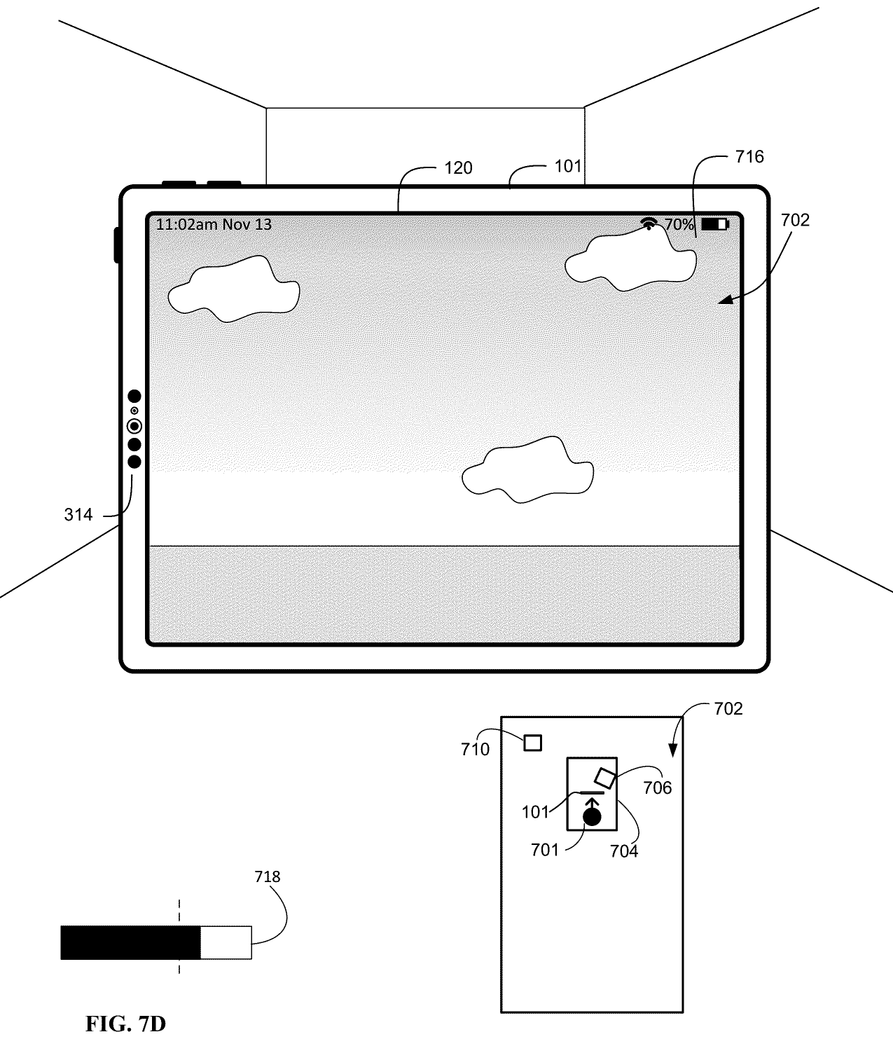

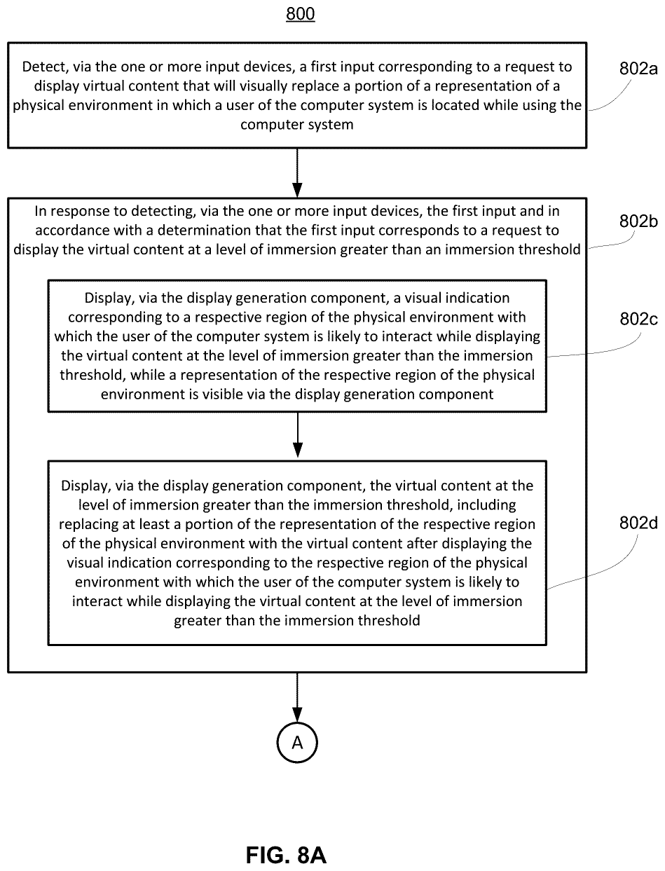

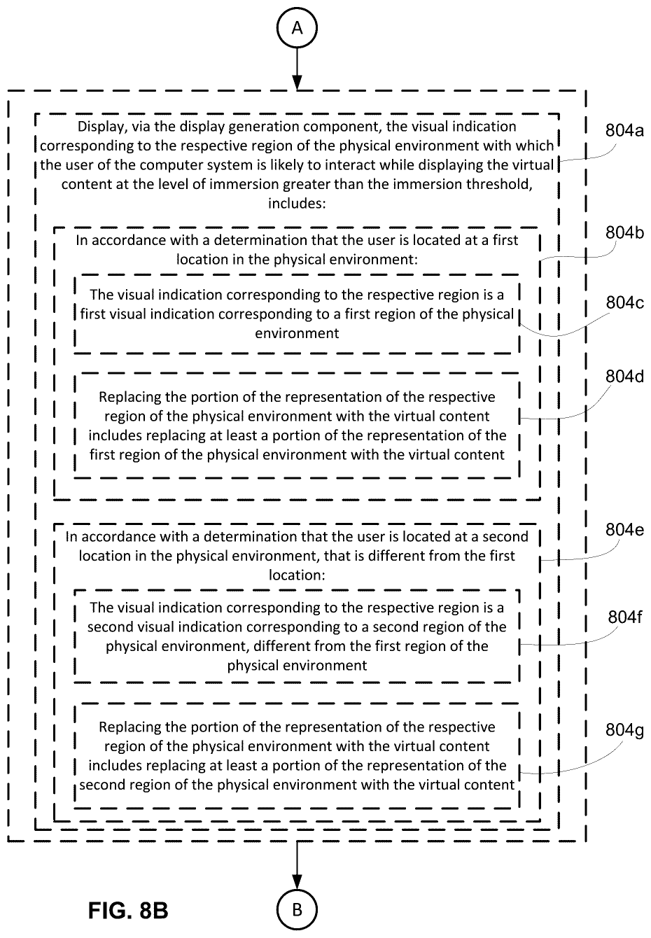

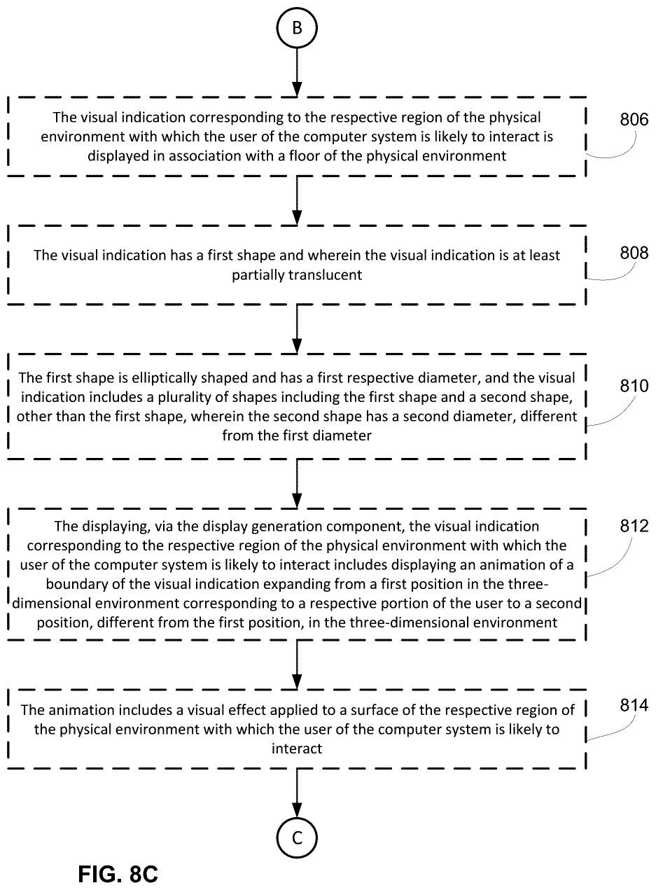

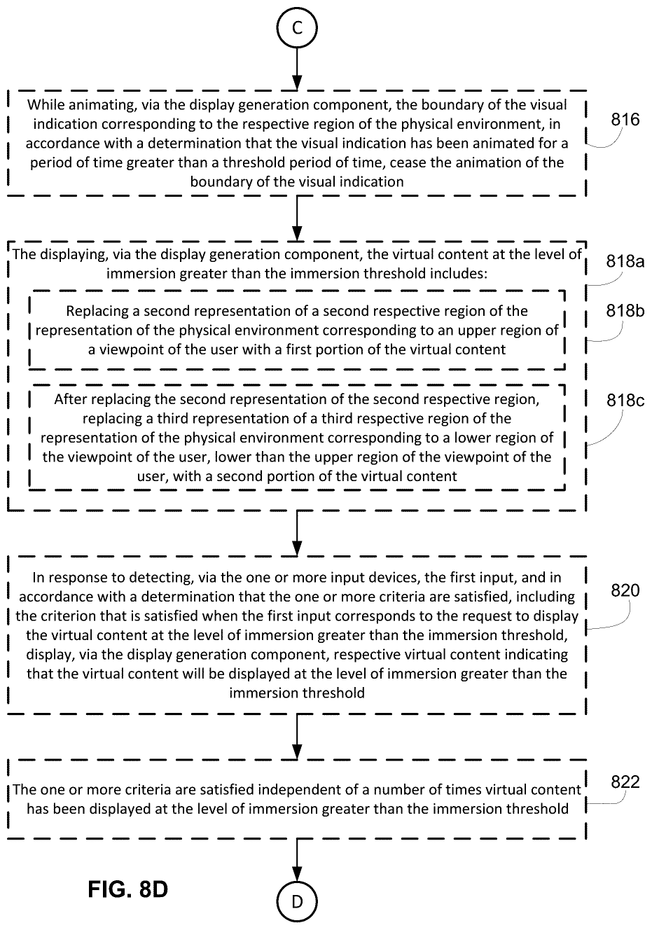

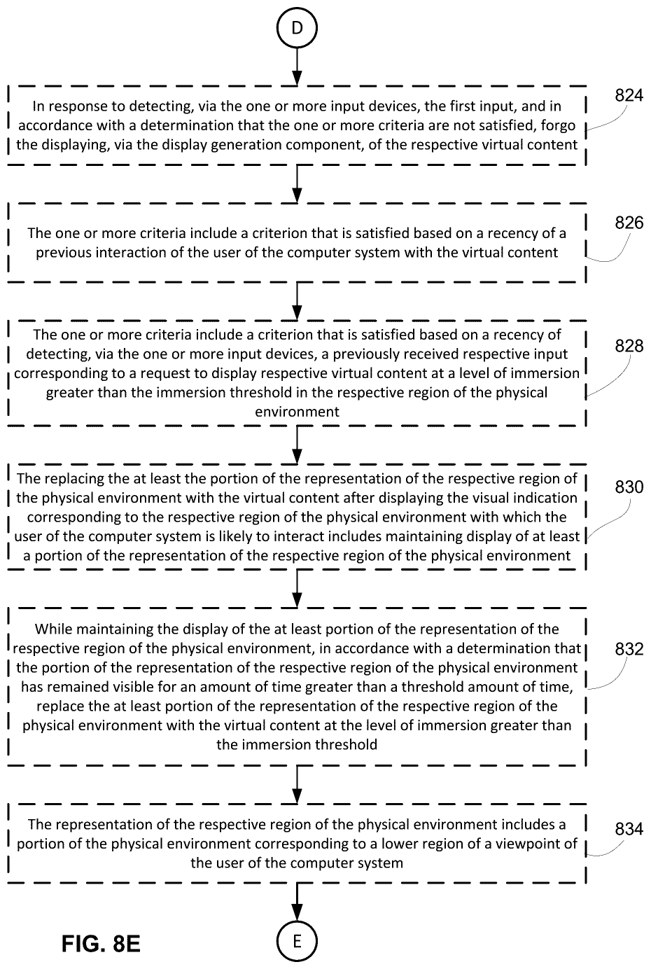

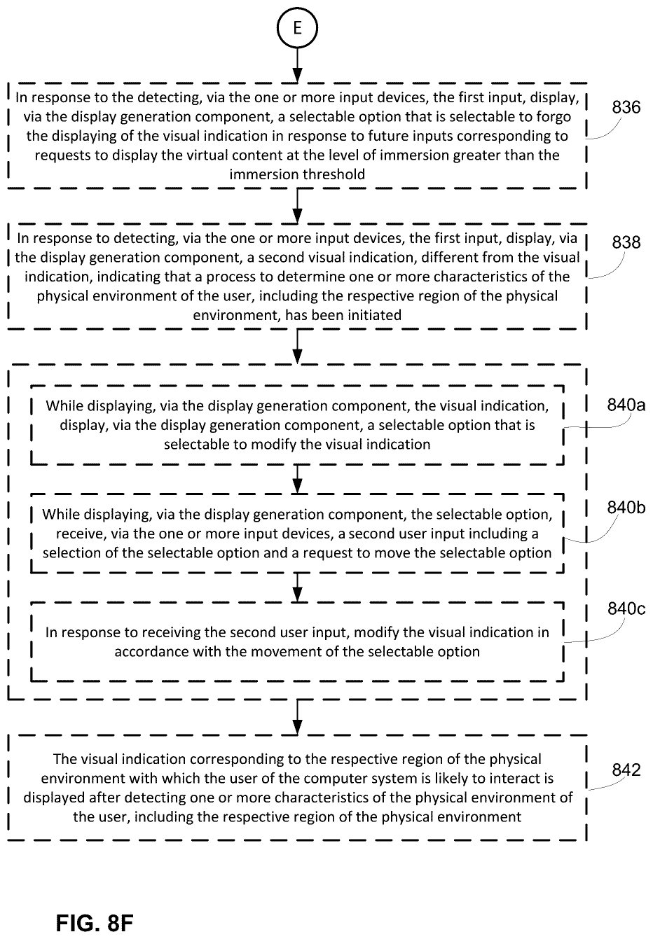

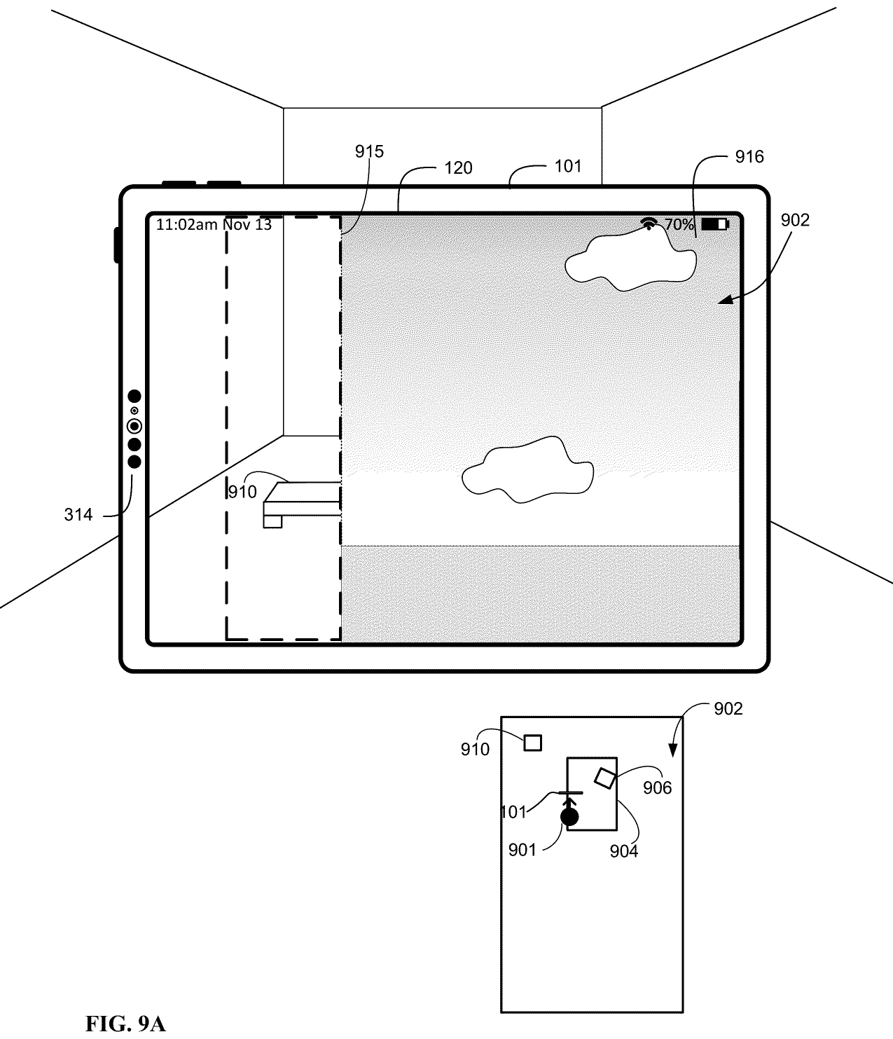

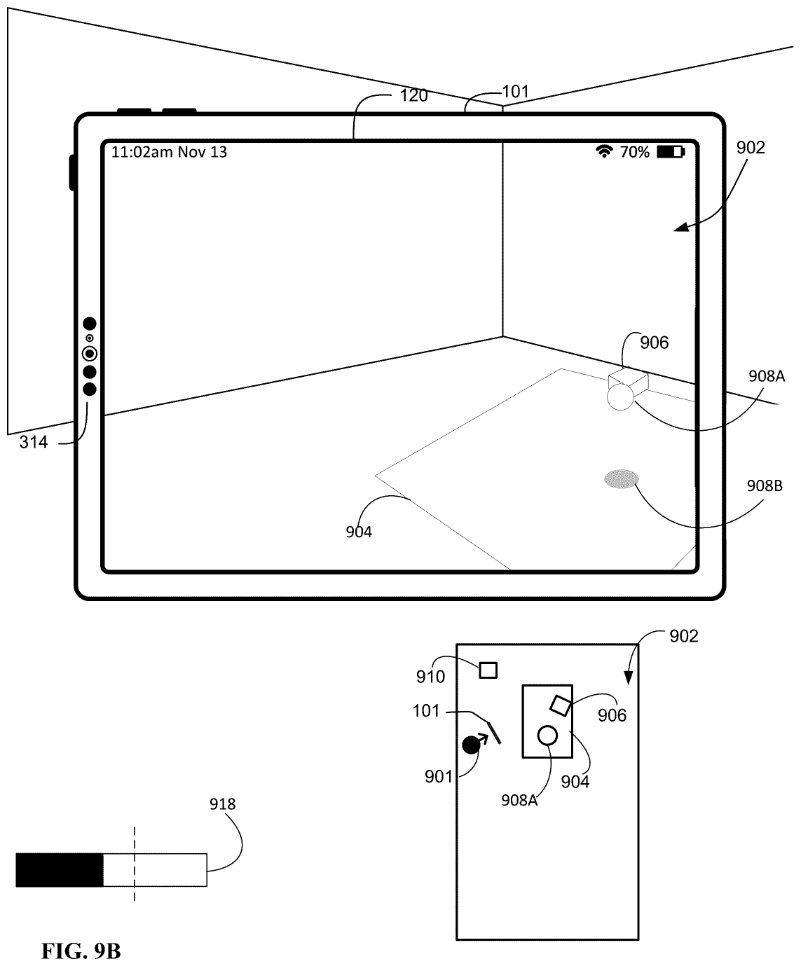

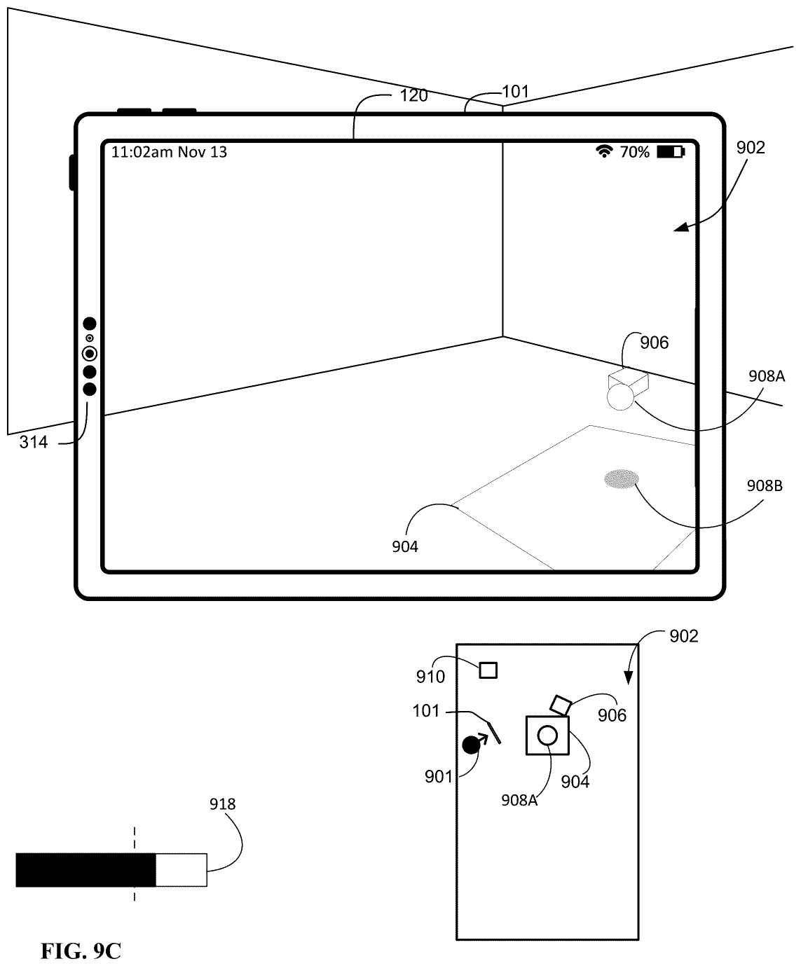

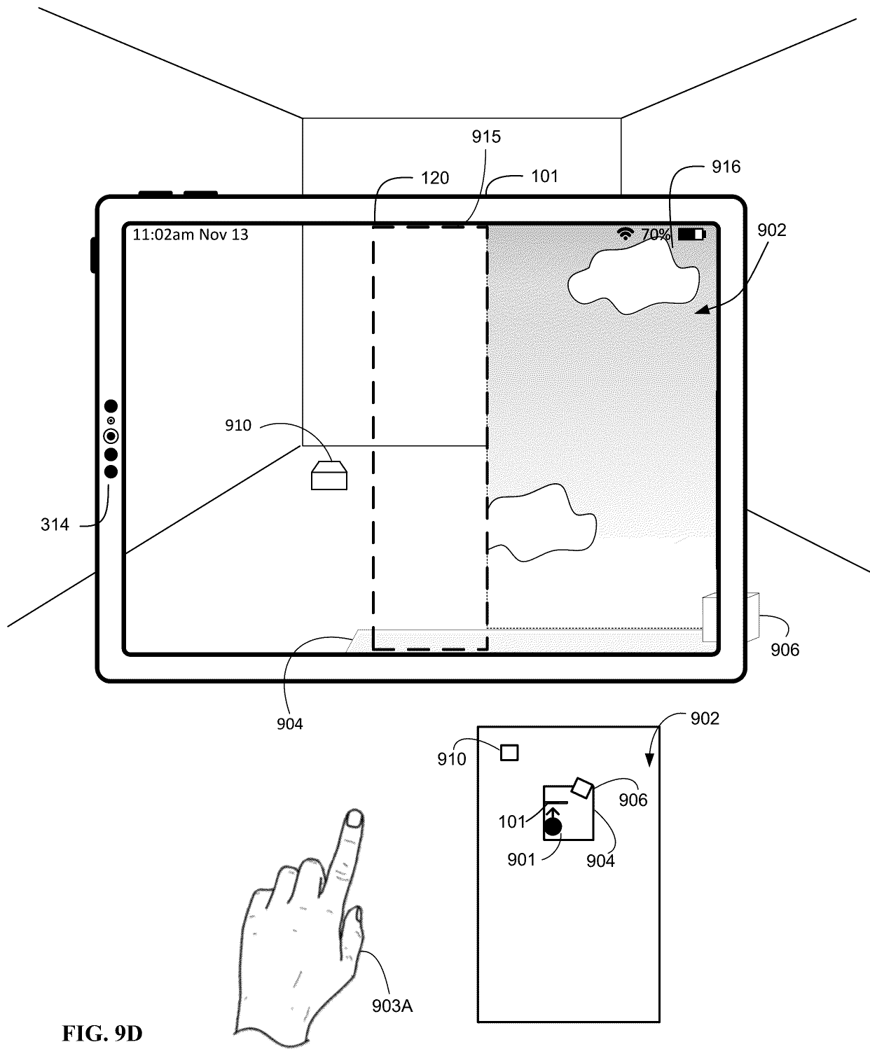

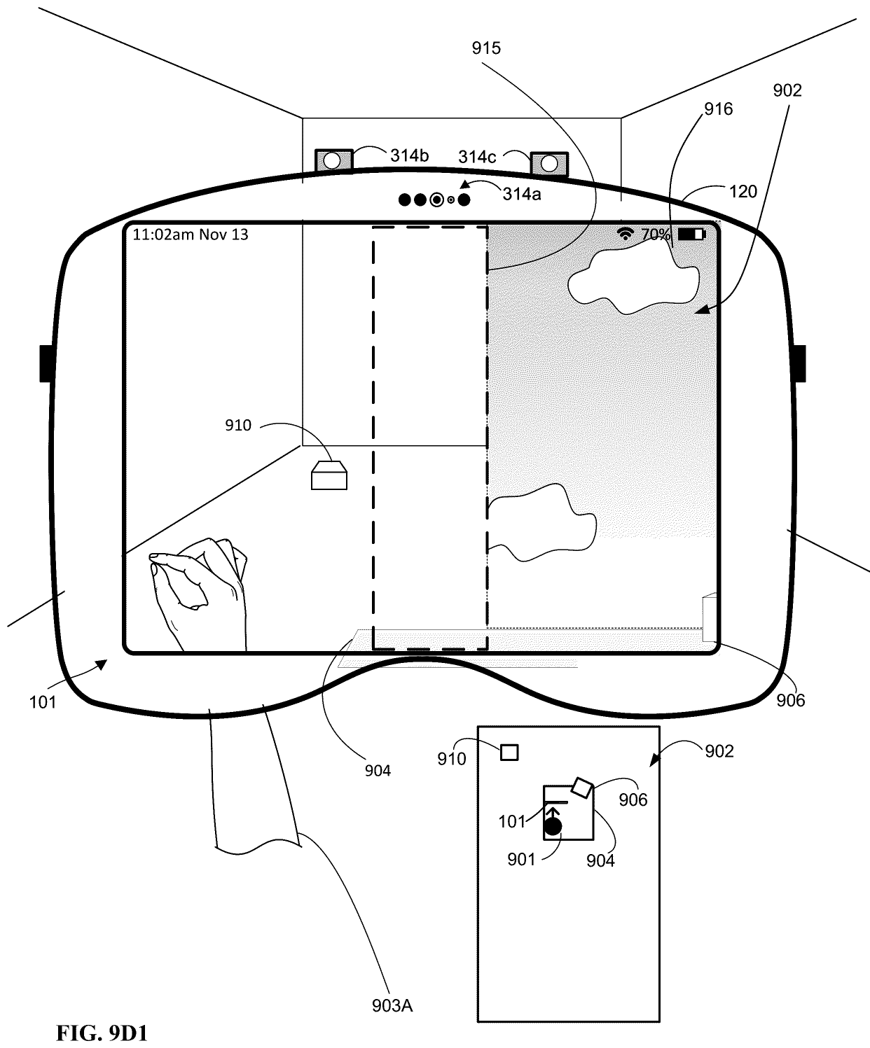

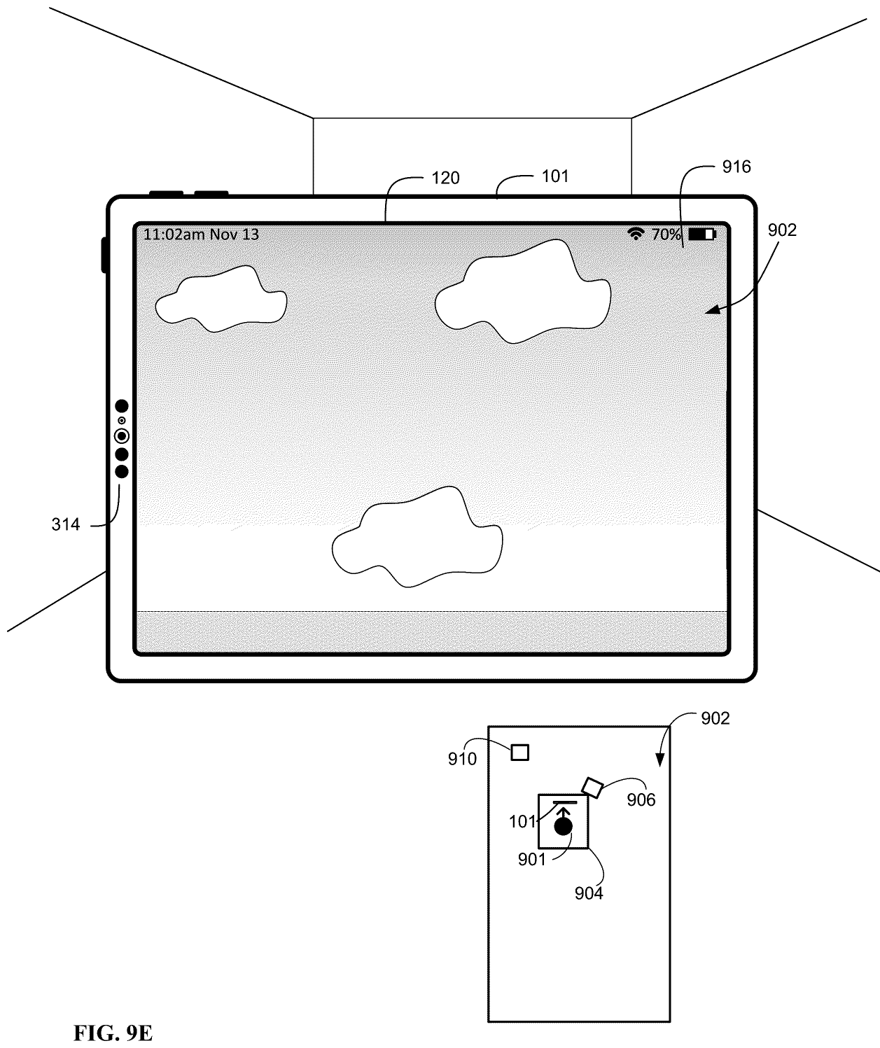

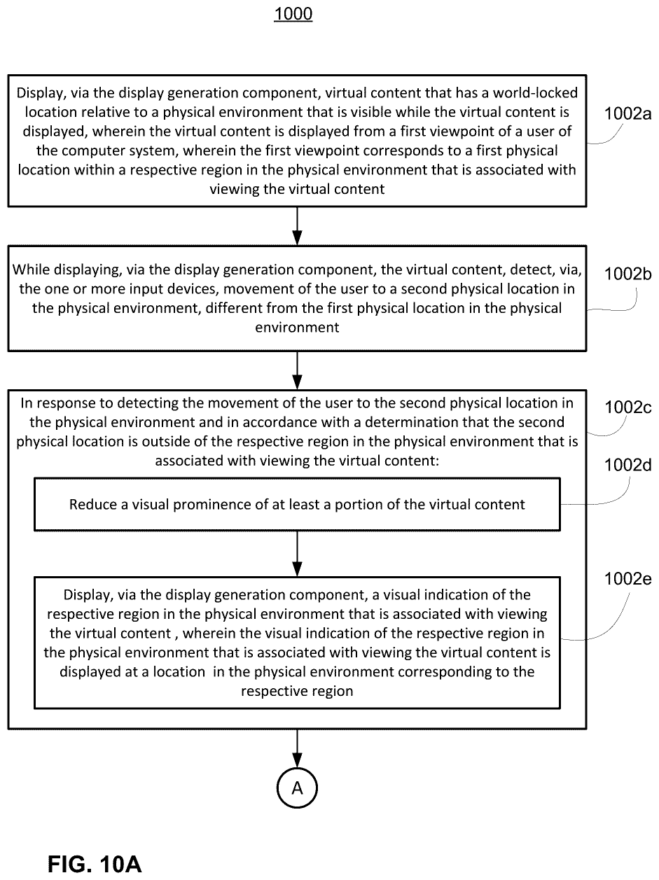

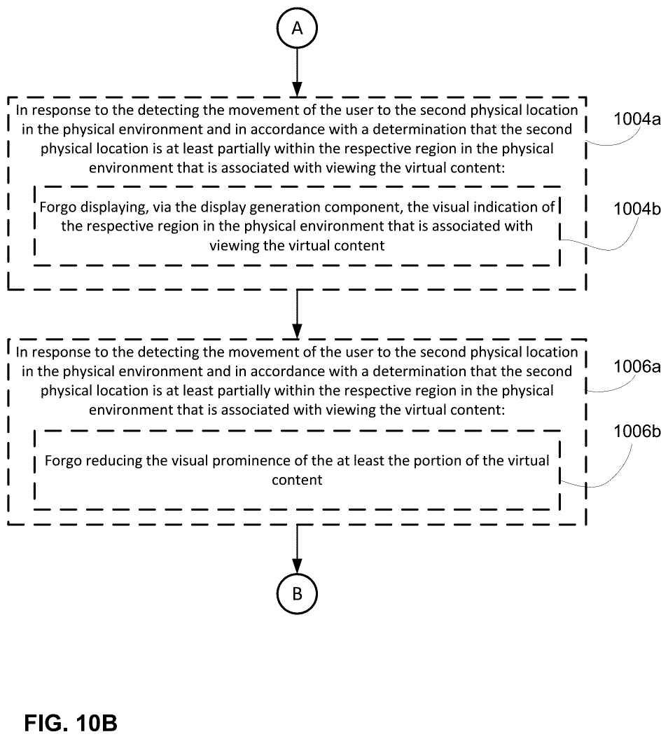

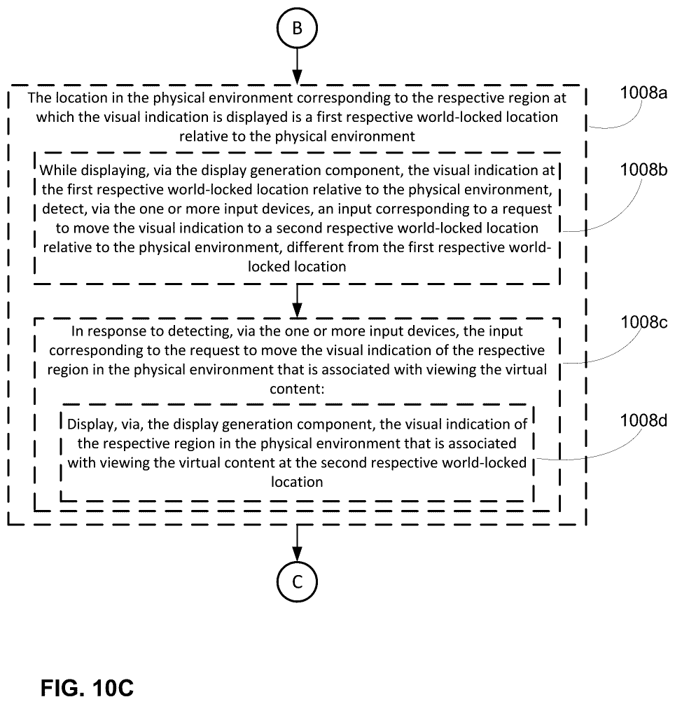

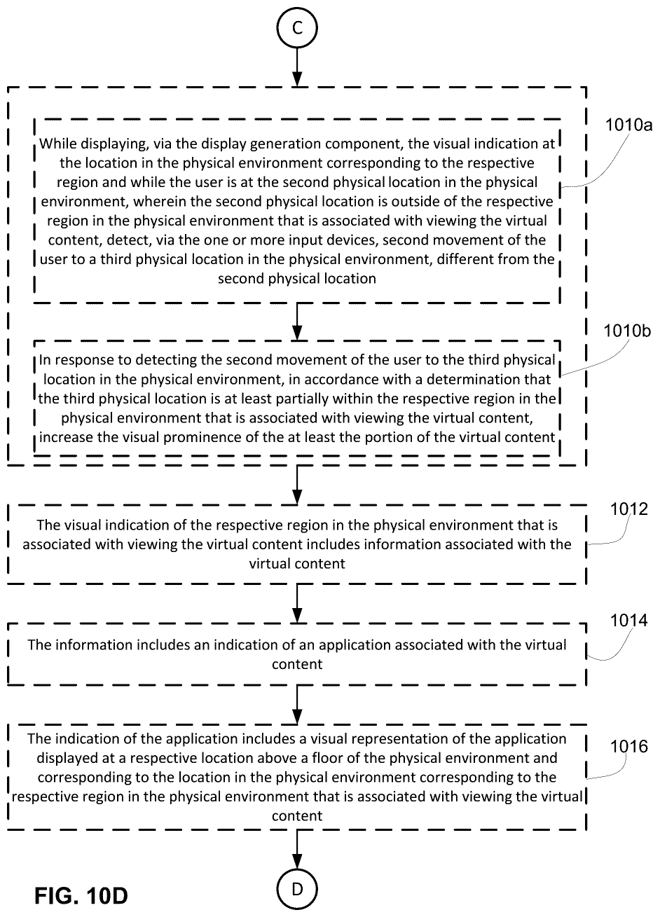

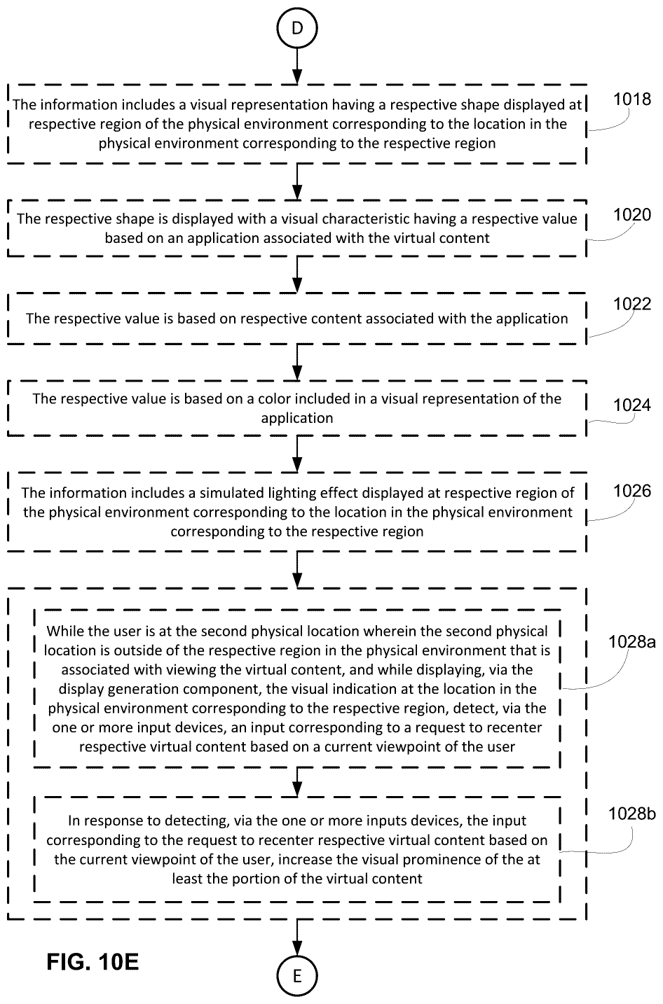

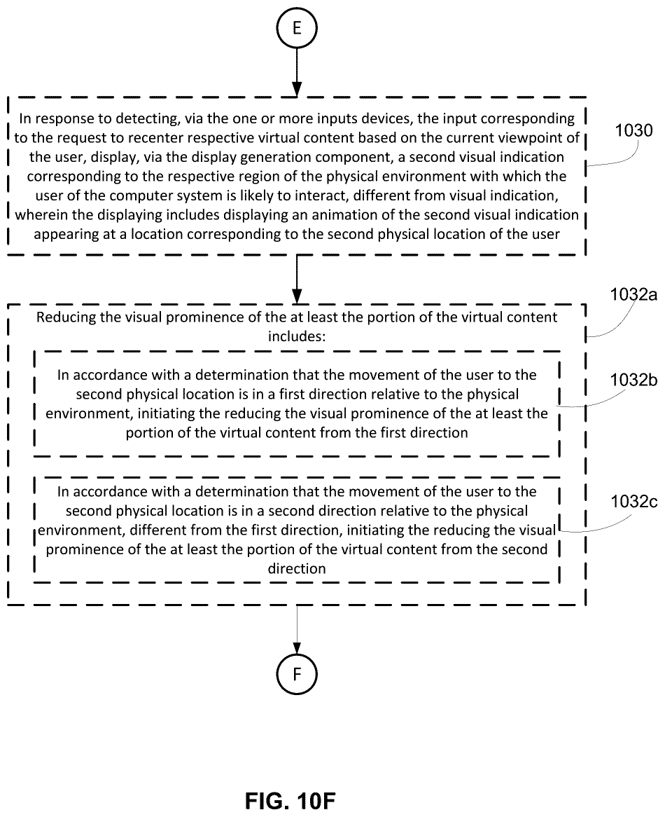

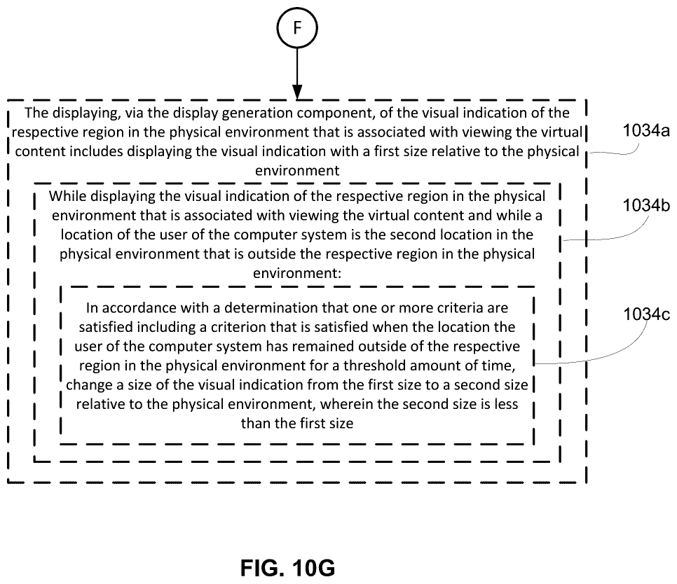

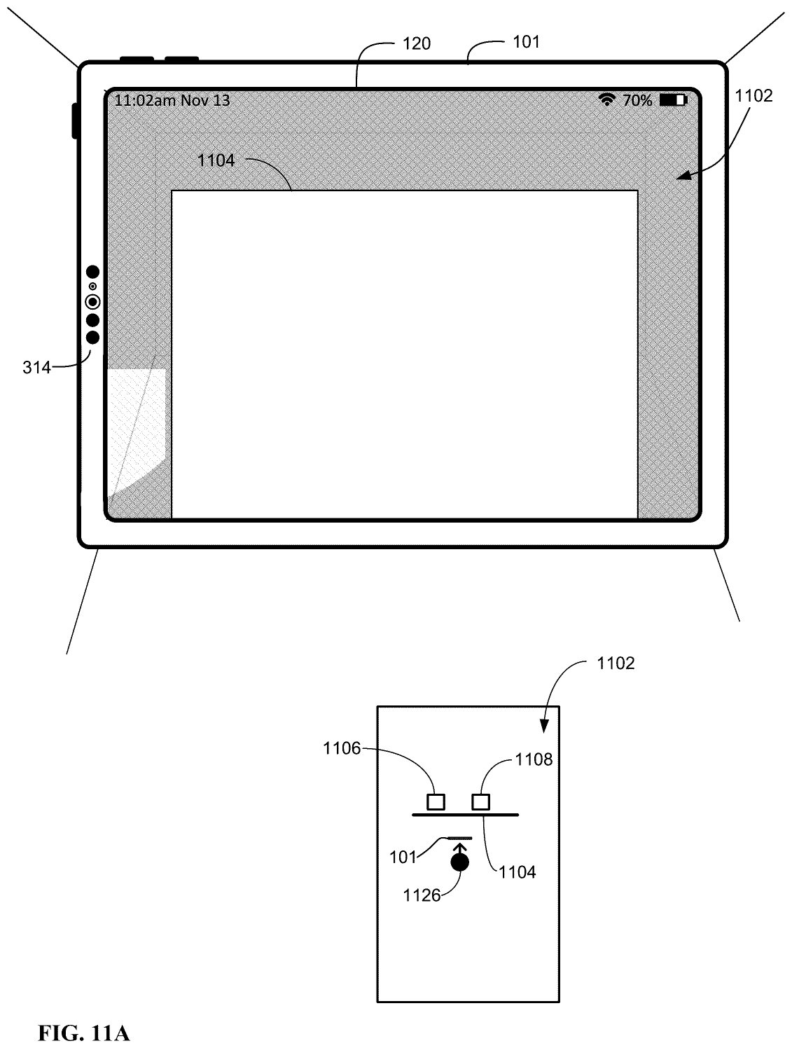

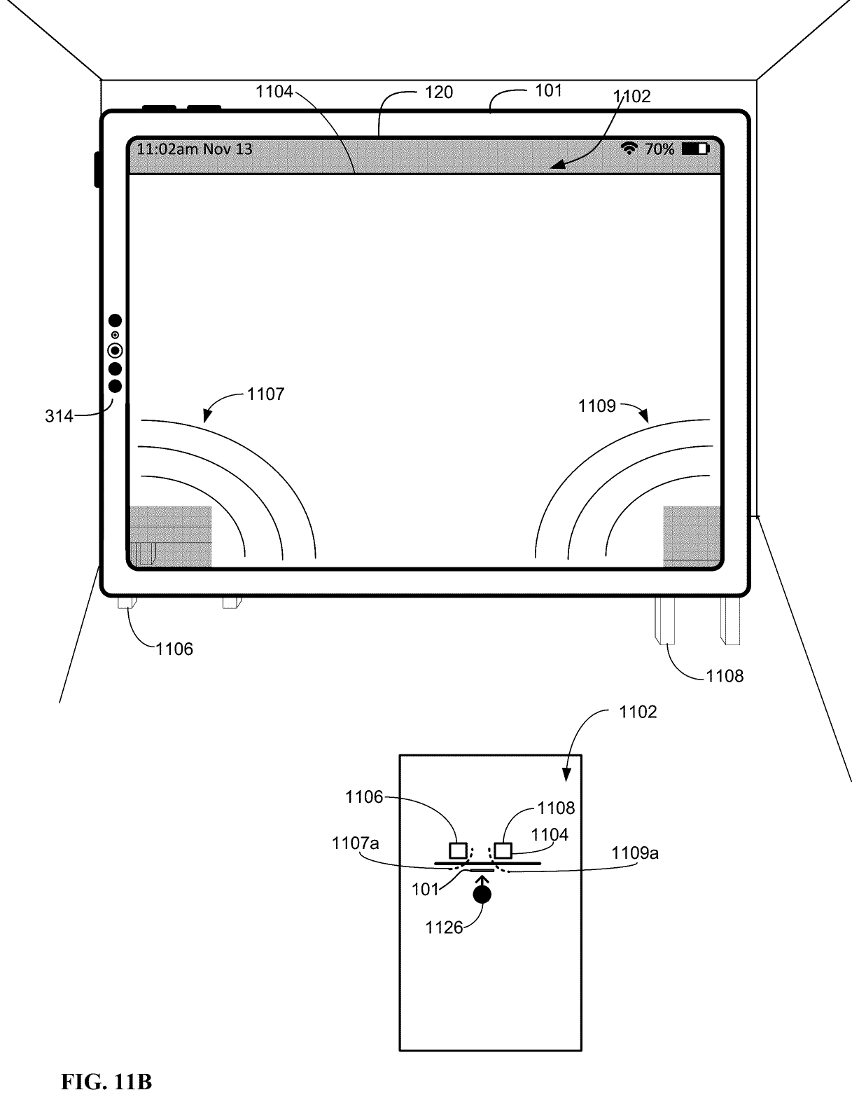

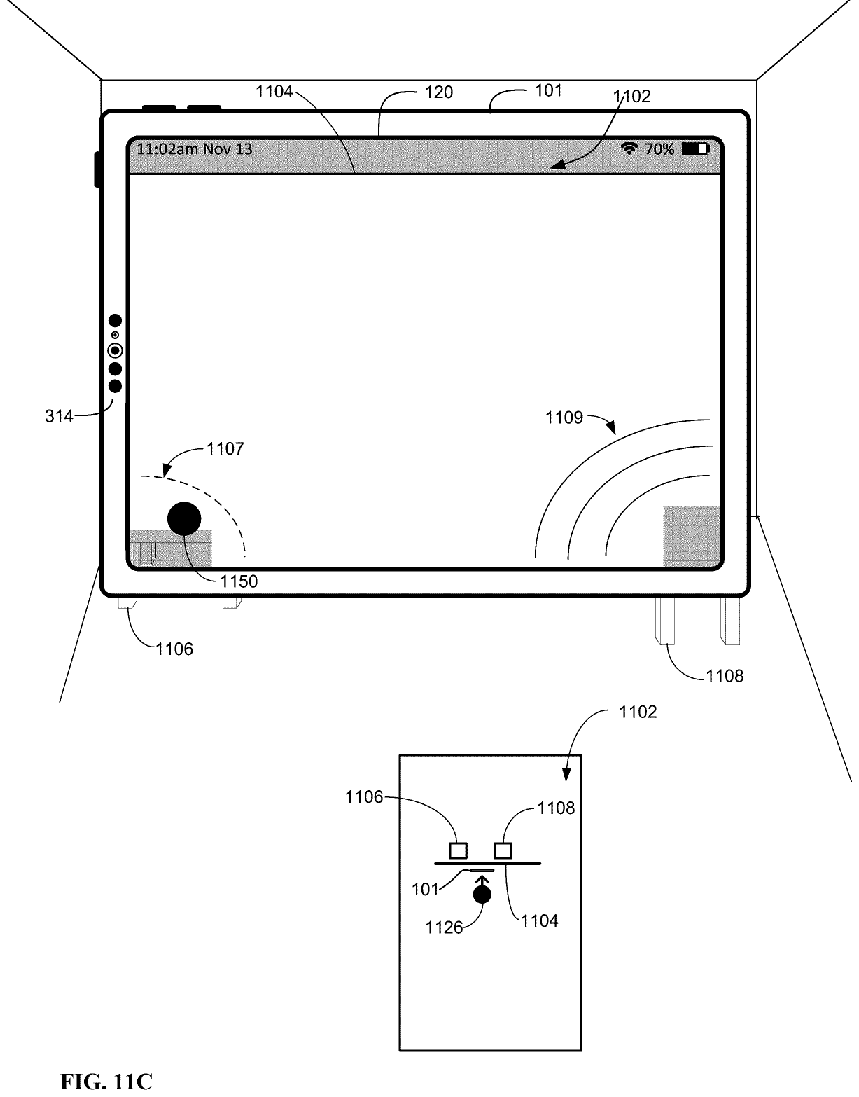

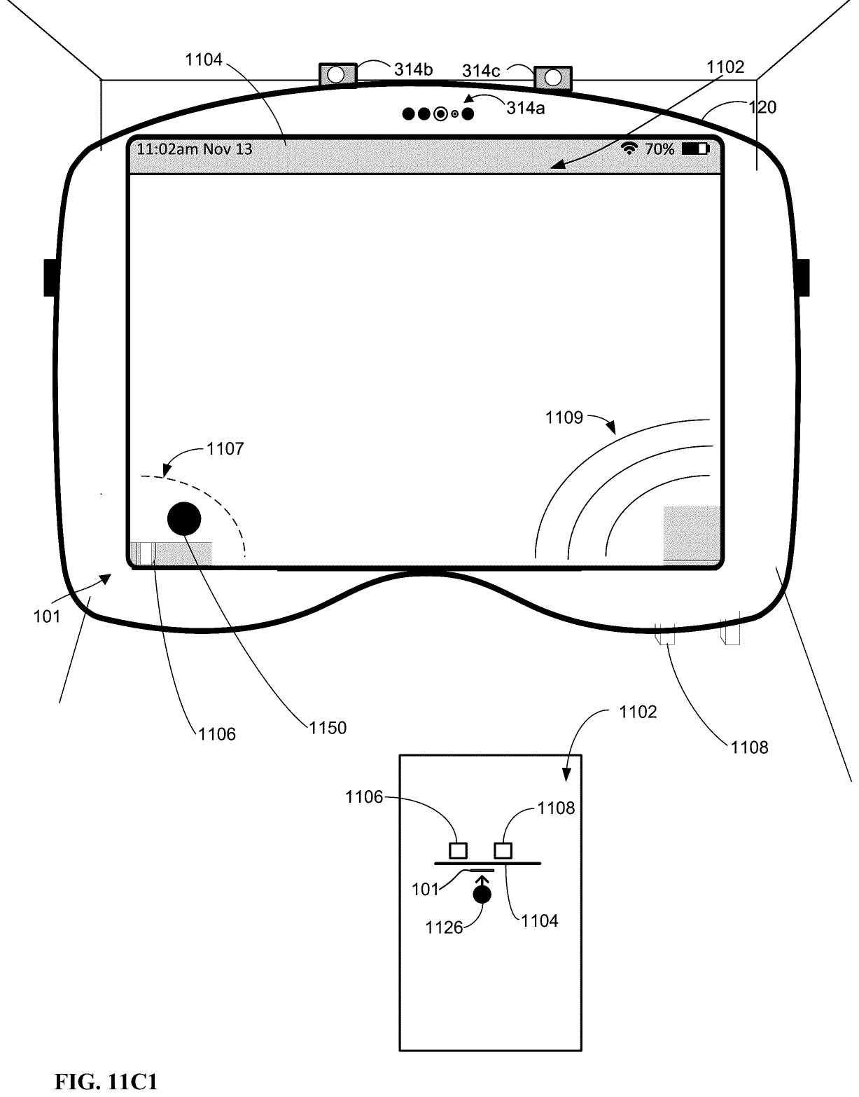

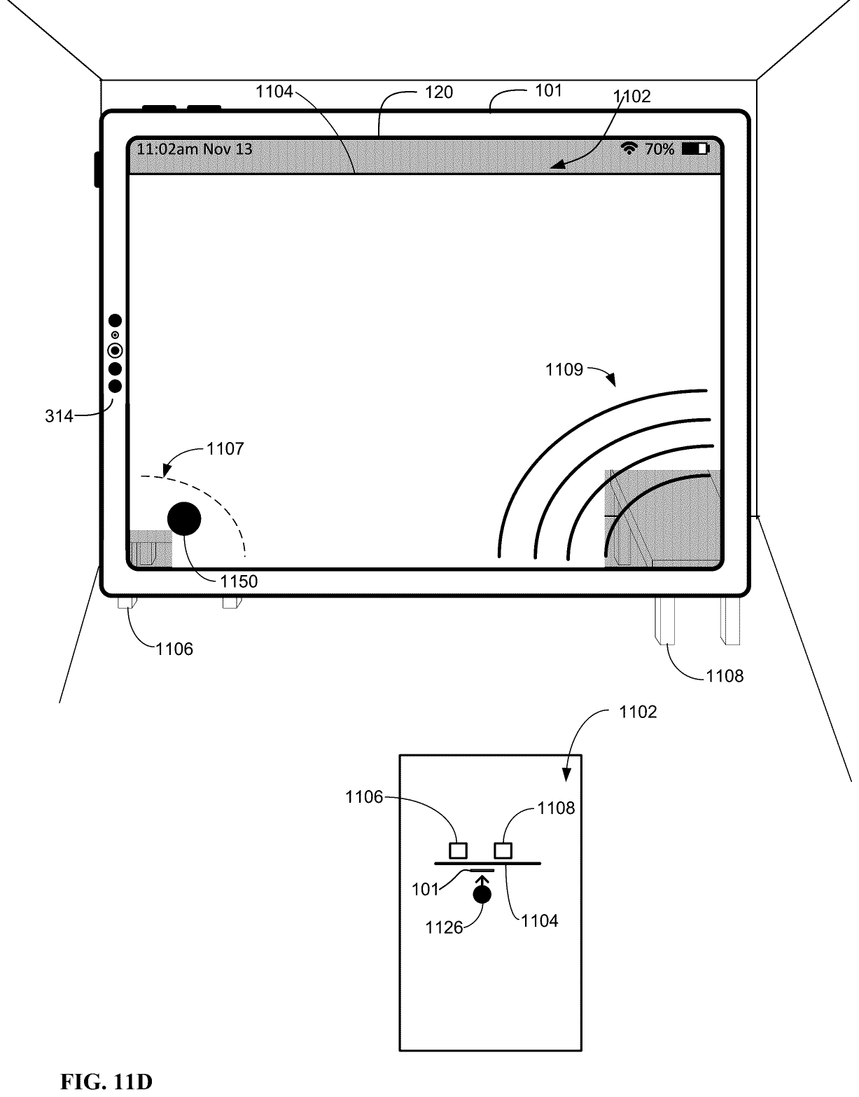

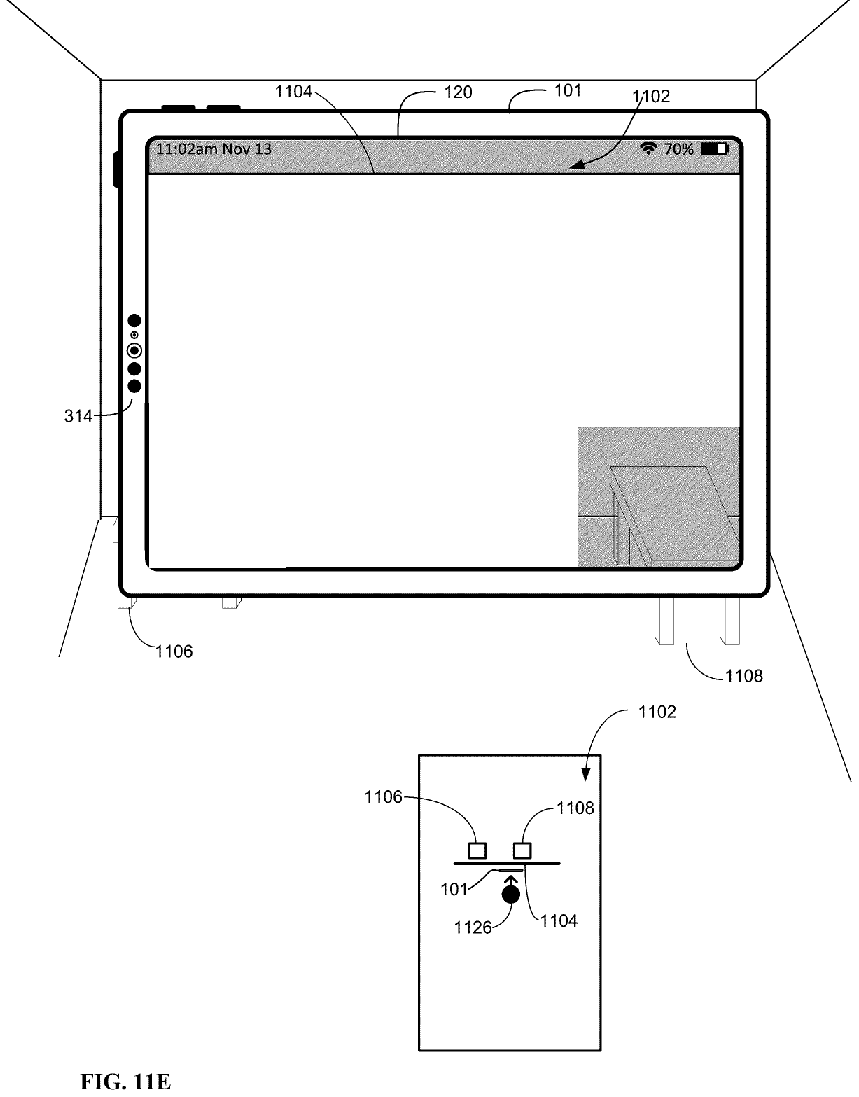

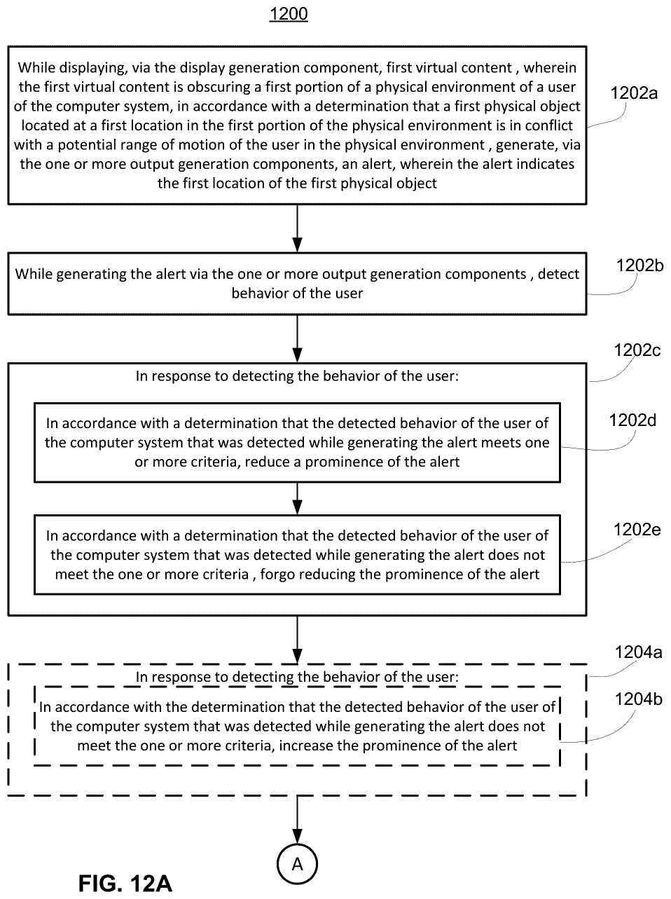

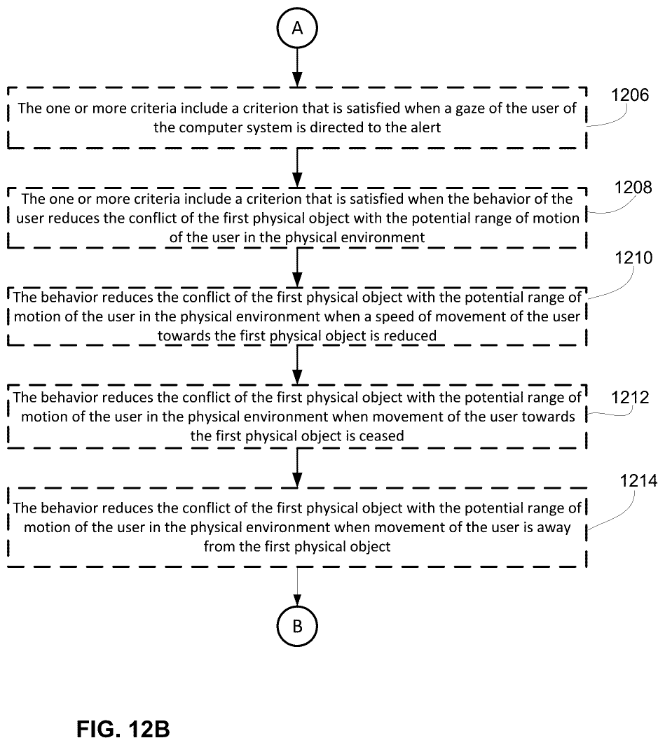

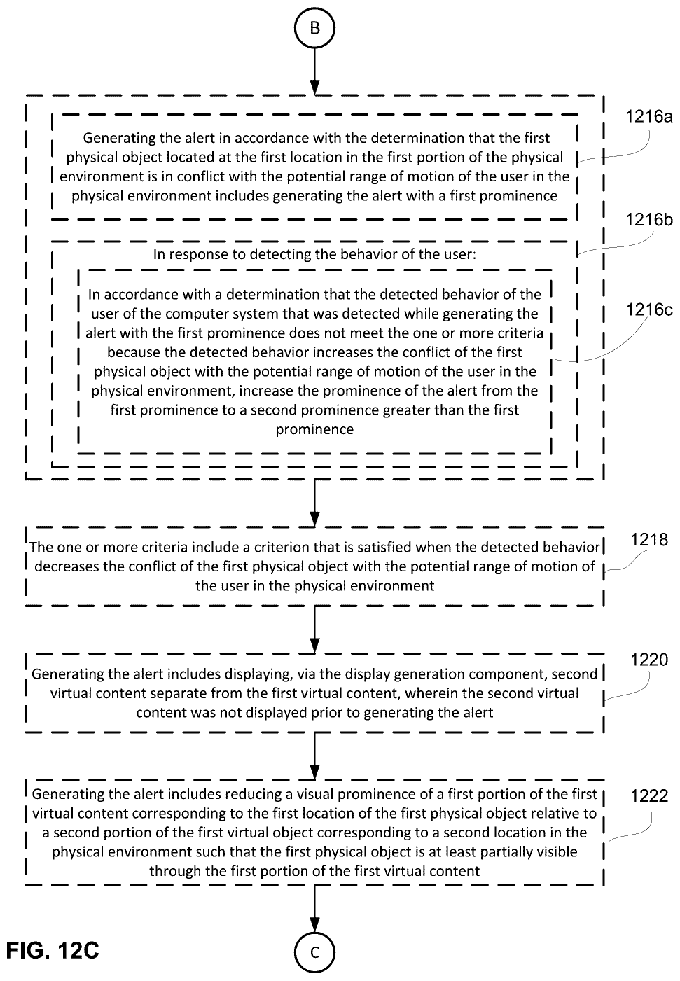

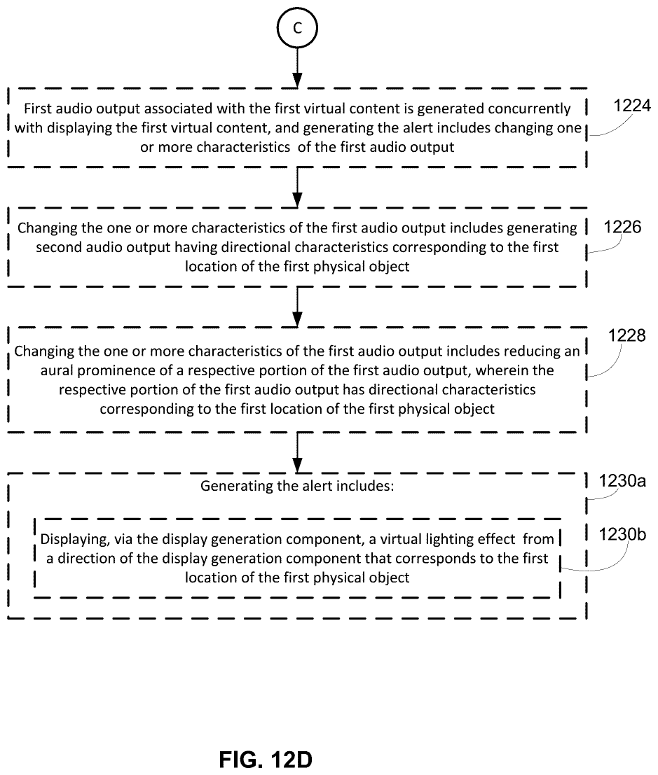

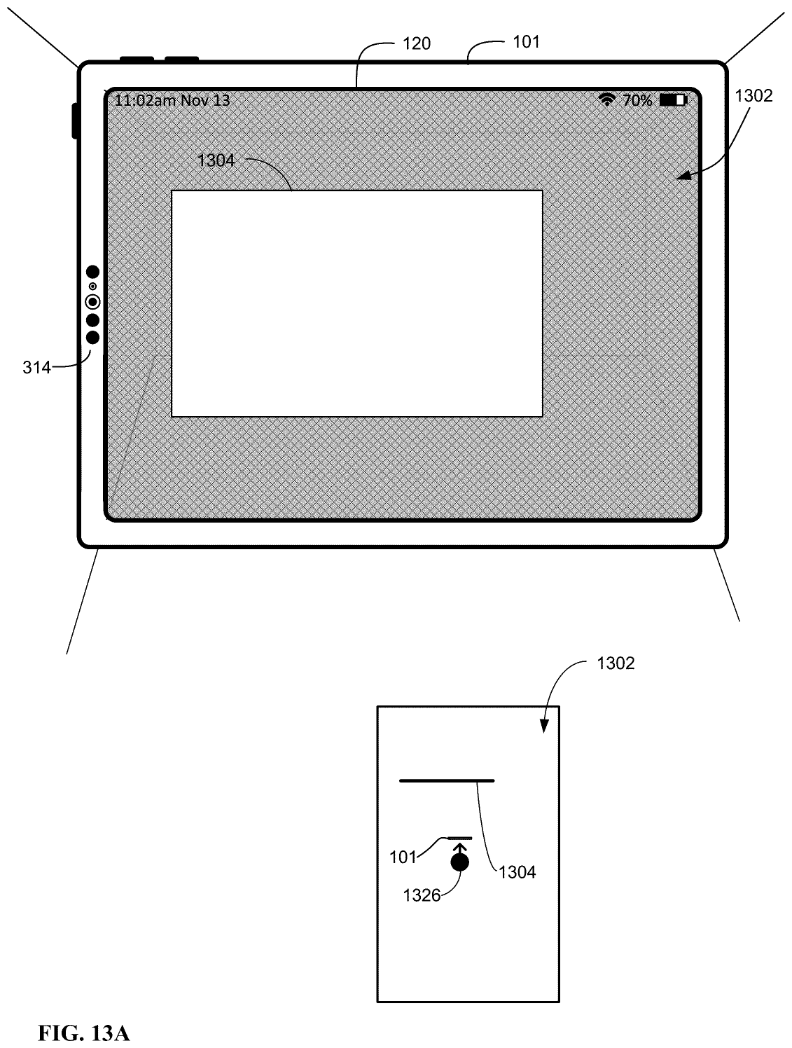

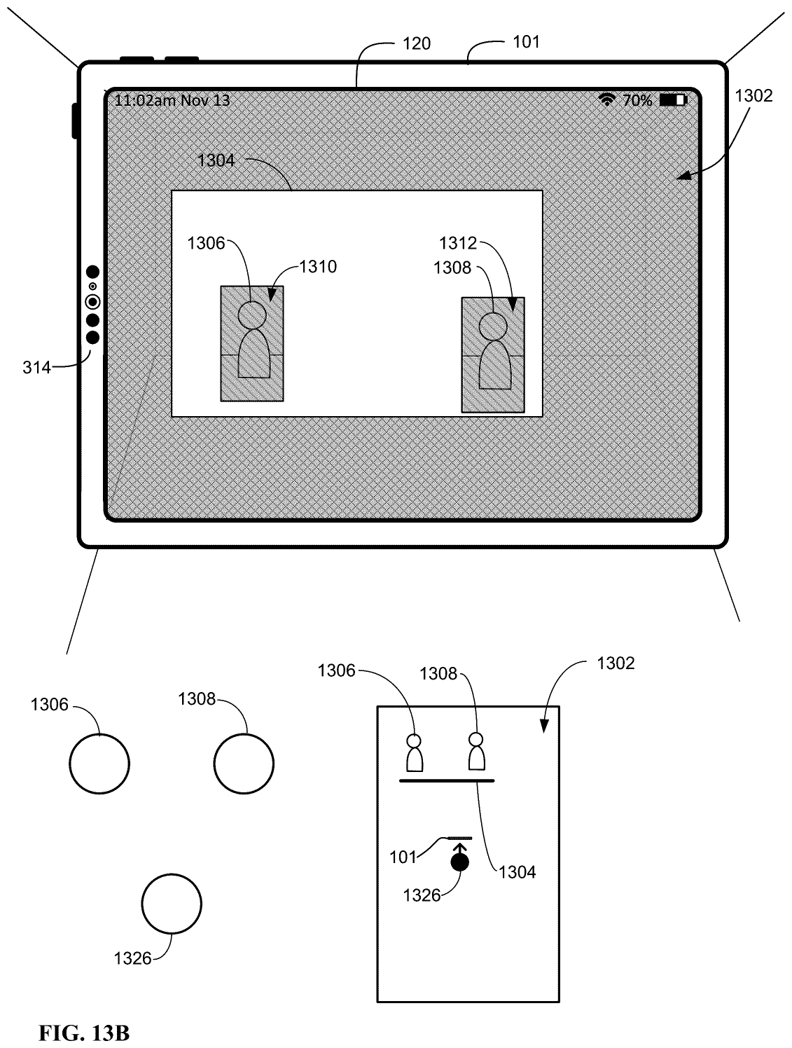

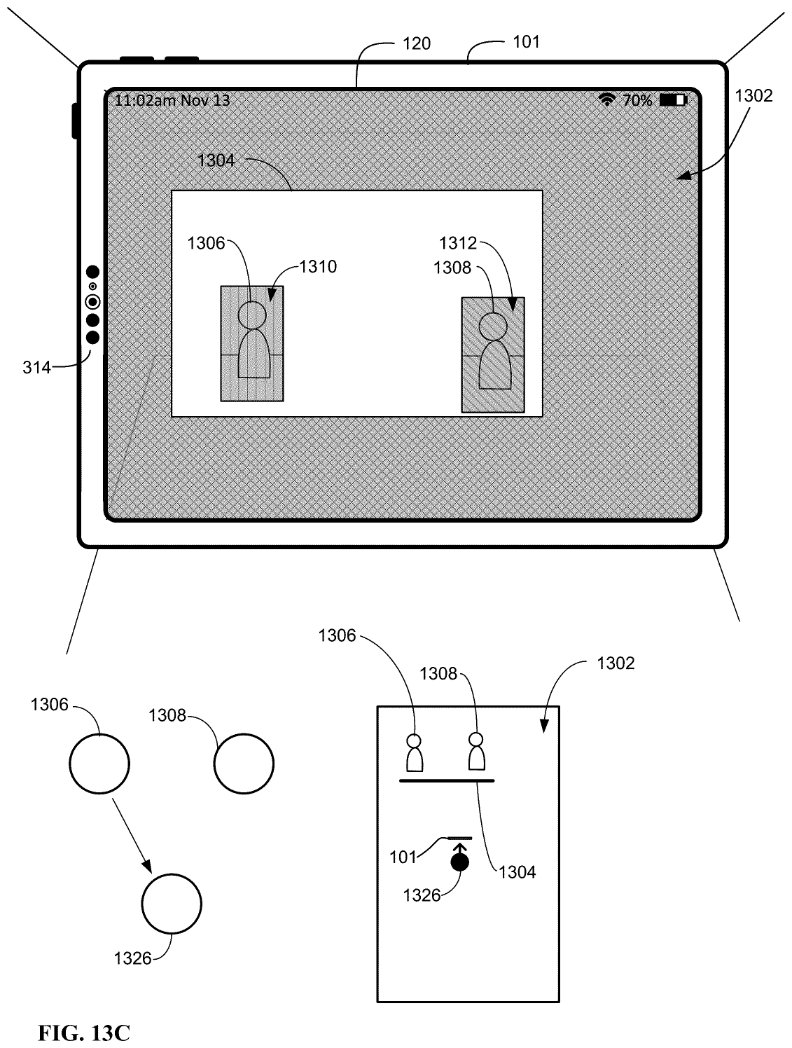

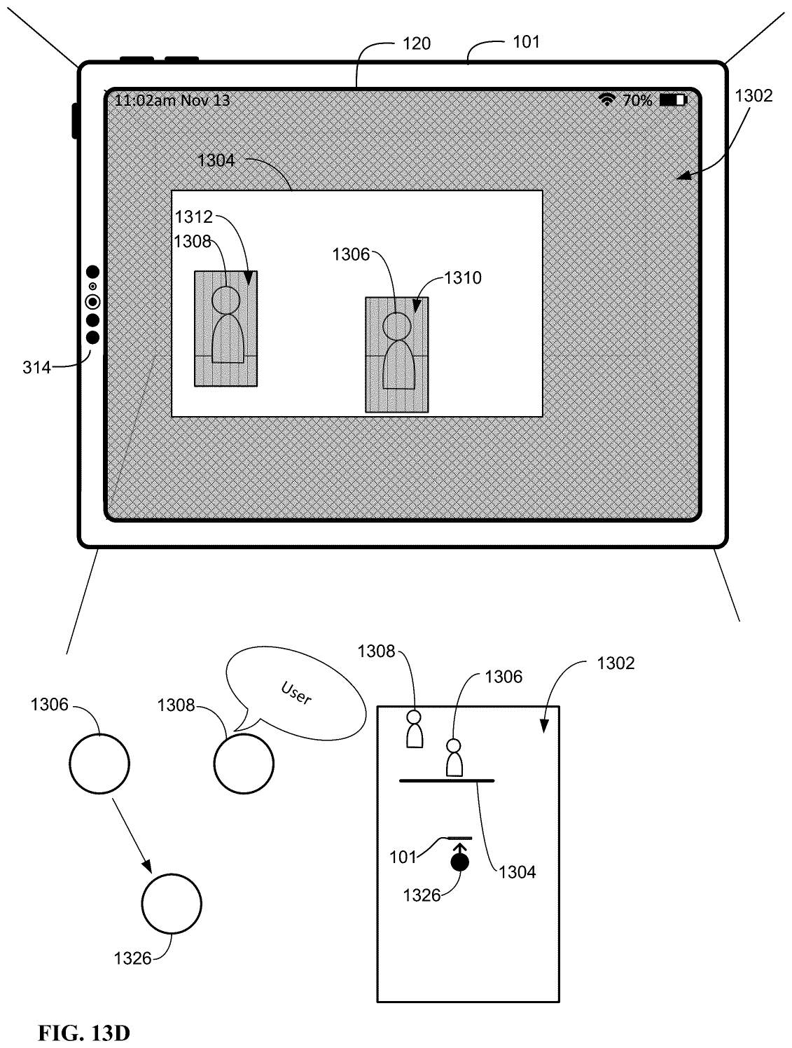

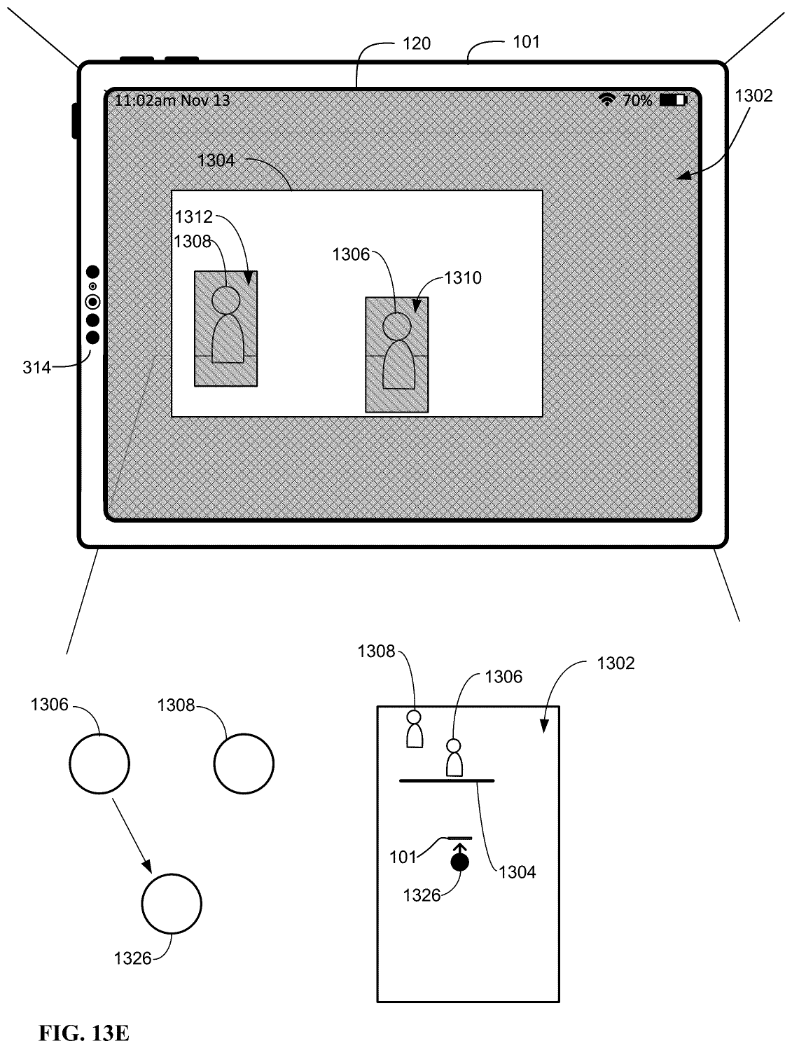

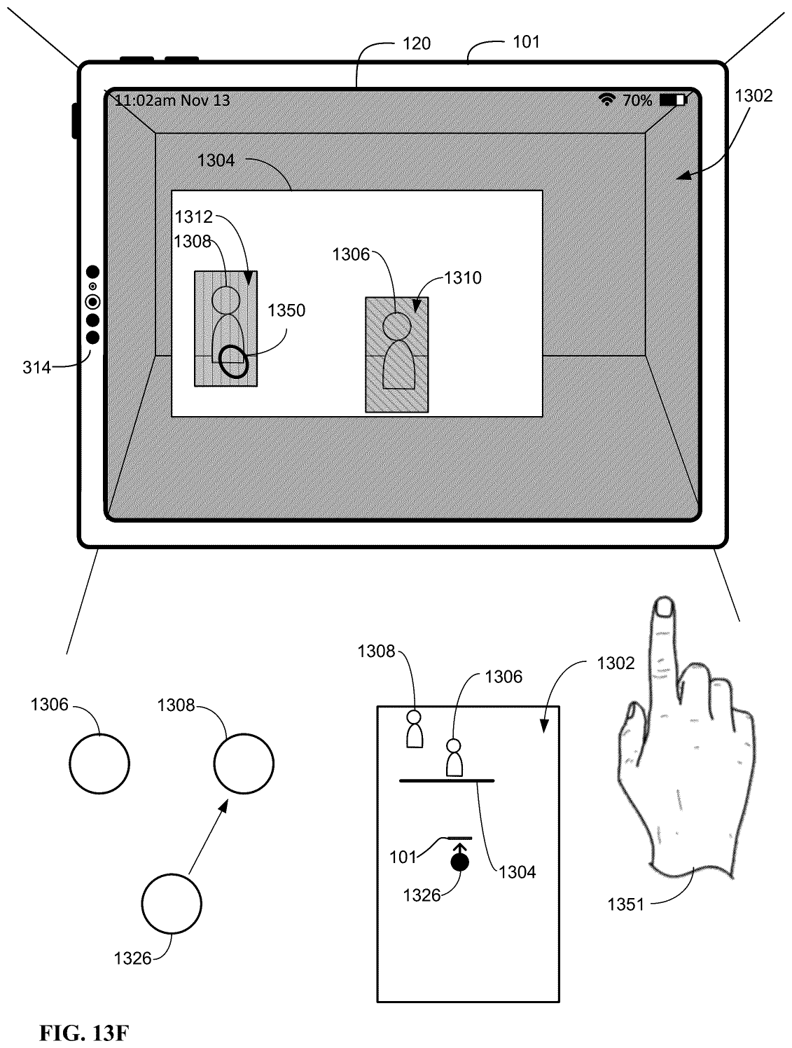

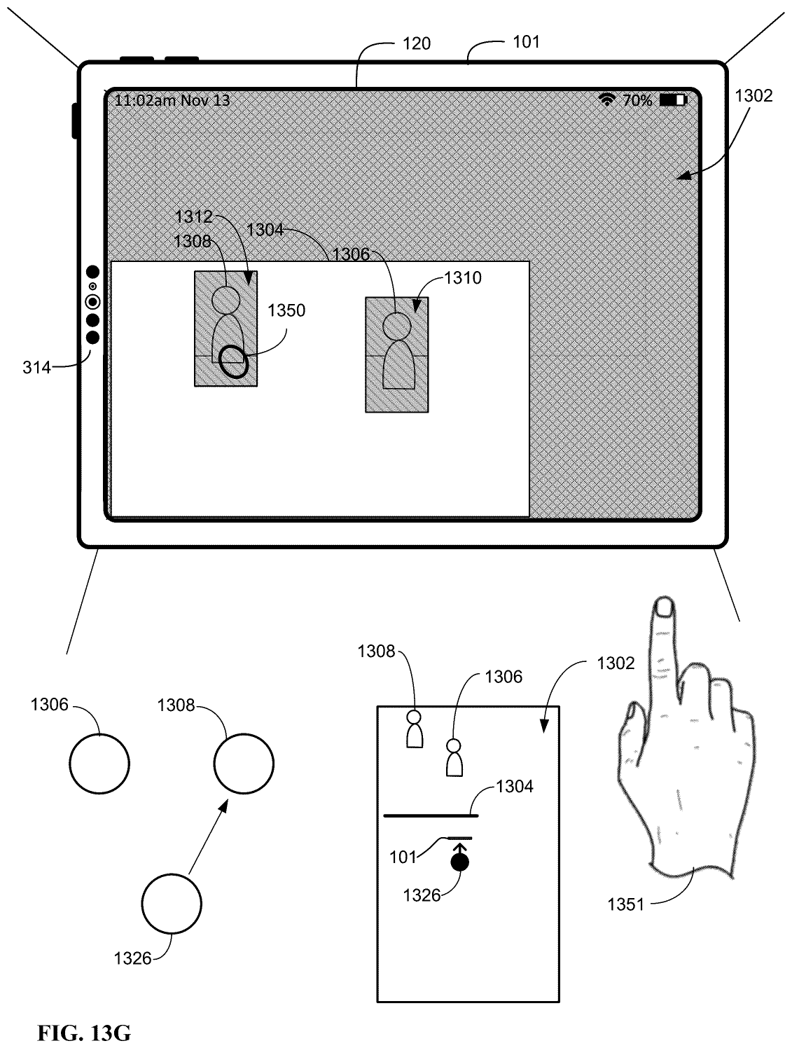

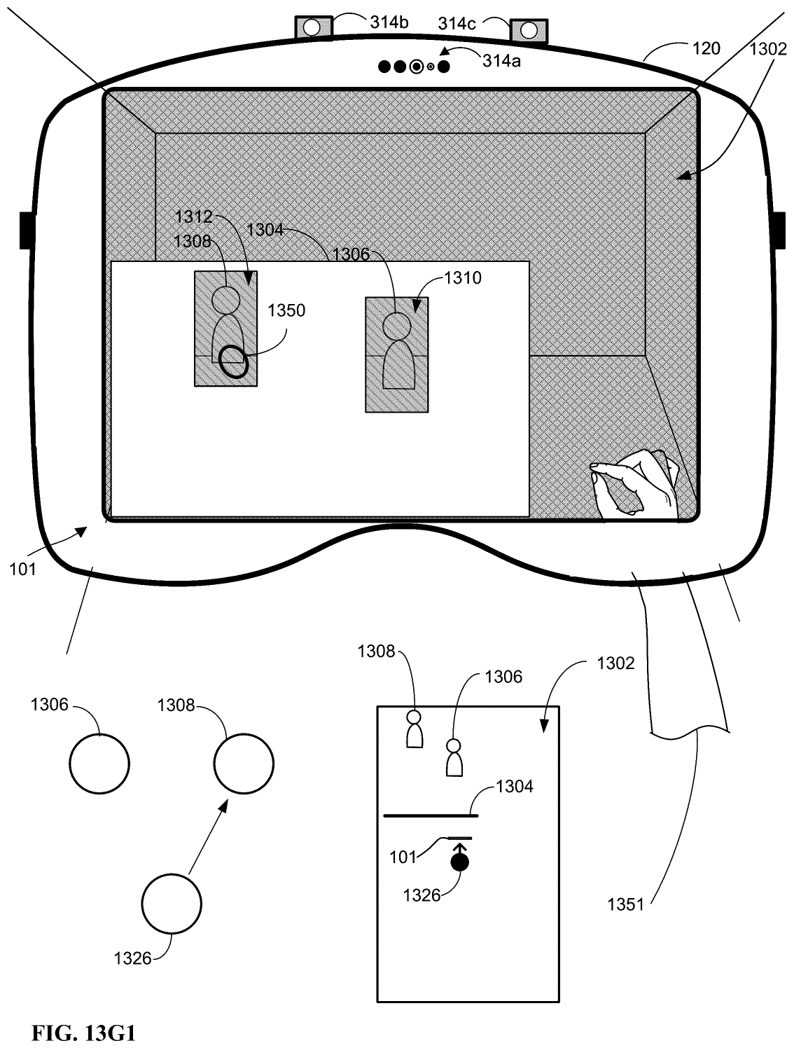

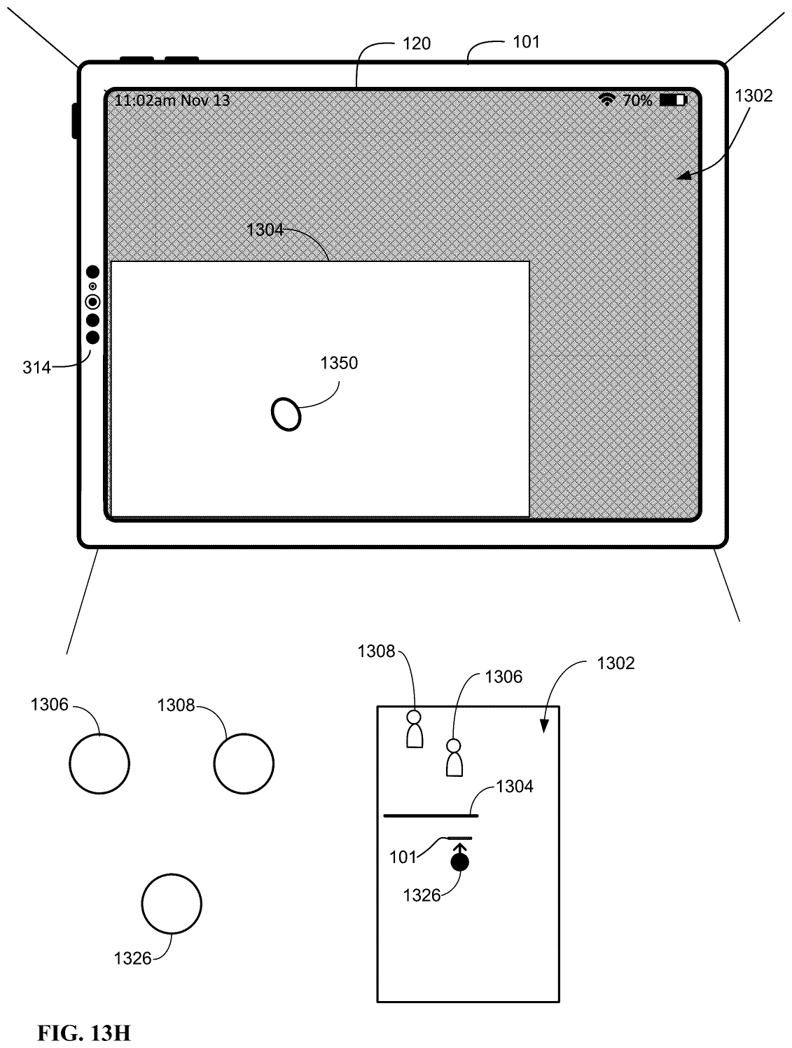

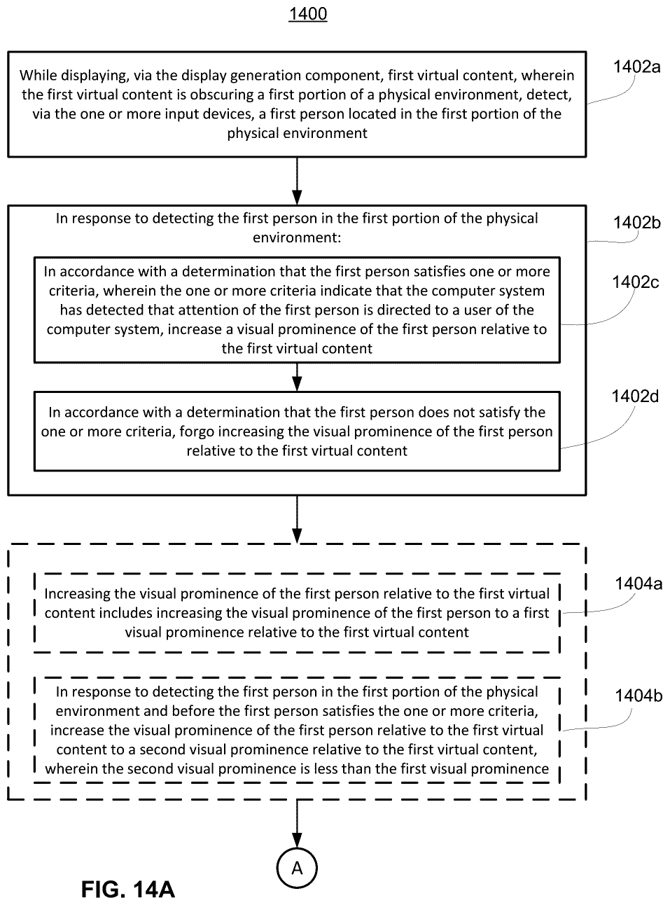

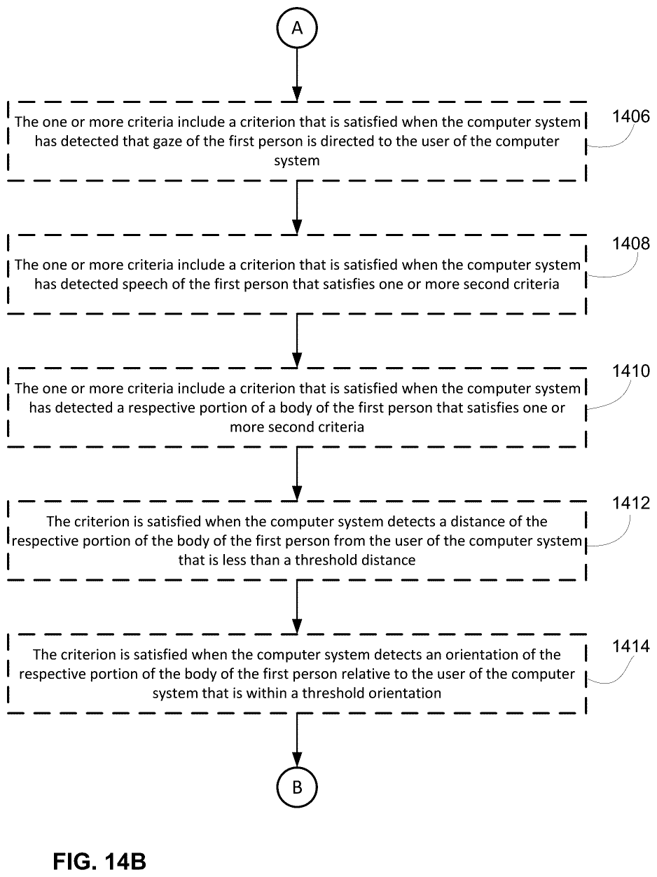

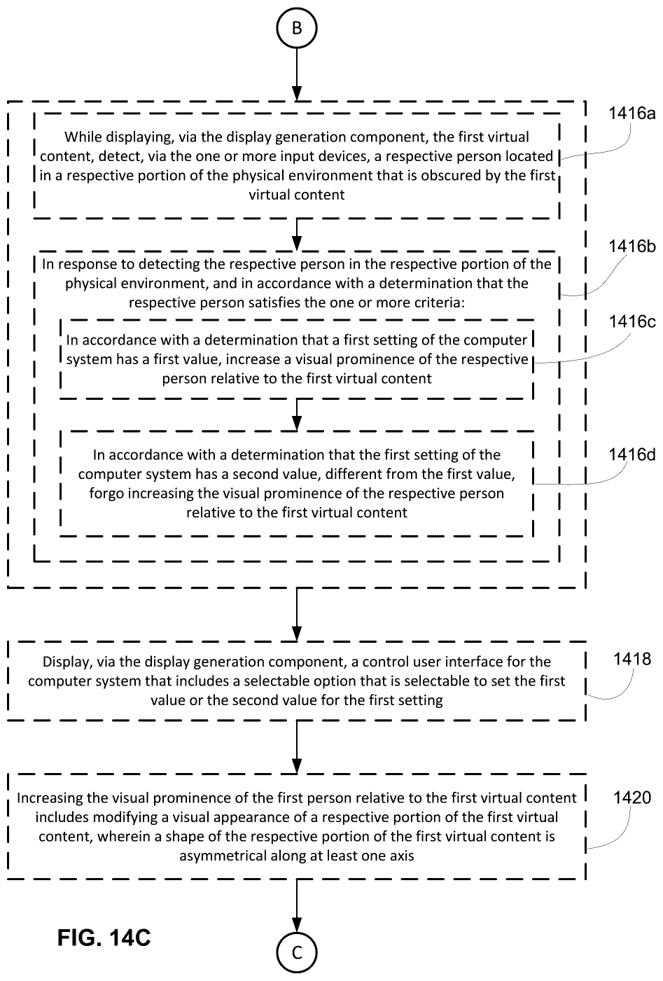

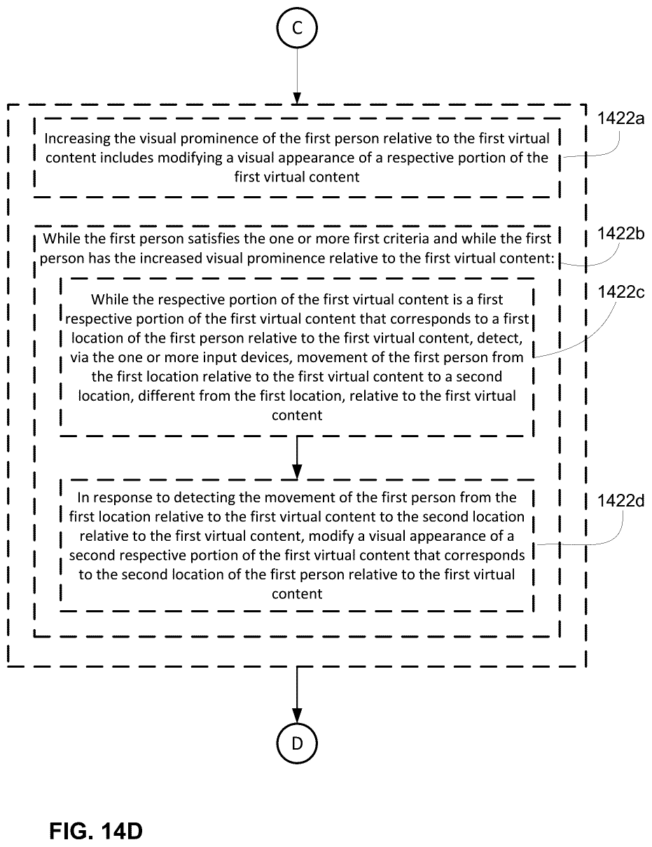

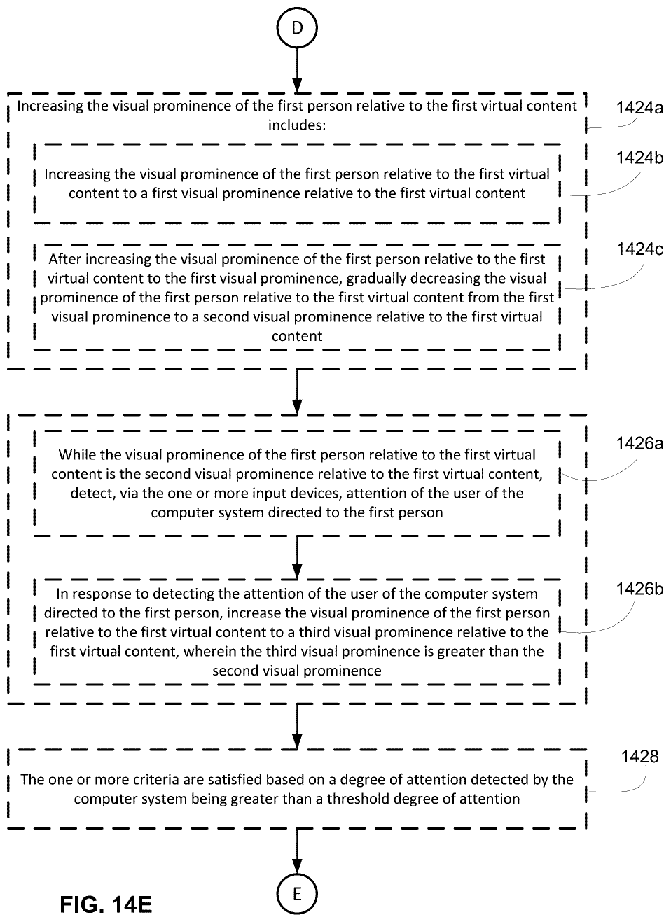

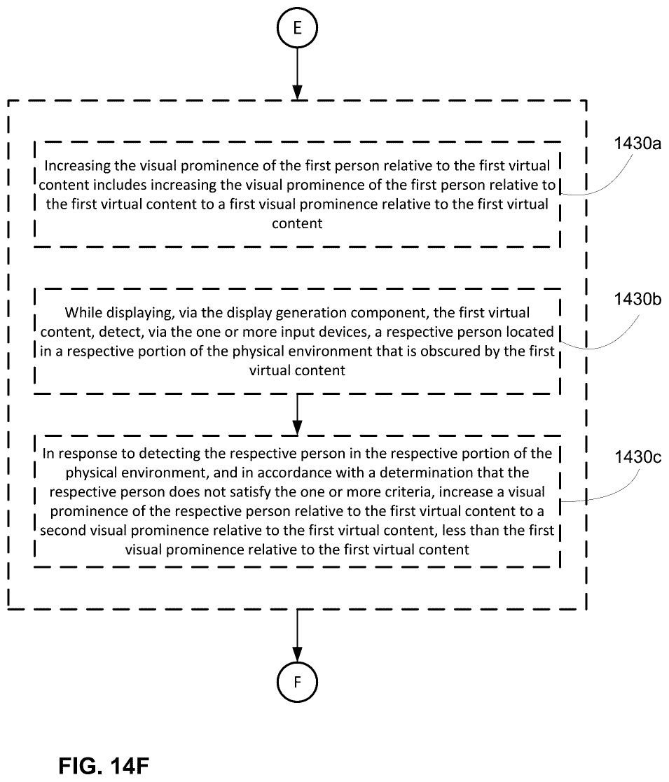

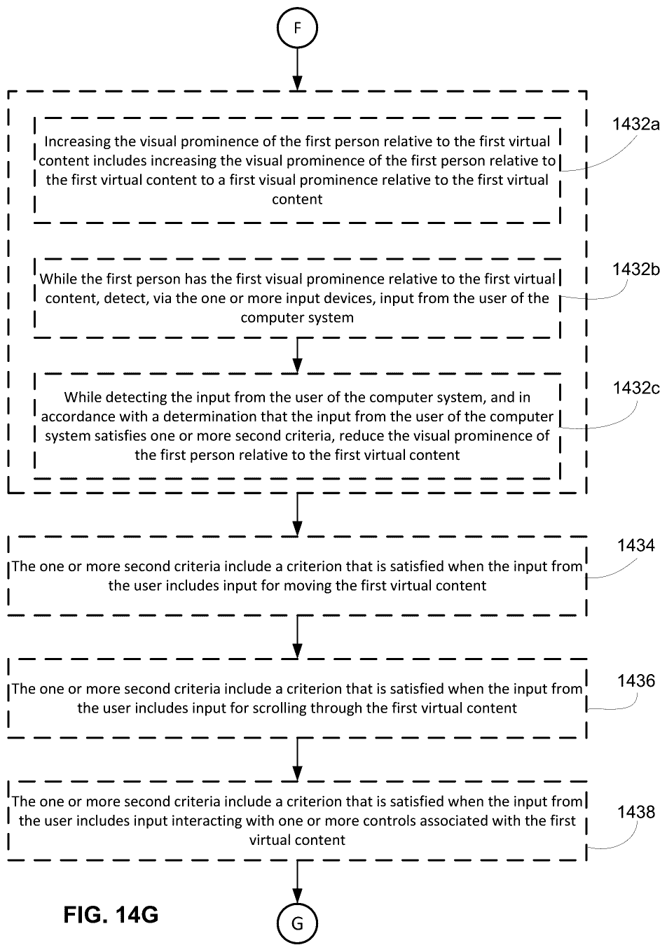

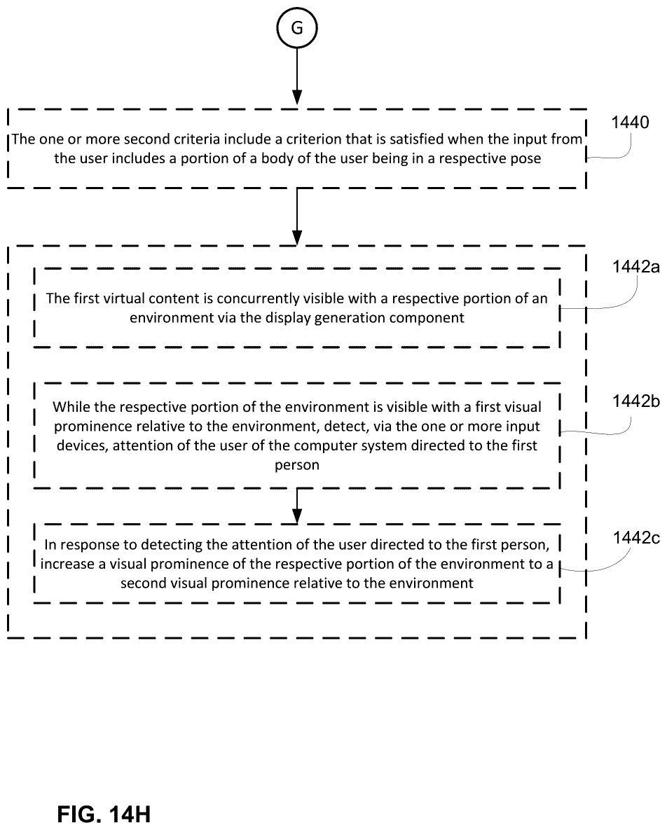

FIGS. 1A-6 provide a description of example computer systems for providing XR experiences to users (such as described below with respect to methods 800, 1000, 1200, and/or 1400). FIGS. 7A-7D illustrate examples of a computer system displaying virtual content illustrating an area of likely interaction, and displaying immersive virtual content in accordance with some embodiments. FIGS. 8A-8F is a flowchart illustrating an exemplary method displaying virtual content illustrating an area of likely interaction, and displaying immersive virtual content in accordance with some embodiments. The user interfaces in FIGS. 7A-7D are used to illustrate the processes in FIGS. 8A-8F. FIGS. 9A-9E illustrate examples of a computer system reducing visual prominence of immersive virtual content and displaying an area of likely interaction in accordance with some embodiments. FIGS. 10A-10G is a flowchart illustrating a method of reducing visual prominence of immersive virtual content and displaying an area of likely interaction in accordance with some embodiments. The user interfaces in FIGS. 9A-9E are used to illustrate the processes in FIGS. 10A-10G. FIGS. 11A-11E illustrate example techniques for generating alerts associated with physical objects in an environment of a user, in accordance with some embodiments. FIGS. 12A-12D is a flow diagram of methods of generating alerts associated with physical objects in an environment of a user, in accordance with various embodiments. The user interfaces in FIGS. 11A-11E are used to illustrate the processes in FIGS. 12A-12D. FIGS. 13A-13H illustrate example techniques for changing the visual prominence of people in a three-dimensional environment based on one or more attention-related factors, in accordance with some embodiments. FIGS. 14A-14H is a flow diagram of methods of changing the visual prominence of people in a three-dimensional environment based on one or more attention-related factors, in accordance with various embodiments. The user interfaces in FIGS. 13A-13H are used to illustrate the processes in FIGS. 14A-14H.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objets such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environement or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movment of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

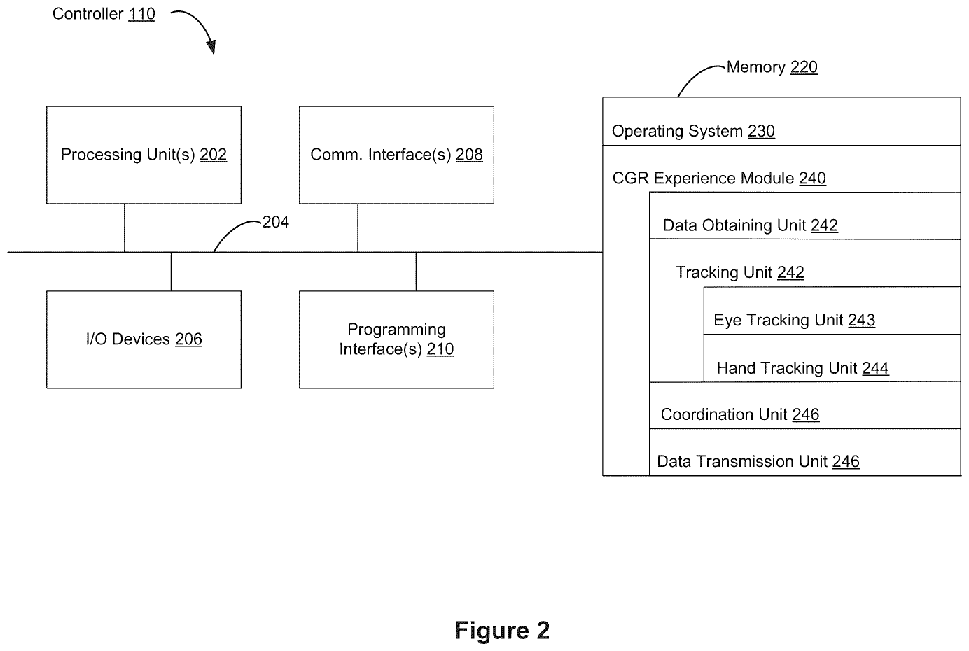

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

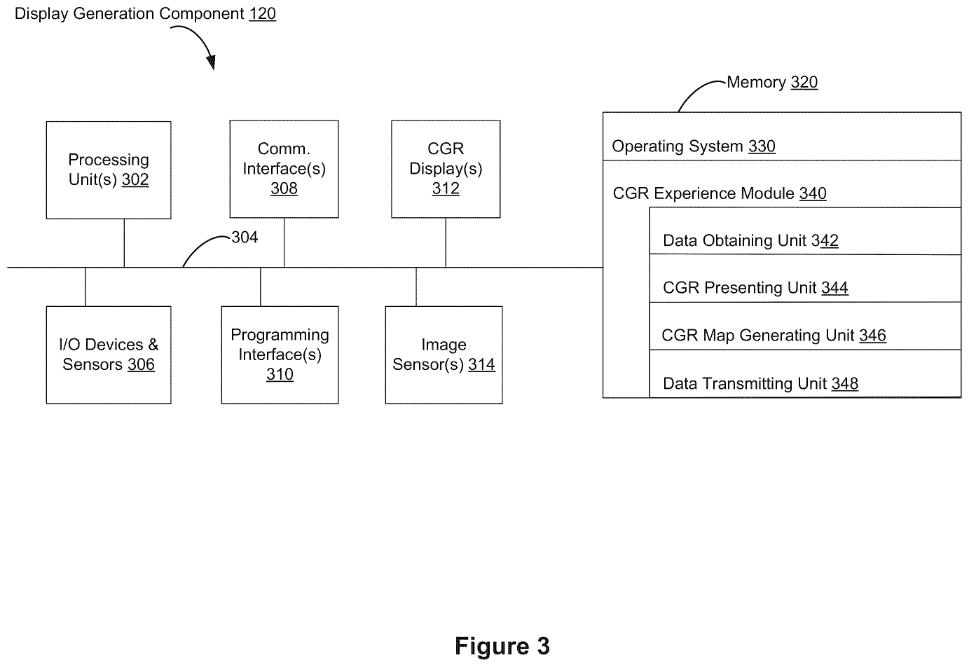

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user′ head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B—1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

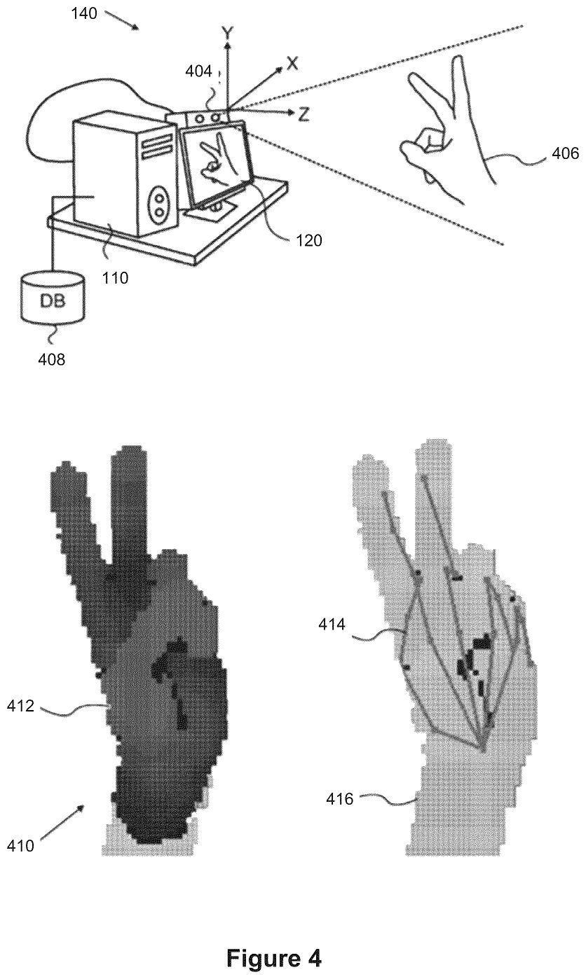

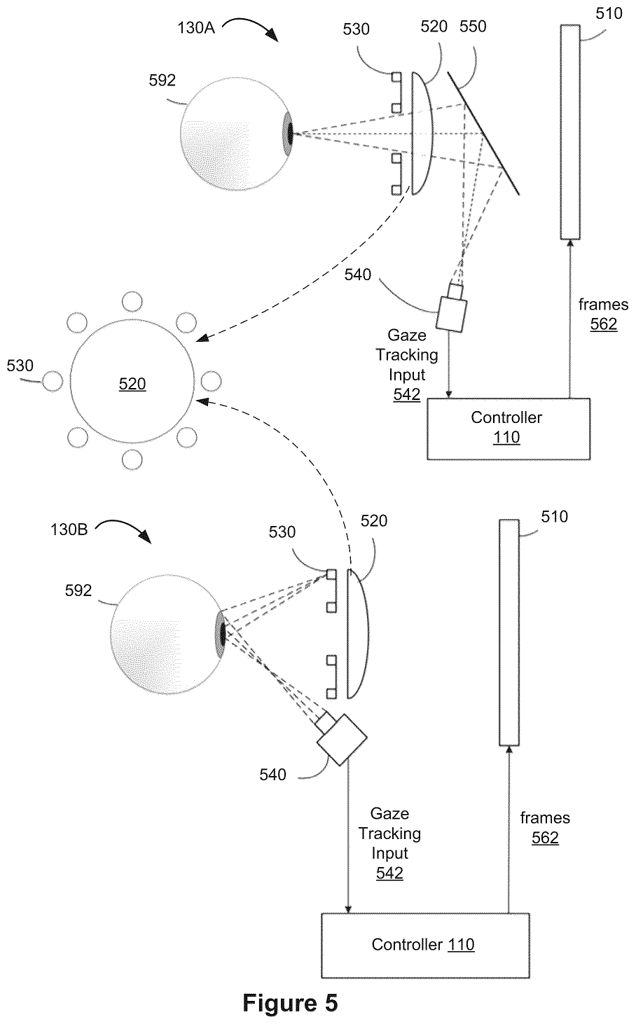

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

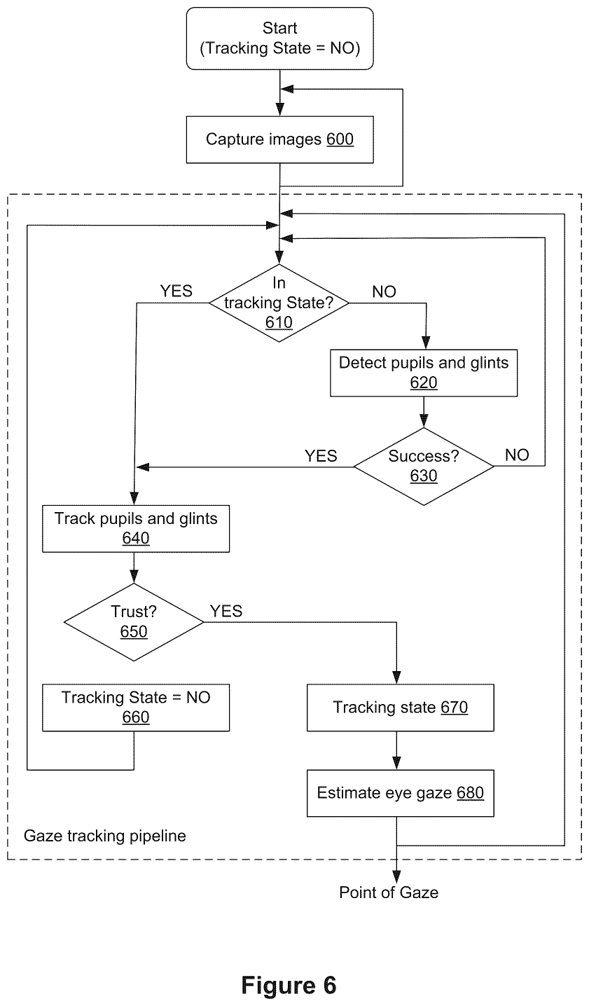

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7D illustrate examples of a computer system displaying virtual content illustrating an area of likely interaction, and displaying immersive virtual content in accordance with some embodiments.

FIG. 7A illustrates a computer system 101 displaying, via a display generation component (e.g., display generation component 120 of FIG. 1), a three-dimensional environment 702 from a viewpoint of the user 701 illustrated in the overhead view (e.g., facing the back wall of the physical environment in which computer system 101 is located). As described above with reference to FIGS. 1-6, the computer system 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user).

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 702 or portions of the physical environment are visible via the display generation component 120 of computer system 101. For example, three-dimensional environment 702 includes portions of the left and right walls, the ceiling, and the floor in the physical environment of user 701, and also includes physical object 706 which is a physical block and physical object 710 which is a table.

In FIG. 7A, three-dimensional environment 702 includes virtual content such as virtual content 708A, virtual content 708B, and virtual content 704. Such virtual content optionally is any element displayed by computer system 101 that is not included in the physical environment of computer system 101.

In some embodiments, virtual content 704 is displayed overlaid over a portion (e.g., a contour) of the physical environment. In some embodiments, virtual content 704 corresponds to a region of the three-dimensional environment 702 with which computer system 101 expects likely user interaction when displaying a virtual environment or other virtual content associated with virtual content 708A, as will be described later. For example, virtual content 704 and/or portions of the physical environment optionally correspond to a “viewing region” of the user. For example computer system 101 optionally anticipates that the user will likely stand within a region of the physical environment corresponding to where virtual content 704 is located (e.g., standing within) when displaying the virtual environment or other virtual content associated with virtual content 708A. In some embodiments virtual content 708 optionally corresponds to a representation corresponding to the virtual environment (e.g., an immersive visual experience, and/or an application providing the immersive visual experience). In some embodiments, the computer system 101 initiates display of virtual content at a level of immersion greater than an immersion threshold in response to detecting an input including a request to display such virtual content, described further with reference to FIG. 7B. Levels of immersion are described in more detail with reference to method 800. Virtual content 704 thus is optionally a visual indication to user 701 of a respective portion of the physical environment of which the user should likely be aware while computer system 101 is displaying the virtual environment or other virtual content associated with virtual content 708A. For example, if there are physical objects such as physical object 706 that warrant the user's attention, virtual content 704 draws the user's focus toward the physical object 706. For example, while computer system 101 is displaying the virtual content associated with virtual content 708A, as will be shown in FIG. 7C, there may be a danger of user colliding with physical object 706. Thus, in some embodiments, virtual content 704 heightens user awareness of the relationship between their physical space prior to interacting with such virtual content.

In some embodiments, virtual content 704 is displayed without displaying virtual content 708A and/or virtual content 708B. In some embodiments virtual content 708A and/or 708B are displayed without displaying virtual content 704. In some embodiments, the visual appearance of virtual content 704, 708A, and 708B is different than illustrated in FIG. 7A. For example, respective virtual content optionally is displayed with a border, lighting effect, color, saturation, hue, brightness, animation, shape, and/or position that is different from as illustrated. In some embodiments, virtual content 708B corresponds to a simulated shadow cast by virtual content 708A in response to one or more simulated light sources that optionally are positioned—but optionally not visible—above virtual content 708A. For example, a first simulated light source positioned normal to the floor of the physical environment and above virtual content 708A optionally casts a virtual shadow (e.g., virtual content 708B) centered below virtual content 708A (e.g., onto virtual content 704). In some embodiments, the simulated light sources are displayed and/or located at different positions and/or angles relative to virtual content 708A, such that additional virtual shadows of varying shapes, positions, and/or intensities are displayed (e.g., on virtual content 704) in addition or in alternative to virtual content 708B. Additionally or alternatively, the one or more simulated light sources additionally cause virtual content 708A to be displayed with a specular lighting effect, simulating the visual effect of a real world light shining on an at least semi-reflective surface such that a bright region or spot is displayed on virtual content 708A, suggesting a position of a light source oriented toward virtual content 708A.

FIG. 7A1 illustrates a perspective view of the physical environment of user 701 corresponding to the position of user 701 in FIG. 7A. For example, user 701 is positioned, in their physical environment, outside of a region of their physical environment corresponding to content 704 (e.g., the region indicated in dashed lines in FIG. 7A1). FIG. 7B illustrates modifications to environment 702 in response to an input from user 701. As shown in FIG. 7B, the input includes movement of user 701 as shown in the overhead view of environment 702 into a location in environment 702 within an area corresponding to virtual content 704. The movement of user 701 from outside of the area corresponding to virtual content 704 to inside the area corresponding to virtual content 704 is also shown from FIG. 7A1 to FIG. 7B2, where user 701 is shown as having moved within the region of their physical environment corresponding to content 704 (e.g., the region indicated in dashed lines in FIG. 7B2). In some embodiments, feedback and/or prompts are displayed in response to such input. For example, virtual content 712 (e.g., a confirmation prompt) optionally is displayed to ensure the user wishes to display virtual content at a level of immersion greater than a threshold level of immersion. In response to input corresponding to a request to display virtual content at a level of immersion greater than an immersion threshold, computer system 101 optionally displays virtual content 712 associated with the display of the virtual content at the level of immersion greater than the immersion threshold. For example, virtual content 712 optionally includes respective information associated with the virtual content that will be displayed at the level of immersion greater than the immersion threshold. The respective information optionally notifies the user of computer system 101 that virtual content will be displayed (e.g., “a virtual environment will be loaded.”). In some embodiments, the respective information includes a name associated with the virtual content (e.g., a name of an application providing the virtual content to be displayed at the level of immersion and/or a name of an immersive visual experience such as a beach, forest, and/or campground). The respective information optionally also includes a prompt to confirm that the user is aware of their physical surroundings. For example, the respective information optionally includes selectable option 712-1, which is selectable (e.g., with a mouse and a cursor click, attention and an air gesture, actuation of a physical and/or virtual button, and/or another suitable selection input directed to the selectable option) confirming user intent to display the virtual content at the level of immersion. In some embodiments, the respective information optionally includes selectable option 712-2 which is selectable to provide confirmation of user intent as described previously and additionally to forgo display of at least a portion of respective information 712 in response to a later received request to display the virtual content at the level of immersion. For example, after receiving a selection of selectable option 712-2, computer system 101 optionally is made aware the user does not wish to see virtual content 712 and/or selectable options 712-1 and 712-2 in the future. As such, at a later time, computer system 101 detects an input corresponding to a request to load the virtual content at the level of immersion and forgoes the display of such virtual content described previously, partially or entirely, and optionally proceeds to display the virtual content at the level of immersion. Thus, virtual content 712 aids computer system 101 and user 701 in confirming intent to display the virtual content, and optionally to reduce the need to continue to display virtual content 712.

As described with reference to method 800, in some embodiments, as a part of the input, computer system 101 detects that a location of a respective portion of user 701 corresponds to a respective portion of the physical environment (e.g., corresponds to the area of virtual content 704)—referred to herein as a viewing region. In some embodiments, computer system 101 optionally is agnostic as to which particular portion of the user corresponds to the viewing region. For example, a first input including movement of the user's foot into the region and a second input including movement of the user's hand into the region optionally are treated similarly, or the same, such that virtual content 712 optionally is displayed in response to the first and/or the second input. In some embodiments, computer system 101 detects an input in accordance with movement of an expected one or more portions of the user moving into the region. For example, computer system 101 optionally displays virtual content 712 in response to detecting both of the user's feet entering the region, but not in response to a single foot entering the region, and/or not in response to a user's hand entering the region. Thus, as shown in FIG. 7B, computer system 101 displays virtual content 712 in response to the user's feet entering the respective region of the physical environment corresponding to virtual content 704.

In some embodiments, additional virtual content associated with virtual content 704 is displayed in response to the input. For example, computer system 101 optionally displays one or more selectable options, such as grabber 714-1, grabber 714-2, and/or grabber 714-3. In some embodiments, computer system 101 detects input directed toward grabber 714-1, grabber 714-2, and/or grabber 714-3 associated with virtual content 704, and modifies one or more dimensions of virtual content 704. For example, computer system 101 optionally detects attention (e.g., gaze) of the user directed to a respective selectable option 714 concurrent with detection of an air gesture of hand 703A. For example, the air gesture optionally is an air pinch gesture including contacting of the index finger and the thumb of hand 703A. In some embodiments, the input includes movement of hand 703A while the air pinch gesture is maintained. While the air pinch gesture is maintained, for example, computer system 101 detects movement of the hand, and modifies one or more dimensions of virtual content 704 in accordance with the movement. For example, as indicated by attention 715B, computer system 101 detects movement of hand 703A while the air pinch gesture is maintained and scales (e.g., elongates) virtual content 704 based on movement of hand 703A away from user 701 and/or scales (e.g., shrinks) virtual content 704 based on movement of hand 703A toward user 701 moving parallel to a first dimension (e.g., a depth) of virtual content 704.

In some embodiments, computer system 101 scales virtual content 704 by an amount of scaling in a first direction based on a magnitude of a component of movement of hand 703A parallel to the first direction, disregarding movement of the hand in a second direction, different from the first. For example, as described with reference to grabber 714-1, computer system 101 optionally detects movement of hand 703A away and to the left of the user while maintaining an air pinch gesture and while attention of the user is directed to grabber 714-1, and forgoes consideration of the magnitude of movement in the leftward direction, instead scaling virtual content 704 based solely on a magnitude of a component of movement toward or away from user 701 (e.g., parallel to the depth of virtual content 704). Similarly, with reference to grabber 714-3, computer system 101 optionally scales virtual content 704 in accordance with a magnitude of leftward movement and/or rightward movement of hand 703A and forgoes consideration of a magnitude of movement toward and/or away from user 701. In some embodiments, computer system 101 scales virtual content 704 along multiple dimensions in accordance with movement in multiple directions. For example, with reference to grabber 714-2, computer system 101 optionally scales virtual content 704 in accordance with a magnitude of movement of hand 703A toward, away from, to the left of, and/or to the right of user 701, to scale the width and/or length of virtual content 704. In some embodiment, the magnitude of movement of the user scales virtual content 704 equally in multiple directions. For example, moving hand 703A forward by a first magnitude of movement in a first direction optionally equally scales virtual content 704 by a first amount along a first and a second dimension (e.g., its depth and width). Similarly, moving hand 703A rightward by the first magnitude of movement, optionally scales virtual content 704 along the first and the second dimensions by the first amount.

In some embodiments, computer system 101 optionally forgoes display of virtual content 712 in accordance with satisfaction of one or more criteria, described further with reference to method 800. For example, computer system 101 optionally is aware that user 701 has recently received an input requesting display of virtual content at the level of immersion greater than the immersion threshold, and as such, forgoes display of virtual content 712. Such a scenario optionally is beneficial when the user temporarily or erroneously moves outside of a boundary of virtual content 704, thereby upon reentry into the boundary, computer system 101 optionally forgoes redundantly prompting the user to confirm their intent to display the virtual content at the level of immersion. In some embodiments, virtual content 712 is displayed with a respective opacity and/or other visual characteristics (e.g., brightness, color, border, and/or visual effect) such that the user does not mistakenly overlook virtual content 712. For example, virtual content 712 optionally is fully opaque and optionally displayed with a colored border.

In some embodiments, in response to selection of selectable options 712-1 and/or 712-2, computer system 101 initiates a process to evaluate the user's physical environment. The evaluation optionally includes a scan of the physical environment. In some embodiments, the evaluation initiates prior to selection of selectable options 712-1 and/or 712-2, such as in response to the input to display the virtual content at the level of immersion greater than the immersion threshold, in response to a powering up of the device, and/or in response to other user interactions with computer system 101. In some embodiments, computer system 101 displays a representation of a scan, such as a grid pattern overlaid over the subject of the scan. In some embodiments, the scan includes the viewing region and/or a region bounded by virtual content 704 of the user's physical environment. In some embodiments, the computer system does not initiate display of virtual content at the level of immersion until such a scan is completed. In some embodiments, the scan includes the majority or entirety of the user's physical environment in front of the user's viewpoint, and a portion of the environment behind the user's viewpoint. In some embodiments, the scan includes one or more portions of the physical environment corresponding to the viewing region corresponding to virtual content 704 (e.g., the respective region of the physical environment with which the user is likely to interact) and/or one or more portions of the physical environment outside of the viewing region. In some embodiments, computer system 101 optionally detects selection of selectable option 712-1 and/or 712-2, and in response to such a selection, initiates display of the virtual content at the level of immersion greater than the immersion threshold, as described in further detail below and/or ceases display of virtual content 712.

FIG. 7B1 illustrates similar and/or the same concepts as those shown in FIG. 7B (with many of the same reference numbers). It is understood that unless indicated below, elements shown in FIG. 7B1 that have the same reference numbers as elements shown in FIGS. 7A-7D have one or more or all of the same characteristics. FIG. 7B1 includes computer system 101, which includes (or is the same as) display generation component 120. In some embodiments, computer system 101 and display generation component 120 have one or more of the characteristics of computer system 101 shown in FIGS. 7A-7D and display generation component 120 shown in FIGS. 1 and 3, respectively, and in some embodiments, computer system 101 and display generation component 120 shown in FIGS. 7A-7D have one or more of the characteristics of computer system 101 and display generation component 120 shown in FIG. 7B1.

In FIG. 7B1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 7A-7D.

In FIG. 7B1, display generation component 120 is illustrated as displaying content that optionally corresponds to the content that is described as being displayed and/or visible via display generation component 120 with reference to FIGS. 7A-7D. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 7B1.

Display generation component 120 has a field of view (e.g., a field of view captured by external image sensors 314b and 314c and/or visible to the user via display generation component 120, indicated by dashed lines in the overhead view) that corresponds to the content shown in FIG. 7B1. Because display generation component 120 is optionally a head-mounted device, the field of view of display generation component 120 is optionally the same as or similar to the field of view of the user.

In FIG. 7B1, the user is depicted as performing an air pinch gesture (e.g., with hand 703A) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 7A-7D.

In some embodiments, computer system 101 responds to user inputs as described with reference to FIGS. 7A-7D.

In the example of FIG. 7B1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 7A-7D and/or described with reference to the corresponding method(s) are optionally implemented on computer system 101 and display generation unit 120 in a manner similar or analogous to that shown in FIG. 7B1.

FIG. 7C illustrates display of virtual content at a level of immersion greater than a threshold level of immersion in response to the input selecting option 712-1 in FIG. 7B. Virtual content 704 has been scaled in accordance with the attention, selection, and request to scale virtual content 704 as described in FIG. 7B. Thus, virtual content 704 as shown is relatively larger than as shown in FIG. 7B.

As described herein, displaying virtual content at a level of immersion optionally includes any suitable manner of displaying virtual content that was not displayed before the input requesting the display was received (e.g., so as to replace at least a portion of the visibility of the physical environment in three-dimensional environment 702) and/or optionally includes modifying visual characteristic(s) of the virtual content, and described in additional detail with reference to method 800. For example, virtual content 716 optionally corresponds to an immersive visual experience. Such an immersive visual experience optionally includes displayed representations of a simulated real-world scene, such as a previously recorded video of a campground. In some embodiments, the immersive visual experience optionally includes a depiction of an entirely, or mostly entirely virtual environment (e.g., a simulated physical space). For example, virtual content 716 as shown in FIG. 7C illustrates a virtual sky, which is a portion of a virtual environment at a virtual beach. Virtual content 716 optionally includes further virtual content such as user interfaces of applications associated with computer system 101, virtual avatars of users of other computer systems, virtual avatars not corresponding to users (e.g., non-user characters), virtual objects, and other suitable virtual content. In some embodiments, the displaying of the virtual content occurs gradually. For example computer system 101 optionally initiates display of virtual content 716 starting from a respective portion of the user's view (e.g., the right, the left, an upper portion, a center, a lower portion, a portion corresponding to a previous location of other virtual content such as virtual content 708A in FIG. 7A, and/or a combination of one or more of such portions). For example, the computer system 101 optionally initiates displaying virtual content 716 at the upper region of the user's field of view, and optionally continues to display portions of virtual content 716 toward another respective portion (e.g., a lower region) of the user's field of view, such that the amount of virtual content 716 that is shown in FIG. 7C is gradually revealed in three-dimensional environment 702. Alternatively, the virtual content 716 optionally is displayed beginning from the right side of the user's field of view and ending toward the left side of the user's field of view, or vice-versa. Thus, in some embodiments, displaying virtual content at the level of immersion greater than the level of immersion optionally includes displaying virtual content that was not displayed when the input requesting the display of the virtual content was received.

As described previously, in some embodiments, displaying the virtual content at the level of immersion greater than the immersion threshold optionally includes modifying visual characteristics of the virtual content. For example, computer system 101 optionally applies one or more visual effects, such as a blurring effect, a feathering effect, and/or a modification of colorspace (e.g., slightly less bright and/or saturated than a terminal brightness and/or saturation of the respective content) of one or more respective portion(s) of virtual content 716. The one or more respective portions optionally include the most recently displayed portions of virtual content 716. For example, while virtual content 716 is loading from an upper region of the user's field of view toward a lower region of the user's field of view, the lowermost respective portion of the virtual content optionally is blurred and/or feathered, thus enhancing visual focus and reducing an abrupt loading of such content. In some embodiments, after additional respective portions of virtual content 716 are displayed with the level of immersion greater than the immersion threshold, computer system 101 modifies display of respective portions of the virtual content that were previously displayed. For example, a first respective portion that was previously at the “bottom” of the displayed virtual content 716 is no longer at the bottom as the display of a second respective portion of the virtual content below the first respective portion progresses, and as such, the computer system 101 modifies the first respective portion to cease display of the visual effect. For example, the first respective portion optionally is displayed with a saturation, level of translucency, and/or other visual effect. In some embodiments, computer system 101 optionally displays the first portion of virtual content 716 simultaneously, or nearly simultaneously, rather than gradually displaying the first portion along one or more directions (e.g., left to right, top to bottom, and/or some combination thereof). For example, computer system 101 optionally gradually fades in (e.g., increases in opacity) the first portion of virtual content 716 in its entirety. In some embodiments, the fading in includes a blooming visual effect. The blooming visual effect optionally includes increasing opacity of a central portion of the first portion at a greater rate than an increasing of opacity of distal portions of the first portion of the virtual content 716.

In some embodiments, computer system 101 at least temporarily continues to display a portion of the respective region of the user's physical environment while displaying the virtual content at the level of immersion greater than the immersion threshold. For example, computer system 101 optionally displays a first portion of virtual content 716 such that the first portion consumes the majority of the user's field of view, but does not display a second portion of the virtual content at the level of immersion greater than the immersion threshold for a period of time (e.g., 0.01, 0.05, 0.1, 0.5, 1, 5, 10, 15, 25, 50, 100, or 500 seconds) and/or until the user provides an express input to initiate display of the second portion at the level of immersion greater than the immersion threshold (e.g., an actuation of a physical or virtual button, input including a voice command, and/or an air gesture such as movement of a hand of the user swiping downward toward the bottom of the user's field of view). In some embodiments, the second portion includes the respective region corresponding to virtual content 704. While the second portion of the virtual content is not displayed at the level of immersion greater than the immersion threshold, the user optionally has visibility of physical objects in the user's physical environment such as physical object 706, potential contours such as a raised portion of the floor and/or a curb of a sidewalk, and/or other elements of the user's environment. Such a visual configuration allows the user to study the details of their physical environment, clear the region of likely interaction of obstructions, and/or move to a respective portion of the region such that their movement and interactions with the physical environment (e.g., around a floor of the user) is unimpeded, or at the very least known to the user. Thus, in some embodiments, the computer system optionally preserves display of the user's physical environment in which the user expects likely interaction, thereby improving user awareness of their surroundings and reducing the likelihood that the user encounters spatial conflicts and/or collisions while moving and interacting with the virtual content.

In some embodiments, in response to displaying virtual content 716 at a level of immersion greater than immersion threshold, computer system 101 modifies and/or ceases display of virtual content 704. For example, prior to the displaying of the virtual content at the level of immersion greater than the immersion threshold, computer system 101 optionally displays virtual content 704 as an at least partially transparent ring or rectangle displayed overlaid the floor surrounding the user. When initiating display of the virtual content at the level of immersion greater than the immersion threshold, computer system 101 optionally ceases display of the transparent ring and/or rectangle, and replaces the virtual content with second virtual content. In some embodiments, computer system 101 optionally does not cease display of virtual content 704, but instead modifies the display of virtual content 704. The modified version of virtual content 704 optionally has one or more characteristics of the display of the second virtual content, but it is understood the two embodiments—while similar—optionally are distinct. In some embodiments, the second virtual content is displayed with an animation. For example, the second virtual content optionally includes one or more simulated light sources illuminating a representation of a floor of the user. In some embodiments, the one or more simulated light sources include one or more concentric rings of such light emanating from a current position of the user (e.g., from the user's feet). For example, the simulated light optionally begins at a point corresponding to a respective portion of the user such as their feet, and over time spreads outward toward the outer portions of the viewing region corresponding to virtual content 704. In some embodiments, the rings additionally or alternatively include display of lines emanating from the user and spreading over the floor. In some embodiments, the second virtual content optionally includes a pulsing of simulated light throughout the viewing region corresponding to virtual content 704. For example, the pulsing optionally includes a rhythmic brightening and dimming of the viewing region. In some embodiments, the second virtual content corresponds to a larger or smaller area of a representation of the physical environment of the user as compared to virtual content 704 shown in FIG. 7B.

In some embodiments, the display of the second virtual content and/or modification of virtual content 704 (e.g., the virtual content and effects applied at areas corresponding to the viewing region) occur concurrently while the second (e.g., lower) portion of virtual content 716 is not displayed at the level of immersion greater than the immersion threshold and the first portion of virtual content 716 is displayed at the level of immersion greater than the threshold. For example, the computer system optionally displays the simulated light spreading over a floor of the user's environment while a lower portion of virtual content 716 is not displayed. In some embodiments, if the second virtual content is displayed with an animation, computer system 101 ceases display of the animation after a threshold period of time (e.g., 0.01, 0.05, 0.1, 0.5, 1, 5, 10, 15, 25, 50, 100, or 500 seconds). In some embodiments, after the threshold period of time, computer system 101 displays a static visual indication, such as a ring indicating a border of the user's viewing region.

FIG. 7D illustrates a replacing of the representation of the user's physical environment corresponding to the viewing region with virtual content. For example, after the first portion of the virtual content 716 has been displayed for a period of time (e.g., 0.01, 0.05, 0.1, 0.5, 1, 5, 10, 15, 25, 50, 100, or 500 seconds) and the second portion of the virtual content 716 has not been displayed for the period of time, computer system 101 initiates displaying of the second portion of virtual content 716. In some embodiments, the displaying of the second portion of virtual content 716 has one or more characteristics of the displaying of the virtual content described with reference to the initiating of display of virtual content in FIG. 7C (e.g., initiating display of the first portion of virtual content 716). For example, if the computer system 101 initiated the display of virtual content 716 from an upper region of the user's point of view, after allowing the user to see the viewing region for a period of time, the computer system continues on to initiate display of the second portion of virtual content 716 at a level of immersion greater than the immersion threshold starting from an upper region of the second portion and progressing downward toward the floor of the environment until the second portion is entirely displayed. Thus, having given the user an opportunity to observe the viewing region and potentially clear the viewing region of objects, computer system 101 optionally continues to display a fully immersive visual experience. For example, the second portion of virtual content 716 optionally includes a floor of a virtual environment, such as sand on a beach or water in an ocean. In some embodiments, replacing a representation of the user's environment with virtual content includes obscuring physical objects within the environment. For example, in FIG. 7D, physical object 706 is no longer visible because the virtual content 716 is displayed at a level of immersion greater than a threshold level of immersion. Thus, although physical object 706 still occupies physical space in the user's environment, it no longer impedes viewing of virtual content 716. In some embodiments, computer system 101 optionally also ceases display of virtual content 704 while replacing the viewing region with the second portion of virtual content 716. In some embodiments, the displaying of the first portion of the virtual content and/or the replacing of the second portion of the virtual content includes a fading in (e.g., a gradual increase in opacity) of the first and/or the second portion, and in the case of fading in the second portion, also includes a concurrent fading out (e.g., gradual decrease in opacity) of virtual content 704 shown in FIG. 7C. For example, computer system 101 optionally increases opacity of the second portion of the virtual content 716 at a first rate and/or decreases opacity of virtual content 704 at a second rate (optionally the same as or different from the first rate) In some embodiments, if virtual content not included in virtual content 716 is displayed in the viewing region of the user, the computer system optionally also replaces display of the virtual content not included in virtual content 716 with respective virtual content in virtual content 716. For example, a virtual window corresponding to an application user interface optionally is displayed within the viewing region of the user before computer system 101 initiates display of the second portion of virtual content 716. In response to initiating display of the second portion of virtual content 716, however, computer system 101 optionally ceases display and/or fades out the virtual window in addition to the replacing of the representations of the user's environment (e.g., the viewing region).

FIGS. 8A-8F is a flowchart illustrating an exemplary method of displaying virtual content with a level of visual prominence greater than a threshold level of visual prominence in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, the method 800 is performed at a computer system, such as computer system 101 as shown in FIG. 7A, in communication with one or more input devices and a display generation component, such as display generation component 120 as shown in FIG. 7A. For example, a mobile device (e.g., a tablet, a smartphone, a media player, or a wearable device), or a computer or other electronic device. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input and/nor detecting a user input.) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device, and/or a motion sensor (e.g., a hand tracking device, a hand motion sensor). In some embodiments, the computer system is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the computer system detects (802a), via the one or more input devices, a first input corresponding to a request to display virtual content, such movement of user 701 from as shown in FIGS. 7B and 7B1 to as shown in FIG. 7C to display virtual content 716 as shown in FIG. 7C, that will visually replace a portion of a representation of a physical environment in which a user of the computer system is located while using the computer system, such as a location corresponding to user 701. For example, while optionally displaying a virtual reality (VR) or mixed reality (XR) environment (e.g., in some embodiments, the first three-dimensional environment is an extended reality (XR) environment such as a virtual reality (VR) environment, a mixed reality (MR) environment, or an augmented reality (AR) environment) including a visual representation (e.g., an icon and/or a shape displayed on a physical floor) of an immersive visual experience (e.g., a virtual environment), such as described with reference to method 1000, the computer system optionally detects movement of the user of the computer system and/or a viewpoint of the user to a position in the physical environment corresponding to (e.g., into) the visual representation. In some embodiments, a request to display virtual content includes actuation of a physical and/or virtual button. In some embodiments, a request to display virtual content includes detecting attention of the user and/or a gesture and/or pose of a respective portion of a user (e.g., the hand and/or fingers of the user). In some embodiments, the first input includes a request to view an immersive virtual experience (e.g., a virtual environment), such as a mixed-reality environment that is predominantly comprised of virtual content. In some embodiments, the virtual content and/or virtual environment is a simulated three-dimensional environment that is displayed in the three-dimensional environment, optionally instead of the representations of the physical environment (e.g., full immersion) or optionally concurrently with the representation of the physical environment (e.g., partial immersion). Some examples of a virtual environment include a lake environment, a mountain environment, a sunset scene, a sunrise scene, a nighttime environment, a grassland environment, and/or a concert scene. In some embodiments, a virtual environment is based on a real physical location, such as a museum, and/or an aquarium. In some embodiments, a virtual environment is an artist-designed location. Thus, displaying a virtual environment in the three-dimensional environment optionally provides the user with a virtual experience as if the user is physically located in the virtual environment. In some embodiments, the first input is or includes tap or hand air gesture in space such as air pointing or air pinching at an icon or other selectable option in an augmented reality (AR) or virtual reality (VR) environment to launch and/or display a virtual environment; or an input using an interface controller in an AR or VR environment to provide input to select an icon or other selectable option to launch and/or display the virtual environment, such as the first virtual environment described later. In some embodiments, the first input includes a hand of a user of the computer system performing a pinch air gesture in which the index finger and thumb of the hand of the user come together and touch while attention of the user is directed to the icon or selectable option. In some embodiments, the first input is an attention-only and/or gaze-only input (e.g., not including input from one or more portions of the user other than those portions providing the attention input).

In some embodiments, in response to detecting, via the one or more input devices, the first input and in accordance with a determination that the first input corresponds to a request to display the virtual content at a level of immersion greater than an immersion threshold (802b) (e.g., 10, 30, 50 or 75% immersion), the computer system displays (802c), via the display generation component, a visual indication, such as virtual content 704 as shown in FIG. 7C, corresponding to a respective region of the physical environment with which the user of the computer system is likely to interact while displaying the virtual content at the level of immersion greater than the immersion threshold, while a representation of the respective region of the physical environment is visible via the display generation component, such as a portion of environment 702 as shown in FIG. 7C. For example, the computer system optionally detects a request to display virtual content, such as XR and/or VR augmentation of the user's current environment. In some embodiments, the computer system is not currently displaying virtual content, or is displaying a first amount of virtual content (e.g., system user interface elements such as date, time, and computer system status(es)) and determines that a first input corresponds to a request to initiate display of second virtual content. In some embodiments, the first input includes a request to view an immersive XR or VR environment such that amount of virtual content visible and/or presented to the user of the computer system increases in response to the first input. In some embodiments, the computer system determines that the first input includes a request to display virtual content such that the requested virtual content consumes greater than a threshold amount of the user's field of view (e.g., 0.1, 1, 3, 5, 10, 15, 30, 45, 90, or 120 degrees) while the user's orientation relative to the three-dimensional environment is varied. In some embodiments, the computer system displays virtual content at a level of opacity greater than an opacity threshold (e.g., 0.01, 0.1, 1, 3, 5, 10, 50, or 90% opacity). In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed. In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion optionally is displayed without concurrently displaying the background content (e.g., in a full screen or fully immersive mode). As another example, a virtual environment displayed with a medium level of immersion optionally is displayed concurrently with darkened, blurred, or otherwise de-emphasized background content. In some embodiments, the visual characteristics of the background objects vary among the background objects. For example, at a particular immersion level, one or more first background objects optionally are visually de-emphasized (e.g., dimmed, blurred, and/or displayed with increased transparency) more than one or more second background objects, and one or more third background objects cease to be displayed. As referred to herein, visual prominence of virtual content optionally refers to display of one or more portions of the virtual content with one or more visual characteristics such that the virtual content is optionally distinct and/or visible relative to a three-dimensional as perceived by a user of the computer system. In some embodiments, visual prominence of virtual content has one or more characteristics described with reference to displaying virtual content at a level of immersion greater and/or less than an immersion threshold. For example, the computer system optionally displays respective virtual content with one or more visual characteristics having respective values, such as a virtual content that is displayed with a level of opacity and/or brightness. The level of opacity, for example, optionally is 0% opacity (e.g., corresponding to virtual content that is not visible and/or fully translucent), 100% opacity (e.g., corresponding to virtual content that is fully visible and/or not translucent), and/or other respective percentages of opacity corresponding to a discrete and/or continuous range of opacity levels between 0% and 100%. Reducing visual prominence of a portion of virtual content, for example, optionally includes decreasing an opacity of one or more portions of the portion of virtual content to 0% opacity or to an opacity value that is lower than a current opacity value. Increasing visual prominence of the portion of the virtual content, for example, optionally includes increasing an opacity of the one or more portions of the portion of virtual content to 100% or to an opacity value that is greater than a current opacity value. Similarly, reducing visual prominence of virtual content optionally includes decreasing a level of brightness (e.g., toward a fully dimmed visual appearance at a 0% level of brightness or another brightness value that is lower than a current brightness level), and increasing visual prominence of virtual content optionally includes increasing the level of brightness (e.g., toward a fully brightened visual appearance at a 100% level of brightness or another brightness value that is higher than a current brightness level) of one or more portions of the virtual content. It is understood that additional or alternative visual characteristics optionally are included in modification of visual prominence (e.g., saturation, where increased saturation increases visual prominence and decreased saturation decreases visual prominence; blur radius, where an increased blur radius decreases visual prominence and a decreased blur radius increases visual prominence; contrast, where an increased contrast value increases visual prominence and a decreased contrast value decreases visual prominence). Changing the visual prominence of an object can include changing multiple different visual properties (e.g., opacity, brightness, saturation, blur radius, and/or contrast). Additionally, when visual prominence of a first object is increased relative to visual prominence of a second object, the change in visual prominence could be generated by increasing the visual prominence of the first object, or decreasing the visual prominence of the second object, increasing the visual prominence of both objects with the first object increasing more than the second object, or decreasing the visual prominence of both objects with the first object decreasing less than the second object. It is also understood that the foregoing description of modification of visual prominence applies to the embodiments described herein.

In some embodiments, while displaying virtual content, such as virtual content 716 as shown in FIG. 7C, such as an immersive virtual scene optionally obscuring background content (e.g., representations of the user's real-world environment, such as environment 702 as shown in FIG. 7C), the computer system optionally displays a geometric indication of a likely region of interaction, such as virtual content 704 as shown in FIG. 7C. In some embodiments, the visual indication is circular, rectangular, and/or elliptical overlaid a respective region of the physical environment of the user (e.g., the floor, and/or a region above the floor). The visual indication optionally is presented to the user to indicate a region (e.g., the respective region) with which the user is likely to interact (e.g., move around within), thus illustrating where there are potential spatial conflicts between the user and real world objects. In some embodiments, the visual indication illustrates a border of the respective region of the physical environment (e.g., a border displayed overlaid over the representation of the respective region of the physical environment), such as the respective region of environment 702 corresponding to virtual content 704 as shown in FIG. 7C. In some embodiments, the respective region of the physical environment is larger or smaller than the corresponding visual indication corresponding to the respective region of the physical environment. For example, the visual indication optionally is a geometric shape overlaid over a portion of a representation of a real world floor, however, the respective region of the physical environment optionally corresponds to the entirety of the floor and/or the region of the floor visible from the user's current viewpoint, such as a floor of environment 702 as shown in FIG. 7C. In some embodiments, a prompt to clear physical objects from the respective region of the physical environment is displayed concurrently with the visual indication, such as virtual content 712 as shown in FIGS. 7B and 7B1.

In some embodiments, the computer system displays (802d), via the display generation component, the virtual content at the level of immersion greater than the immersion threshold, such as virtual content 716 as shown in FIG. 7C, including replacing at least a portion of the representation of the respective region of the physical environment with the virtual content after displaying the visual indication corresponding to the respective region of the physical environment with which the user of the computer system is likely to interact while displaying the virtual content at the level of immersion greater than the immersion threshold, such as replacing representations of the physical environment with virtual content 716 as shown in FIG. 7D. For example, a first three-dimensional environment corresponds to a mixed-reality environment including an immersive virtual experience optionally including one or more regions of virtual content. The one or more regions of virtual content, for example, optionally comprise 90% of the mixed-reality environment and one or more regions not including virtual content comprise the remaining 10% of the mixed-reality environment. In some embodiments, the immersive virtual experience includes a virtual environment that entirely, or nearly entirely, occupies a field of view of the user of the computer system. In some embodiments, the virtual content included in the virtual environment entirely occupies the field of view of the user while the user varies their physical position and/or orientation relative to the immersive virtual environment, such that the user remains surrounded by virtual content. For example, the computer system optionally displays a visual indication such as a circular or rectangular shape overlaid over a respective region (e.g., floor) of the user's physical environment indicating a region in which the computer system anticipates likely interaction with virtual content and/or in which the user optionally is allowed to move while remaining in the immersive experience, and/or in which the computer system optionally permits initiation of one or more functions. In some embodiments, the visual indication is initially displayed at a position relative to the user and the first three-dimensional environment (e.g., centered at the user's position and/or feet). In some embodiments, the visual indication is static. In some embodiments, the visual indication is animated for a period of time or continues to be animated. In some embodiments, the visual indication is partially transparent such that a virtual or real world ground or floor is at least partially visible through the visual indication. In some embodiments, at least a portion of the visual indication includes representation(s) of the physical environment. In some embodiments, the visual indication is offset from the ground or floor such that the visual indication appears to hover or has a height (e.g., 1, 3, 5, 10, 100 or 1000 cm) relative to the ground. In some embodiments, the visual indication remains visible while the respective region of the three-dimensional environment is visible from the viewpoint of the user. In some embodiments, the computer system ceases display of the visual indication after a threshold amount of time (e.g., 0.01, 0.1, 0.25, 0.5, 1, 2.5, 5, or 10 seconds) and displays virtual content at the respective region. In some embodiments, the computer system does not display the visual indication if the first input corresponds to a request to display the virtual content in the first three-dimensional environment at a level of immersion less than the immersion threshold. Temporarily displaying the visual indication corresponding to the respective region of the environment increases user safety by biasing the user towards the respective region in the physical environment of the user and foreshadowing potential collisions with physical objects within the respective region.

In some embodiments, displaying, via the display generation component, the visual indication corresponding to the respective region of the physical environment with which the user of the computer system is likely to interact while displaying the virtual content at the level of immersion greater than the immersion threshold, such as the viewing region corresponding to virtual content 704 as shown in FIG. 7C (e.g., as described with respect to step(s) 802), includes (804a), in accordance with a determination that the user is located at a first location in the physical environment (804b), the visual indication corresponding to the respective region is a first visual indication corresponding to a first region of the physical environment (804c), such as a location of virtual content 704 as shown in FIG. 7D. For example, the computer system optionally determines a position of the user relative to the physical environment, such as the position of a respective portion of the user (e.g., the user's head, the user's feet, and/or the user's torso) corresponds to the first location of the physical environment. In some embodiments, the computer system determines that the first location of the user corresponds to the respective region of the physical environment, referred to herein as a “physical viewing area.” For example, the computer system optionally determines that the first location of the user is at least partially intersecting and/or within the physical viewing area. In some embodiments, the visual indication—referred to herein as the “viewing zone”—has one or more characteristics described in step(s) 812. In some embodiments, the first region of the physical environment is defined relative to a portion of the user's viewpoint. For example, the computer system optionally determines the first region of the physical environment corresponds to a portion (e.g., 5%, 10%, 15%, 20%, 25%, 30%, 35%, or 40%) of the user's field of view extending from the physical floor towards a physical ceiling or sky. In some embodiments, the region of the physical environment corresponds to a portion (e.g., 5%, 10%, 15%, 20%, 25%, 30%, 35%, or 40%) of the physical floor relative to the user's viewpoint (e.g., centered on the physical location of the user, such as at the user's feet). In some embodiments, the region corresponds to an area of the physical environment (0.01, 0.05, 0.1, 0.5, 1, 5, 10 m²) visible relative to the user's viewpoint. In some embodiments, the first region of the physical environment has a world-locked location.

In some embodiments, the computer system replaces (804d) the portion of the representation of the respective region of the physical environment with the virtual content includes replacing at least a portion of the representation of the first region of the physical environment with the virtual content, such as shown by virtual content 716 in FIG. 7D. For example, the computer system optionally at least partially or entirely ceases display of the previously described physical viewing area and/or initiates display of the virtual content greater than the immersion threshold as described with respect to step(s) 802. In some embodiments, the physical viewing area potentially is visible (e.g., via a passive visual passthrough such as a sheet of transparent material), however, the display of the virtual content obscures visibility of the representation of the respective region. For example, if the user moves to the first position in the physical environment (e.g., has entered the viewing zone) the physical viewing area initially optionally consumes a lower region of the user's field of view while the virtual content is visible.

In some embodiments, in accordance with a determination that the user is located at a second location in the physical environment, that is different from the first location (804c), the visual indication corresponding to the respective region is a second visual indication corresponding to a second region of the physical environment, different from the first region of the physical environment such as virtual content 704 as shown in FIG. 7C displayed at a second location different from as shown (804f). For example, the visual indication optionally is displayed at a position within a XR or VR environment different from the first position, optionally corresponding to the respective portion of the user. In some embodiments, the computer system displays the visual indication at a respective region of the physical environment corresponding to the respective portion of the user.

In some embodiments, the computer system replaces the portion of the representation of the respective region of the physical environment with the virtual content includes replacing at least a portion of the representation of the second region of the physical environment with the virtual content, such as virtual content 716 replacing physical object 706 as shown in FIG. 7D (804g) (e.g., the same or similar as described with respect to replacing the first region of the physical environment with virtual content). Replacing portions of representations of the respective region of the physical environment with virtual content based on a determination that the user is located at a respective location in the physical environment provides a consistent visual experience despite variance in the respective location of the user, thereby reducing the likelihood the user will interact erroneously with virtual content and/or reducing the need for inputs to re-orient virtual content relative to the respective location.

In some embodiments, the visual indication corresponding to the respective region of the physical environment with which the user of the computer system is likely to interact is displayed in association with a floor of the physical environment (806) such as virtual content 704 as shown in FIG. 7C. For example, the viewing region (e.g., the visual indication) optionally corresponds to a portion of a floor of the physical environment of the user, such that the user is visually guided towards the floor of the physical environment. In some embodiments, the portion of the floor is a circular, rectangular, or other-shaped region of the floor of the physical environment that is optionally centered at the feet of the user. Displaying the visible indication associated with a respective region of the physical environment provides information about potential spatial conflicts with the physical environment while concurrently viewing virtual content, thus improving user safety.

In some embodiments, the visual indication has a first shape and wherein the visual indication is at least partially translucent such as virtual content 704 as shown in FIG. 7C (808). For example, the visual indication optionally is a ring-shaped graphic overlaid over a representation of a physical floor of the user, optionally illustrates a boundary of the viewing zone, and/or is optionally displayed with a respective level of translucency (e.g., 5%, 10%, 15%, 20%, 25%, 35%, 45%, 60%, or 75% translucent). In some embodiments, the visual indication has one or more characteristics as described in method 1000. Displaying the visual indication with a partial translucency reduces visual obstruction of the representation of the physical environment, thus reducing the likelihood the user undesirably collides with portions of the physical environment.

In some embodiments, the first shape is elliptically shaped and has a first respective diameter, and the visual indication includes a plurality of shapes including the first shape and a second shape, other than the first shape, wherein the second shape has a second diameter, different from the first diameter such as an elliptically shaped version of virtual content 704 as shown in FIG. 7C (810). In some embodiments, the visual indication includes a plurality of concentric shapes (e.g., rings). In some embodiments, the plurality of shapes is centered on a respective position of the user. In some embodiments, the plurality of shapes is animated similar to as described in step(s) 812. For example, the plurality of concentric shapes optionally emanates from the respective position of the user. Displaying the visual indication with a plurality of shapes draws user attention toward the respective region of the physical environment, thus reducing the likelihood the user undesirably collides with portions of the physical environment.

In some embodiments, the displaying, via the display generation component, the visual indication corresponding to the respective region of the physical environment with which the user of the computer system is likely to interact includes displaying an animation of a boundary of the visual indication, such as an animation of virtual content 704 as shown in FIG. 7C, expanding from a first position, such as a position of virtual content 704 as shown in FIG. 7C, in the three-dimensional environment corresponding to a respective portion of the user to a second position, different from the first position, in the three-dimensional environment (812). In some embodiments, the viewing zone (e.g., visual indication corresponding to the respective region of the physical environment of likely user interaction) has one or more characteristics of the animation as described in step(s) 802. For example, in response to the first input corresponding to a request to display the virtual content, such as virtual content 716 as shown in FIG. 7C, at the level of immersion greater than the immersion threshold, the computer system optionally initially displays the visual indication having a first shaped boundary and first size, such as a first boundary and first size of virtual content 704 as shown in FIG. 7C (e.g., a relatively small circle centered on the user and/or the user's feet) which optionally expands to a second shaped boundary—optionally similar to the first shape—having a relatively greater size (e.g., a relatively bigger circle) over time, such as a second size of virtual content 704 as shown in FIG. 7C. In some embodiments, the animation includes continuing to expand the boundary towards the outer extremities of the user's point of view or a maximum size defined by the computer system. In some embodiments, the animation additionally includes visual effects such as a glowing effect, a blurring effect, a modification of translucency, a lighting effect as described in step(s) 814, and/or modification of a brightness. In some embodiments, the boundary of the visual indication continuously is animated (e.g., expanded) until reaching the outer extremities of the user's point of view and/or a maximum size, such as an animation of virtual content 704 as shown in FIG. 7C. Displaying the visual indication with an animation draws user attention toward the respective region of the physical environment, thus reducing the likelihood the user undesirably collides with portions of the physical environment.

In some embodiments, the animation includes a visual effect applied to a surface of the respective region of the physical environment with which the user of the computer system is likely to interact, such as a visual effect applied to virtual content 704 as shown in FIG. 7C, (814). For example, the visual effect optionally has one or more characteristics as described in step(s) 812, such as a simulated lighting effect optionally applied to the surface (e.g., the floor, a surface of a respective object positioned on top of the floor, and/or a physical wall) of a representation of the physical viewing area. In some embodiments, the simulated lighting effect is based on one or more virtual light sources positioned and oriented towards respective positions of the physical environment. For example, a respective virtual light source optionally is visible or not visible and oriented normal to the surface of the representation of the physical viewing area. Including a visual effect applied to the surface of the respective region of the physical environment draws user attention to respective objects included within the respective region and contours of the respective region, thereby improving user safety.

In some embodiments, while animating, via the display generation component, the boundary of the visual indication corresponding to the respective region of the physical environment, in accordance with a determination that the visual indication has been animated for a period of time greater than a threshold period of time (e.g., 0.01, 0.05, 0.1, 0.5, 1, 5 10, 15, 30 or 60 seconds), the computer system ceases (816) the animation of the boundary of the visual indication such as a ceasing of an animation of virtual content 704 as shown in FIG. 7C. For example, the animation optionally gradually or abruptly ceases after the visual indication has been animated past the threshold amount of time. In some embodiments, the visual indication continues to be displayed with a default appearance (e.g., including one or more characteristics of the visual effect of the animation described in step(s) 812) after the threshold time has passed. In some embodiments, the visual indication continues to be displayed after the ceasing of the animation with a visual appearance matching the appearance of the visual effect at the time the animation is ceased. Ceasing the animation visually guides the user away from the respective region of the physical environment, thereby improving focus on the displayed virtual content and optionally indicates that particular inputs that optionally did not initiate performance of function(s) while the animation was ongoing optionally are operable to initiate performance of function(s).

In some embodiments, the displaying, via the display generation component, the virtual content at the level of immersion greater than the immersion threshold includes (818a) replacing a second representation of a second respective region of the representation of the physical environment corresponding to an upper region of a viewpoint of the user with a first portion of the virtual content, such as virtual content 716 as shown in FIG. 7C to as shown in FIG. 7D (818b). For example, the second respective region of the representation of the physical environment optionally includes a portion of the upper region of the user's field of view (e.g., 0.1, 1. 3, 5, 10, 15, 30, 45, 90, or 120 degrees). In some embodiments, the replacing of the second representation of the second respective region includes reducing a visual prominence (e.g., ceasing display and/or increasing a respective translucency) of the second representation of the second respective region. In some embodiments, the remaining (e.g., not replaced) portion of the representation of the physical environment is maintained while the replacing occurs. For example, the replacing optionally includes an animation gradually reducing respective visual prominence of the second respective region in a first direction (e.g., from the top of the user's field of view downwards towards the bottom of the user's field of view) while maintaining respective visual prominence of the remaining portion of the representation of the physical environment. Additionally or alternatively, visual prominence of the first virtual content optionally is increased while the replacing occurs. For example, the animation includes gradually increasing the visual prominence of the virtual content that replaces the second representation of the second respective region.

In some embodiments, after replacing the second representation of the second respective region, the computer system replaces a third representation of a third respective region of the representation of the physical environment corresponding to a lower region of the viewpoint of the user, lower than the upper region of the viewpoint of the user, with a second portion of the virtual content, such as virtual content 716 as shown in FIG. 7C to as shown in FIG. 7D (818c). For example, the replacing of the third representation of the third respective region of the representation of the physical environment is optionally initiated in accordance with a determination that one or more criteria are satisfied including a criterion that is satisfied when a threshold amount of time (0.01, 0.05, 0.1, 0.5, 1, 5, 10, or 15 seconds) has passed since the replacing of the second representation of the second respective region is initiated or completed. In some embodiments, the one or more criteria include a criterion that is satisfied when user input is received including a request to cease the display of the third respective region (e.g., an actuation of a physical button, a selection of a selectable affordance to cease the display of the third respective region, and/or input including detected movement within the respective region of the physical environment). In some embodiments, the replacing of the third representation of the third respective region has one or more characteristics of the replacing of the second representation of the second respective region. Additionally or alternatively, visual prominence of the first virtual content optionally is increased while the replacing occurs. For example, the animation includes gradually increasing the visual prominence of the virtual content that replaces the second representation of the third respective region. In some embodiments, the animations described herein are included in an animation that continuously replaces representations of the physical environment from a top of the user's field of view to a bottom of the user's field of view. Successively replacing respective regions of the representations of the physical environment with respective virtual content visually guides the user's attention towards the lower region of the viewpoint of the user, thereby reducing the likelihood of spatial conflicts between the user of the computer system and physical objects visible within the lower region of the viewpoint of the user.

In some embodiments, in response to detecting, via the one or more input devices, the first input, and in accordance with a determination that the one or more criteria are satisfied, including the criterion that is satisfied when the first input corresponds to the request to display the virtual content at the level of immersion greater than the immersion threshold, the computer system displays (820), via the display generation component, respective virtual content indicating that the virtual content will be displayed at the level of immersion greater than the immersion threshold, such as virtual content 712 as shown in FIGS. 7B and 7B1. For example, the computer system optionally displays a virtual object including respective virtual content (e.g., text and/or graphical icons) indicating that the immersive virtual content will be loaded. In some embodiments, the respective virtual content displays descriptions of the virtual content. In some embodiments, the respective virtual content includes one or more selectable options that are associated with the display of the virtual object and/or its respective virtual content described in further detail below. In some embodiments, as described in step(s) 824, the respective virtual content is displayed if one or more criteria are satisfied. Displaying respective virtual content indicating virtual content will be displayed at the level of immersion greater than the immersion threshold reduces the likelihood the user erroneously initiates display of the virtual content, thereby reducing processing required to initiate such erroneous display and preventing the need for input to dismiss the virtual content.

In some embodiments, the one or more criteria are satisfied independent of a number of times virtual content has been displayed at the level of immersion greater than the immersion threshold, such as the number of time virtual content 716 as shown in FIG. 7C has been displayed (822). For example, the virtual object described in step(s) 820 optionally is displayed every time in response to the first input, regardless of a previous history of interaction associated with the virtual content (e.g., a number of times an input similar to the first input has been received and/or a number of times the virtual content or other virtual content at a level of immersion greater than the immersion threshold has been displayed). In some embodiments, as described in step(s) 820, the virtual object includes one or more selectable options (e.g., including “confirm” and/or including “do not show again”). In some embodiments, in response to detecting an input selecting a respective affordance included in the respective virtual content, the computer system initiates the display of virtual content (e.g., the immersive visual experiences described in step(s) 802). In some embodiments, the one or more criteria include a criterion that is satisfied when the user has not previously selected a respective affordance (e.g., “do not show again”) included in the respective virtual content (e.g., as described with respect to step(s) 824, the computer system optionally forgoes the display of the virtual object (e.g., the respective virtual content indicating that the virtual content will be displayed at the level of immersion greater than the immersion threshold)). Displaying the respective virtual content independent of a number of times the virtual content has been displayed ensures the user has a consistent expectation of what is displayed in response to the first input, thereby reducing the likelihood that the user erroneously directs input to the virtual content.

In some embodiments, in response to detecting, via the one or more input devices, the first input, and in accordance with a determination that the one or more criteria are not satisfied (e.g., as described in step(s) 822), the computer system forgoes (824) the displaying, via the display generation component, of the respective virtual content, such as foregoing display of virtual content 716 as shown in FIG. 7C. For example, the one or more criteria include a criterion that is not satisfied when the user has recently interacted with respective virtual content (e.g., the respective virtual object) described in step(s) 820. In some embodiments, the one or more criteria include a criterion that is not satisfied based on a recency of interaction described in step(s) 826. For example, the computer system optionally forgoes display of respective virtual content such as the virtual object and/or virtual content if the one or more criteria are not satisfied. As another example, the computer system optionally determines that the user has recently provided an input requesting display of the virtual content at the level of immersion greater than the threshold level of immersion, and accordingly forgoes the display of the respective virtual content. Forgoing the displaying of the respective virtual content reduces user input required to cease displaying of the respective virtual content.

In some embodiments, the one or more criteria include a criterion that is satisfied based on a recency of a previous interaction of the user of the computer system with the virtual content (826). For example, the computer system optionally forgoes display of the respective virtual content, such as shown in FIG. 7A, in which computer system 101 forgoes display of virtual content 712 as shown in FIGS. 7B and 7B1, if the computer system detects that the user has recently interacted with the virtual content, such as a request to display virtual content 712 as shown in FIGS. 7B and 7B1 (e.g., initiated loading of virtual content, dismissed virtual content, and/or moved respective virtual content into and/or away from the virtual content). In some embodiments, the one or more criteria include respective criterion that are satisfied when the user recently interacted with the virtual content, such as virtual content 716 as shown in FIG. 7C, that was displayed at a level of immersion greater than an immersion threshold, similar or the same as described in step(s) 802. In some embodiments, the one or more criteria include a criterion that is satisfied when the user has not provided such a recent interaction within a threshold amount of time (e.g., 0.05, 0.1, 0.5, 1, 5, 10, 50, 100, or 500 hours) from receiving the first input, such as a threshold amount of time within detecting user 701 move to a position as shown in FIGS. 7B and 7B1. Including a criterion that is satisfied based on a recency of a previous interaction of the user of the computer system with the virtual content reduces display of redundant respective virtual content that the user may not wish to view.

In some embodiments, the one or more criteria include a criterion that is satisfied based on a recency of detecting, via the one or more input devices, a previously received respective input corresponding to a request to display respective virtual content at a level of immersion greater than the immersion threshold in the respective region of the physical environment, such as a recency of detecting input of hand 703A directed to selectable option 712-1 (828). For example, as described in step(s) 824-826. In some embodiments, the previously received respective input is the same as the first input described with respect to step(s) 802. In some embodiments, the previously received respective input is a different input, such as an input to display recently displayed virtual content (e.g., the immersive visual experience(s) described in step(s) 802). In some embodiments, the recency of detecting a respective input is at least partially based on the respective physical environment the user was within when the respective input was detected. For example, the one or more criteria optionally include a criterion that is satisfied when the respective input was received while the user was within a respective physical environment (e.g., a room) that is the same as a current physical environment (e.g., the same room). In some embodiments, the one or more criteria include a criterion that is not satisfied when the user was within a different respective physical environment—such as a first room—when the respective input was received that is different from the current physical environment of the user—such as a second room, different from the first room. In some embodiments, the one or more criteria include a criterion that is satisfied when a degree to which the current physical environment is similar to a respective physical environment the user was within when the respective input was received is greater than a threshold amount (e.g., 5%, 10%, 15%, 25%, 35%, 50%, 65%, 75%, or 90%). For example, the current physical environment optionally is a first room, and the respective physical environment optionally corresponds to a doorway connected to the first room and a second, different room. Including a criterion that is satisfied based on a recency of detecting a previously received, respective input corresponding to a request to display respective virtual content reduces display of redundant respective virtual content due to a recency of the user having provided such respective input while within a similar physical environment.

In some embodiments, the replacing the at least the portion of the representation of the respective region of the physical environment, such as physical object 706, with the virtual content after displaying the visual indication corresponding to the respective region of the physical environment with which the user of the computer system is likely to interact includes maintaining display of at least a portion of the representation of the respective region of the physical environment, such as virtual content 716 as shown in FIG. 7D (830). For example, the computer system optionally maintains visibility of at least a portion of the physical viewing area and optionally replaces a different portion of the physical viewing area with virtual content (e.g., a portion of an immersive visual experience) similar to as described in step(s) 802. In some embodiments, representations of physical objects within the physical viewing area remain partially or entirely visible as a part of the maintaining and replacing of respective portions of the physical viewing area with virtual content. For example, the computer system optionally replaces representations of the physical world from a top-most portion of the user's field of view down towards a lower portion of the user's field of view, optionally partially intersecting with a physical object (e.g., a toy, a block, a couch, and/or a table) such that an upper portion of the physical object is replaced with virtual content while a lower portion of the representation physical object continues to be displayed. In some embodiments, the representation of the physical viewing area is maintained, but is reduced in visual prominence (e.g., at an increased translucency) at least partially because the virtual content that begins to replace representations of the physical viewing area is displayed with reduced visual prominence (e.g., with a relatively increased amount of translucency). In some embodiments, respective portions of representations of the physical viewing area (e.g., representations of physical objects) are displayed with a reduced prominence while other remaining portions of the physical viewing area are replaced with virtual content. Thus, the computer system optionally preserves visibility of one or more portions of the user's physical environment for at least a portion of time. In some embodiments, the maintaining of the at least the portion of the representation of the physical environment is ceased if one or more criteria are met, as further described in step(s) 830. In some embodiments, the computer system detects the presence of physical objects within the physical viewing area and forgoes replacing representations of the physical objects and/or respective portions of representations of the physical environment with virtual content. In some embodiments, if the computer system does not detect physical objects within a respective portion of the physical viewing area, the computer system replaces the representations of the respective portion of the physical viewing area with virtual content. In some embodiments, display of a first representation of a first respective region including a physical object is maintained while a representation of a second respective region is replaced with virtual content. At least partially maintaining display of the representation of the physical environment while replacing the representation of the physical environment with virtual content visually emphasizes the presence of physical objects within the user's environment, thereby reducing potential physical collisions with such physical objects.

In some embodiments, while maintaining the display of the at least portion of the representation of the respective region of the physical environment, such a portion of environment 702 not consumed by virtual content 716 as shown in FIG. 7C, in accordance with a determination that the portion of the representation of the respective region of the physical environment has remained visible for an amount of time greater than a threshold amount of time (0.01, 0.05, 0.1, 0.5, 1, 5, 10, or 15 seconds), the computer system replaces (832) the at least portion of the representation of the respective region of the physical environment with the virtual content at the level of immersion greater than the immersion threshold, such as shown by the replacing with virtual content 716 as shown in FIG. 7D. For example, while maintaining the display of a portion of the physical viewing area, and in accordance with a determination that one or more criteria are satisfied, including a criterion that is satisfied when at least the portion of the physical viewing area has remained visible for more than the threshold amount of time, the computer system optionally initiates the replacing of that remaining portion of the physical viewing area with virtual content at the level of immersion greater than the immersion threshold. In some embodiments, the replacing includes displaying an animation of the virtual content having one or more characteristics of the animation described in step(s) 812 and in step(s) 818. Replacing the at least portion of the representation of the respective region of the physical environment after the representation has been visible for greater than a threshold amount of time improves the user's orientation of the physical world with respect to the virtual content, thereby reducing inputs to manually cause such replacing and orienting of the user, and reducing the likelihood of collision between the user and the physical environment.

In some embodiments, the representation of the respective region of the physical environment includes a portion of the physical environment corresponding to a lower region of a viewpoint of the user of the computer system, such as the portion of environment 702 not consumed by virtual content 716 as shown in FIG. 7C (834). For example, as described in step(s) 802 and step(s) 828. For example, a region of the user's viewpoint corresponding to the physical viewing area optionally remains visible for at least a period of time during the maintaining of display of at least a portion of the physical view area described in step(s) 828. In some embodiments, the lower region corresponds to any respective point of the physical environment beneath a threshold (e.g., 0.01, 0.025, 0.05, 0.25, 0.5, 1, 2.5, or 5 m) height. Additionally or alternatively, the lower region optionally corresponds to an amount of the user's field of view (e.g., 0.1, 1, 3, 5, 10, 15, 30, 45, 90, or 120 degrees of the lower portion of the user's field of view). In some embodiments, the degree to which the representation of the respective region of the physical environment consumes the user's field of view is variable based on an orientation of a second portion of the user's body (e.g., head) relative to the physical environment. For example, the computer system optionally entirely displays representations of the respective region of the physical environment (e.g., without displaying immersive virtual content or displaying a minimal amount of immersive virtual content) while the second portion of the user's body is directed towards a boundary (e.g., the floor) of the physical viewing region. In response to optionally detecting the second of the portion move to a second orientation (e.g., corresponding to a field of view including the portion of the respective region of the physical environment that has been replaced with immersive visual content), the computer system optionally concurrently displays the immersive virtual content and/or the at least the portion of the representation of the physical environment in accordance with a boundary of the virtual content displayed at a level of immersion greater than the immersion threshold and the remaining portions of the physical viewing area that have not been consumed by the virtual content. Maintaining display of the lower region of the representation of the physical environment of the user of the computer system in which the user is likely to move, sit and/or stand while displaying virtual content with an immersion level greater than an immersion threshold improves user awareness of their physical surroundings thereby reducing the likelihood of physical collisions with the environment and reduces the need to cease display of virtual content in the lower region to gain such awareness.

In some embodiments, in response to the detecting, via the one or more input devices, the first input, the computer system displays (836), via the display generation component, a selectable option that is selectable to forgo the displaying of the visual indication in response to future inputs corresponding to requests to display the virtual content at the level of immersion greater than the immersion threshold, such as selectable option 712-2 as shown in FIG. 7D. For example, as described with respect to step(s) 822, the computer system optionally displays a plurality of selectable options to indicate the user's intent to forgo display of virtual content such as the visual indication in the future. The computer system optionally displays a selectable option to forgo the displaying of the visual indication in the future in response to the first input, and optionally detects input selecting the selectable affordance. In some embodiments, in response to detecting a second input corresponding to a second request to display the virtual content at the level of immersion greater than the immersion threshold, and in accordance with a determination that one or more criteria are satisfied including a criterion that is satisfied when the user of the computer system has previously selected the selectable option, the computer system forgoes the displaying of the visual indication (e.g., a geometric shape). In some embodiments, the display of the visual indication is not forgone, but instead is modified. For example, the visual indication optionally is displayed with a modified appearance (e.g., increased translucency, an added blurring effect, and/or a decreased brightness) in response to the second input if the one or more criteria are satisfied. Presenting a selectable option to later forgo the displaying of the visual indication reduces the need for future inputs to cease display of the visual indication.

In some embodiments, in response to detecting, via the one or more input devices, the first input, the computer system displays (838), via the display generation component, a second visual indication, different from the visual indication, indicating that a process to determine one or more characteristics of the physical environment of the user, including the respective region of the physical environment, has been initiated, such as an indication of determining characteristics of environment 702 as shown in FIG. 7D. For example, the computer system optionally displays a progress indicator to communicate that the computer system is evaluating the physical environment. In some embodiments, the progress indicator is a graphical icon that is modified in accordance with the progress of the evaluation (e.g., a ring that gradually darkens and/or is filled). In some embodiments, the progress indicator includes a grid overlaid over the representation of the physical environment following the contours the physical environment (e.g., the object, the floor, and/or the walls). In some embodiments, the second visual indication is displayed concurrently with the visual indication described in step(s) 802. In some embodiments, the second visual indication is displayed until the evaluation of the physical environment is completed; in response to completion of the evaluation, display of the second visual indication is ceased and display of the visual indication is initiated. In some embodiments, one or more characteristics of the physical environment such as the area of the floor of the physical environment, the presence of objects within the physical environment, the location of walls within the physical environment, and/or contours of surfaces in the physical environment. Displaying an indication of evaluation of the physical environment of the user illustrates that the computer system optionally is not yet responsive to some user input(s), thereby reducing erroneous user input(s).

In some embodiments, while displaying, via the display generation component, the visual indication, the computer system displays (840a), via the display generation component, a selectable option that is selectable to modify the visual indication, such as selectable option 1714-1 as shown in FIGS. 7B and 7B1. For example, the selection option optionally is a shape that is selectable to scale the visual indication in one or more directions.

In some embodiments, while displaying, via the display generation component, the selectable option, the computer system receives (840b), via the one or more input devices, a second user input including a selection of the selectable option and a request to move the selectable option, such as in put from hand 703A as shown in FIGS. 7B and 7B1. For example, the computer system optionally detects an air pinch gesture (e.g., a convergence and maintenance of contact of an index finger and a thumb of the user) performed with a first portion of the user (e.g., a hand) while attention of the user is directed to the selectable option and movement of the first portion of the user. The second user input optionally corresponds to a selection and movement performed by a pointing device (e.g., a mouse, a stylus, and/or a glove), or another air gesture (e.g., a squeezing of a hand of the user while attention is directed to the selectable option and scaling of the visual indication in accordance with movement of the hand until a similar squeezing of the hand is detected).

In some embodiments, in response to receiving the second user input, the computer system modifies (840c) the visual indication in accordance with the movement of the selectable option, such as shown by the virtual content 704 as shown in FIGS. 7B and 7B1 compared to as shown in FIG. 7C. For example, the computer system optionally detects a leftward and upward movement of the air pinch gesture while the user's attention is directed to a selectable option overlaid over an upper-left hand corner of the visual indication (e.g., having a semi-rectangular shape or another shape), and optionally expands the visual indication and optionally moves the selectable option in accordance with the movement (e.g., away from the user and to the left of the user or in another direction). In some embodiments, the visual indication is scaled along a respective one or more dimensions in accordance with the movement. In some embodiments, the visual indication is scaled equally in all directions in accordance with the movement. Presenting selectable options for modifying the visual indication allows the user of the computer system to reduce visual conflicts between the visual indication and respective content such as virtual content and/or representations of the physical environment, and indicates to the computer system a likely region of physical interaction such that the computer system can determine how to present virtual content and accordingly modify visual prominence of virtual content and/or representations of the user's physical environment.

In some embodiments, the visual indication corresponding to the respective region of the physical environment with which the user of the computer system is likely to interact is displayed after detecting one or more characteristics (e.g., size, shape, and/or location of one or more physical objects) of the physical environment of the user, such as environment 702, including the respective region of the physical environment, such as virtual content 704 as shown in FIG. 7C (842). For example, as described with respect to step(s) 836. In some embodiments, the process is initiated and/or completed prior to receiving the first input requesting display of virtual content at an immersion level greater than an immersion threshold. For example, the computer system optionally initiates and/or completes the process in response to detecting the user enter a (optionally new) physical environment (e.g., a room or other physical space). In some embodiments, the process is initiated and/or completed in response to the first input. In some embodiments, the process includes determining one or more characteristics of the physical environment or a portion of the physical environment. For example, the computer system optionally determines one or more characteristics of a first portion of the physical environment optionally including portions of the physical environment in front of the user's current viewpoint and optionally including portions behind the user's current viewpoint (e.g., 0.01, 0.05, 0.1, 0.5, 1, 5, 10, 15, 25, 50, or 100 m behind the user), but not including the entirety of the physical environment behind the user's current viewpoint. In some embodiments, the process is initiated as described in the foregoing embodiments and continued concurrently while the user is displaying the virtual content at the level of immersion greater than the immersion threshold. Displaying the visual indication after the computer system has initiated a process to determine characteristic(s) of the physical environment ensures the computer system is aware of the physical environment and thereby is able to display the visual indication at a respective region of the physical environment corresponding to a region of likely interaction, thereby improving user awareness of the physical environment.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-9E illustrate examples of a computer system reducing visual prominence of immersive virtual content and displaying an area of likely interaction in accordance with some embodiments.

FIG. 9A illustrates decreasing of visual prominence of virtual content in accordance with embodiments of the disclosure. FIG. 9A illustrates a computer system 101 displaying, via a display generation component (e.g., display generation component 120 of FIG. 1), a three-dimensional environment 902 from a viewpoint of the user 901 illustrated in the overhead view (e.g., facing the back wall of the physical environment in which computer system 101 is located. As described above with reference to FIGS. 1-6, the computer system 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user).

As shown in FIG. 9A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 902 or portions of the physical environment are visible via the display generation component 120 of computer system 101. For example, three-dimensional environment 902 includes portions of the left and right walls, the ceiling, and the floor in the physical environment of user 901.

In FIG. 9A, three-dimensional environment 902 also includes virtual content, such as virtual content 904. Virtual content 916 optionally has one or more characteristics described relative to virtual content 904, and optionally has one or more characteristics of the virtual environments and/or immersive visual experiences described with reference to FIGS. 7A-7D. In some embodiments, virtual content 916 corresponds to a virtual environment, and has one or more characteristics of the virtual environments described with reference to FIGS. 7A-7D. In some embodiments, virtual content 904 is not yet shown, or is displayed with a level of translucency such that virtual content 904 is not visible.

In some embodiments, while displaying virtual content 916 at a level of immersion greater than an immersion threshold as described with reference to method 800 and FIGS. 7A-7D, a user of computer system 101 optionally provides an input to cease display of the virtual content at the level of immersion greater than the immersion threshold. For example, while displaying an immersive visual experience as shown in FIG. 7D, computer system 101 optionally detects an input including modification of the user's viewpoint, such as movement of the user to a second location that is away from a respective position within a three-dimensional environment, such as movement of user 901 moving towards and/or through a boundary of a viewing region associated with virtual content 904 (e.g., corresponding to virtual content 704 and viewing region described with reference to FIGS. 7A-7D). In some embodiments, the respective position optionally corresponds to a respective location within the viewing region as described with reference to FIGS. 7A-7D, such as a center of the viewing region, a boundary of the viewing region, and/or a corner of the viewing region. In some embodiments, the respective position has a world-locked location, such that the respective position corresponds to a respective physical position in the physical environment. In some embodiments, the respective position corresponds to a border of the viewing region.

In some embodiments, in response to the movement away from the respective position and/or in accordance with a determination that the user's modified viewpoint does not correspond to the respective position, computer system 101 initiates a reducing of the visual prominence of at least a portion of virtual content 916. For example, while displaying an immersive visual experience (e.g., virtual content 916, optionally corresponding to a virtual scene of a campground, a meadow, and/or a lake), in response to an input including movement of the user 901 to a second physical location that is outside the viewing region (corresponding to 904), computer system 101 begins to reduce the visual prominence of the immersive visual experience such. The reducing in visual prominence—as described in further detail below—optionally includes any suitable manner of modifying the visual appearance and/or display of the virtual content 916. In some embodiments, the reducing includes ceasing display of a portion of the virtual content 916. In some embodiments, the reducing includes modifying a translucency of the portion of the virtual content 916. Additional or alternative details relating to reducing the visual prominence of the virtual content 916 are described with reference to method 1000.

FIG. 9A shows a modification of the visual prominence of virtual content 916 according to examples of the disclosure. For example, user 901 moves away from a viewing region corresponding to virtual content 904 visible in the overhead view, and not displayed by computer system 101. In some embodiments, virtual content 904 is not displayed until a current viewpoint corresponds to a second location that is outside a respective region of the physical environment corresponding to virtual content 904 (e.g., outside the viewing region). For example, while the user's position is within the viewing region, computer system 101 optionally forgoes display of virtual content 904, and in accordance with a determination that the user's viewpoint has shifted to a second location that is outside the viewing region, computer system 101 optionally initiates display of virtual content 904 (e.g., corresponding to virtual content 704). In some embodiments, computer system 101 determines that the user have moved to a second location that is within the viewing region corresponding to virtual content 904 and forgoes a reducing of visual prominence of the virtual content. For example, computer system 101 optionally detects that the user has moved to a location within the viewing region such that the user's feet have remained within the viewing region, and accordingly maintains display of the virtual content 916.

In some embodiments, virtual content 904 corresponds to a world-locked location. For example, even if the user's viewpoint shifts in orientation and/or location within and/or outside of a boundary of virtual content 904, computer system 101 maintains an understanding of a shape and/or orientation of virtual content 904 relative to the user's physical environment. As such, from the user's perspective, virtual content 904 optionally has a fixed position within the environment 902, analogous to a physical object such as a rug that is placed on a floor of environment 902.

In some embodiments, in response to an input to initiate a reducing of visual prominence of virtual content 916, computer system 101 initiates a reducing of visual prominence of at least a portion of virtual content 916. For example, computer system 101 optionally detects an input including movement of user 901 outside of a viewing region, and in response, computer system 101 optionally modifies and/or ceases display of a portion of virtual content 916. In some embodiments, virtual content 916 includes one or more virtual objects (e.g., virtual windows including one or more user interfaces of respective applications, such as communication applications, media playback applications, and/or mapping applications), one or more representations of virtual objects (e.g., a virtual pillar, a virtual car, and/or a virtual tree), and/or immersive visual experiences (e.g., immersive visual scenes such as an immersive beach, forest, and/or outer space scenes). In some embodiments, computer system 101 interprets the movement as a request to reduce visual prominence of at least a portion of the virtual content 916, such as a request to begin viewing portions of the physical environment and/or to cease display of the virtual content entirely. In some embodiments, the modification of visual prominence of virtual content 916 to a level of immersion less than an immersion threshold optionally includes ceasing display of virtual content. For example, computer system 101 optionally ceases display of a first portion of the virtual content 916, such as portion 915. Because portion 915 optionally includes virtual content displayed at a reduced visual prominence (e.g., is displayed with 100% transparency and/or is no longer displayed), user 901 optionally is able to view physical object 910.

In some embodiments, computer system optionally applies one or more visual effects to portion 915 of virtual content 916 to indicate the reducing of the visual prominence of the portion 915 of virtual content 916. The one or more visual effects optionally include a blurring effect, a feathering effect, a dimming, and/or an increase in transparency that is uniformly or non-uniformly applied across portion 915. For example, a leftmost region of portion 915 optionally is displayed with a feathered edge and at a first degree of transparency (e.g., 5, 10, 15, 20, 30, 40, 50, 60, 75, 90, or 95% transparency) and second region to the right of the leftmost region is displayed with a second, relatively lesser degree of transparency. In some embodiments, the non-uniformly applied visual effect includes a gradient of visual effect (e.g., a gradient increasing in translucency from the leftmost region towards a rightmost region of portion 915 of virtual content 916). The non-uniformity of the visual effect optionally lends a sense of progression of the reducing in visual prominence.

In some embodiments, the direction of the reducing in visual prominence of virtual content 916 and/or portion 915 is determined in accordance with the input of the user 901. For example, because the input optionally includes leftward movement of the user 901, computer system 101 optionally initiates the reduction in visual prominence of virtual content 916 starting from a leftmost portion of the virtual content and/or field of view of the user, such as the left edge of the virtual content 916. As another example, if the input includes movement of the user backward away from the viewing region (e.g., from virtual content 904), the computer system optionally initiates reduction of the visual prominence of virtual content 916 from the upper region of the user's field of view or a lower region of the user's field of view. Conversely, if the input optionally includes movement of the user 901 forward away from the viewing region, computer system 101 optionally initiates reduction of visual prominence from the lower region or an upper region of the user's field of view (e.g., optionally in opposition to the direction of reducing of visual prominence in response to the backward movement). Thus, in some embodiments, computer system 101 reduces visual prominence of different respective portions of virtual content 916 in accordance with an input including movement of the user to a second location that is outside a respective region of the user's physical environment corresponding to a region in which the computer system expects interaction with the virtual content (e.g., a viewing region). Further, the computer system optionally reduces visual prominence such that the user gains an improved understanding of how a direction of movement optionally affects a reducing of visual prominence of the virtual content. In some embodiments, in response to detecting input including movement further away from the viewing region, computer system 101 progressively reduces visual prominence of larger portions of virtual content 916. In some embodiments, in response to detecting movement of user 901 such that user 901 is entirely outside of the viewing region, computer system 101 reduces visual prominence of virtual content 916 entirely.

FIG. 9B illustrates a ceasing of display of virtual content at a level of immersion greater than a level of immersion. In FIG. 9B, user 901 has moved to a location that is entirely outside the physical environment corresponding to the viewing region (e.g., corresponding to virtual content 904). In some embodiments, because all respective portion(s) of the user have moved outside the viewing region and/or because user 901 has remained outside the viewing region for a period of time greater than a threshold amount of time (e.g., 0.01, 0.05, 0.1, 0.5, 1, 5, 10, 15, 25, 50, 100, or 500 seconds), computer system 101 has entirely ceased display of virtual content 916 at the level of immersion greater than the threshold level of immersion. As such, physical object 906 is visible without obstruction from respective virtual content corresponding to an immersive visual experience. Additionally or alternatively to the reducing in visual prominence of the virtual content, computer system 101 optionally initiates display of virtual content 904 in response to the movement such that the user optionally is aware that movement to the viewing region corresponding to virtual content 904 optionally initiates display of immersive visual experiences (e.g., as described with reference to FIGS. 7A-7D). As described previously, computer system 101 optionally displays virtual content 904 if the user's location does not correspond to the physical region corresponding to the virtual content 904—as described with reference to method 800—such that the user optionally gains a sense of the portion of the user's environment in which computer system 101 expects interaction with respective virtual content associated with virtual content 904 (e.g., such as the virtual content 916). In some embodiments, also in response to the movement, computer system 101 displays virtual content 908A and virtual content 908B, which have one or more characteristics described with reference to virtual content 708A, and/or 708B as shown in FIGS. 7A-7D.

In some embodiments, the virtual content 904 maintains a respective world-locked location in three-dimensional environment 902. For example, virtual content 904 optionally is displayed at a first location before the user moves from an initial location at an initial viewpoint relative to their three-dimensional environment 902 into the viewing region corresponding to virtual content 904. In response to input corresponding to a request to cease display of immersive virtual content (e.g., an immersive visual experience), computer system 101 optionally displays virtual content 904 again at the first location, despite the second location of the user corresponding to a second viewpoint, different from the initial viewpoint. For example, in response to movement to a second location exiting the viewing region, computer system 101 optionally displays virtual content 904 at its previously displayed first location, as if virtual content 904 were a physical object that was present and unmoving in the user's physical environment. In some embodiments, although the world-locked location is consistent despite movement of the user to a different viewpoint, the world-locked location of virtual content 904 is not necessarily fixed. For example, computer system 101 optionally detects an input to select and move virtual content 904. The input to select and move virtual content 904 optionally includes an air gesture such as an air pinching gesture and movement of the hand while maintaining the air pinch hand shape, a swiping of the user's hand, a pointing of an index finger while attention of the user is directed toward virtual content 904, a pointing of an oblong device such as a stylus toward the virtual content 904 and detected concurrent with a contact on a housing of the stylus followed by movement of the stylus, and/or an actuation of a physical and/or a virtual button. In response to the input to select and move virtual content 904, the computer system 101 optionally moves the virtual content 904 to a second world-locked location, different from the first, in accordance with the selection and movement. In some embodiments, the second world-locked location optionally has a similar or the same location as the first world-locked location, but corresponds to a modified orientation of the virtual content 904 such as a rotation of virtual content 904 along any suitable axis of rotation.

In some embodiments, in response to the input including the movement away from the viewing region corresponding to virtual content 904, the computer system optionally displays virtual content 904 with a first visual appearance, such as shown in FIG. 9B. The first visual appearance optionally is configured to draw the user's visual focus toward the virtual content 904 such that the user is aware of the respective world locked location of the virtual content 904, for example, if the user optionally desires to re-display virtual content 916. The first visual appearance optionally is described further with reference to the size of the visual indication (corresponding to virtual content 904) in method 1000.

In some embodiments, the first visual appearance optionally includes a first size of virtual content 904. For example, computer system 101 optionally displays virtual content 904 at a larger size immediately after ceasing display of immersive virtual content (e.g., an immersive visual experience) to draw the user's visual focus to the virtual content, and over time, scales down one or more dimensions of virtual content 904. In some embodiments, the first visual appearance includes one or more visual characteristics including a size, brightness, border, saturation, hue, animation, and/or lighting effect applied to virtual content 904. In some embodiments, after the virtual content 904 is displayed with the first visual appearance for a threshold period of time (e.g., 0.01, 0.05, 0.1, 0.5, 1, 5, 10, 15, 25, 50, 100, or 500 seconds), computer system 101 displays virtual content 904 with a second visual appearance that is different from the first visual appearance of virtual content 904. For example, the second visual appearance optionally includes a scaling (e.g., scaling down) of virtual content 904, such as shown in FIG. 9C. In some embodiments, a respective visual characteristic optionally has a first value while virtual content 904 is displayed with the first visual appearance (e.g., a first size and/or brightness), and the respective characteristic optionally has a second value while virtual content 904 is displayed with the second visual appearance (e.g., a second, relatively smaller size and/or a second, relatively dimmer brightness).

In some embodiments, virtual content 908A and/or 908B have one or more characteristics described with reference to virtual content 904. For example, after ceasing display of immersive virtual content 916, virtual content 908A and/or 908B are displayed at first respective sizes, and after a similar threshold period of time, are scaled (e.g., scaled down) to second respective sizes, optionally smaller than the first respective sizes.

In some embodiments, virtual content 904, virtual content 908A, and/or virtual content 908B include information indicating one or more characteristics of respective virtual content. For example, the information optionally provides a preview of information associated with an application that provides virtual content 916 (e.g., an immersive visual experience) associated with virtual content 908A. The information optionally includes a name of the application, an icon associated with the application, and/or media such as video and/or pictures associated with the application. For example, the icon optionally is a logo of a company that provided the application and/or a logo corresponding to the application. In some embodiments, the information includes virtual content 908A, which optionally includes an icon that is displayed above virtual content 904 similar to a real-world object floating in space above a real world floor. In some embodiments, the information includes one or more colors associated with the application, one or more colors associated with respective virtual content provided by the application, and/or one or more colors associated with a representation of the application. For example, the application optionally is a communication application between respective users of respective computer systems that optionally are in communication with computer system 101, and the one or more colors indicate several unseen communications (e.g., text messages, electronic mails, and/or media) provided by a respective computer system in communication with computer system 101. In some embodiments, the one or more colors correspond to colors of respective virtual content such as an immersive visual experience provided by the application. For example, the immersive visual experience (e.g., content 916) optionally includes a beach scene, and as such, the one or more colors include a color of an ocean in the beach and/or a color of sand and/or rocks in the beach. In some embodiments, the one or more colors include colors corresponding to a representation such as an icon associated with the application. For example, the application optionally is a media playback application with an icon having a musical note having a white colored fill overlaid over a red background, and the one or more colors optionally include the white and the red to represent the icon. Thus, user 901 gains an understanding of information associated with the application at a glance, without having to provide an express input to interact with the application.

FIG. 9C illustrates modification of displayed virtual content 904. For example, as described previously, after a threshold period of time, computer system 101 optionally modifies display of virtual content such as virtual content 904. Specifically, as shown, a scale of visual indication 904 is decreased relative to as shown in FIG. 9B. Due to the relatively smaller size, the visual indication 904 optionally draws a lesser degree of visual focus, and user 901 is less likely to inadvertently move into the viewing region corresponding to visual indication 904.

FIG. 9D illustrates a request to re-display virtual content at a level of immersion greater than a threshold level of immersion. For example, user 901 moves rightward into the viewing region corresponding to virtual content 904. Similar to as described with reference to method 800, in some embodiments, computer system 101 optionally detects an input including a request to display virtual content at a level of immersion greater than a threshold level of immersion. Such an input optionally follows an input to reduce visual prominence of respective virtual content (e.g., display virtual content at a level of immersion less than the threshold level of immersion) as described with reference to FIG. 9B. In some embodiments, the display of the virtual content 916 mirrors the ceasing of the display of the virtual content 916 described in FIG. 9B. For example, while moving left out of the viewing region, computer system 101 optionally ceases display of portions of the virtual content 916 starting from the left of the viewing region. Conversely, in some embodiments, moving right back into the viewing region initiates display of the virtual content 916 starting from the right of the user's field of view, as shown in FIG. 9D. Similarly, portion 915 of virtual content 916 optionally trails the other portion of the virtual content 916 displayed, and optionally includes one or more visual effects described previously with reference to portion 915 in FIG. 9B. In some embodiments, while the user is to the right of the viewing region, computer system 101 detects leftward movement of the user towards the viewing region. In response to the leftward movement, computer system 101 initiates display of virtual content 916 starting from the left of the user's field of view. Thus, in some embodiments, virtual content 916 is displayed starting from a region of the user's field of view corresponding to the direction of movement into the viewing region, and in some embodiments, virtual content 916 is reduced in visual prominence starting from a region of the user's field of view that opposes the direction of the user 901 moving outside of the viewing region.

In some embodiments, similar to as described to method 800, computer system 101 at least temporarily maintains display of representations of regions of the user's physical environment in response to the input to re-display virtual content at the level of immersion greater than the immersion threshold. For example, in FIG. 9D, physical object 906 remains visible while virtual content 916 is gradually displayed. In some embodiments, virtual content 916 is displayed initiating from an upper region of the user's field of view toward a lower region of the user's field of view. In some embodiments, in accordance with a determination that the representation of the user's physical environment (e.g., the viewing region) has been displayed for an amount of time greater than a threshold amount of time after receiving an input to display the virtual content at a level of immersion greater than the immersion threshold, computer system 101 optionally initiates a process to replace the representation of the user's physical environment with respective virtual content, as described in further detail with reference to FIGS. 7A-7D.

In some embodiments, the request to re-display the virtual content optionally includes an input different from the movement back into the viewing region. For example, computer system 101 optionally detects an input that optionally includes a detection of attention of the user directed to virtual content 904 and/or virtual content 908A and optionally includes detection of an air pinching gesture of hand 903A, as described previously. In response to such an input, computer system 101 optionally initiates display of virtual content 916 at a level of immersion greater than an immersion threshold, optionally similar to or the same as described with reference to the input including rightward movement into the viewing region. In some embodiments, the input optionally is an actuation of a physical or virtual button. In some embodiments, the input optionally is an air gesture (e.g., a splaying of fingers of hand 903A) that is understood as a request to display the virtual content that was last displayed at a level of immersion greater than the immersion threshold. In some embodiments, the display of the virtual content at the level of immersion greater than the immersion threshold has already initiated before the user provides the input other than the movement back into the viewing region—referred to herein as a recentering input—and while the virtual content is displayed at the level of immersion greater than the immersion threshold, computer system 101 detects a recentering input. In response to the recentering input, computer system 101 optionally modifies display of virtual content 916 and/or modifies a world-locked position assigned to virtual content 904 in response to the recentering input as further described with reference to FIG. 9E. For example, as shown in FIG. 9D, user 901 is positioned in a left region of the viewing region corresponding to virtual content 904, when the recentering input is received, as described in further detail with reference to method 1000.

FIG. 9D1 illustrates similar and/or the same concepts as those shown in FIG. 9D (with many of the same reference numbers). It is understood that unless indicated below, elements shown in FIG. 9D1 that have the same reference numbers as elements shown in FIGS. 9A-9E have one or more or all of the same characteristics. FIG. 9D1 includes computer system 101, which includes (or is the same as) display generation component 120. In some embodiments, computer system 101 and display generation component 120 have one or more of the characteristics of computer system 101 shown in FIGS. 9A-9E and display generation component 120 shown in FIGS. 1 and 3, respectively, and in some embodiments, computer system 101 and display generation component 120 shown in FIGS. 9A-9E have one or more of the characteristics of computer system 101 and display generation component 120 shown in FIG. 9D1.

In FIG. 9D1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a. 314b, and 314c have one or more of the characteristics of image sensors 314 described with reference to FIGS. 9A-9E.

In FIG. 9D1, display generation component 120 is illustrated as displaying content that optionally corresponds to the content that is described as being displayed and/or visible via display generation component 120 with reference to FIGS. 9A-9E. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 9D1.

Display generation component 120 has a field of view (e.g., a field of view captured by external image sensors 314b and 314c and/or visible to the user via display generation component 120, indicated by dashed lines in the overhead view) that corresponds to the content shown in FIG. 9D1. Because display generation component 120 is optionally a head-mounted device, the field of view of display generation component 120 is optionally the same as or similar to the field of view of the user.

In FIG. 9D1, the user is depicted as performing an air pinch gesture (e.g., with hand 903A) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 9A-9E.

In some embodiments, computer system 101 responds to user inputs as described with reference to FIGS. 9A-9E.

In the example of FIG. 9D1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 9A-9E and/or described with reference to the corresponding method(s) are optionally implemented on computer system 101 and display generation unit 120 in a manner similar or analogous to that shown in FIG. 9D1.

FIG. 9E illustrates displaying of virtual content at a level of immersion greater than an immersion threshold in response to the recentering input in FIG. 9D or in response to further movement of user 901 towards the center of the viewing region corresponding to virtual content 904. In FIG. 9E, virtual content 916 fully consumes the user's field of view. For example, after the threshold amount of time after receiving the input to display the virtual content at the level of immersion greater than the immersion threshold, computer system 101 replaces a lower portion of the user's field of view that previously included a view of the user's physical environment with virtual content, described in further detail with reference to FIGS. 7A-7D. Such replacing optionally occurs in response to the input including movement of the user into the viewing region. Initiating display of virtual content at a level of immersion greater than the immersion threshold is described in further detail with reference to method 800.

Additionally or alternatively, computer system 101 optionally initiates the display of the virtual content at a level of immersion greater than the immersion threshold in response to the “recentering” input in FIG. 9D. For example, in FIG. 9E, in response to receiving the recentering input in FIG. 9D, computer system 101 modifies the world-locked position of virtual content 904 relative to a respective portion of the user's body, such as centering virtual content 904—and the corresponding viewing region—at the location between the user's feet. Further, in response to receiving the recentering input, computer system 101 optionally displays virtual content 916 at least partially at a level of immersion greater than the immersion threshold, due to the modification of the viewing region to the world-locked location centered on the user (e.g., the user's feet). Additionally or alternatively, virtual content 916 is modified in response to the recentering input. For example, virtual content 916 optionally shifts toward the left of the user's viewpoint because computer system 101 optionally has centered virtual content 916 on the user's current position (e.g., that was previously toward a left edge of virtual content 904 as shown in FIG. 9D).

FIGS. 10A-10G is a flowchart illustrating a method 1000 of reducing visual prominence of immersive virtual content and displaying an area of likely interaction in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, the method 1000 is performed at a computer system, such as computer system 101 as shown in FIG. 9A, in communication with one or more input devices and a display generation component, such as display generation component 120 as shown in FIG. 9A. For example, a computer system as described with respect to method 800, one more input devices described with respect to method 800, and/or a display generation component as described with respect to method 800.

In some embodiments, the computer system displays (1002a), via the display generation component, virtual content that has a world-locked location relative to a physical environment that is visible while the virtual content is displayed, such as virtual content 904 as shown in FIG. 9B, wherein the virtual content is displayed from a first viewpoint of a user of the computer system, such as a viewpoint of user 901 as shown in FIG. 9B, wherein the first viewpoint corresponds to a first physical location within a respective region in the physical environment that is associated with viewing the virtual content, such as a location corresponding to virtual content 904A as shown in FIG. 9B. In some embodiments, the three-dimensional environment includes one or more virtual objects (e.g., the first virtual object), such as application windows, operating system elements, representations of other users, and/or content items. In some embodiments, the three-dimensional environment includes representations of physical objects in the physical environment of the computer system. In some embodiments, the representations of physical objects are displayed in the three-dimensional environment via the display generation component (e.g., virtual or video passthrough). In some embodiments, the representations of physical objects are views of the physical objects in the physical environment of the computer system visible through a transparent portion of the display generation component (e.g., true or real passthrough). In some embodiments, the computer system displays the three-dimensional environment from the viewpoint of the user at a location in the three-dimensional environment corresponding to the physical location of the computer system, user and/or display generation component in the physical environment of the computer system. In some embodiments, the region of interaction has one or more of characteristics of the region of interaction described with respect to method 800. In some embodiments, the virtual content has one or more of the characteristics of the virtual content described with reference to method 800. In some embodiments, the three-dimensional environment has one or more of the characteristics of the three-dimensional environment described with reference to method 800. In some embodiments, the virtual content has a level of immersion greater than an immersion threshold, as described with reference to method 800.

In some embodiments, while displaying, via the display generation component, the virtual content, the computer system detects (1002b), via, the one or more input devices, movement of the user to a second physical location in the physical environment, different from the first physical location in the physical environment, such as movement as user 901 from as shown in FIG. 9A to as shown in FIG. 9B. For example, the computer system optionally detects a movement of the user from a first position relative to the three-dimensional environment corresponding to the first viewpoint to a second position relative to the three-dimensional environment corresponding to the second viewpoint and/or a change in orientation of the user relative to the three-dimensional environment. In some embodiments, the first input has one or more of the characteristics of the inputs described with reference to method 800.

In some embodiments, in response to detecting the movement of the user to the second physical location in the physical environment and in accordance with a determination that the second physical location is outside of the respective region in the physical environment that is associated with viewing the virtual content, such as shown by user 901 in FIG. 9A (1002c) (e.g., the computer system optionally determines that a location of the user is outside a boundary established by the region of interaction as described with respect to method 800), the computer system reduces (1002d) a visual prominence of at least a portion of the virtual content, such as virtual content 904 as shown in FIG. 9A. In some embodiments, reducing the visual prominence of the virtual content includes reducing an opacity, modifying the scale (e.g., reducing the amount of the three-dimensional environment occupied by the virtual content), modifying a visual effect such as a glowing effect, modifying a colorspace, and/or another visual modification of the virtual content. In some embodiments, the computer system initiates a ceasing of the displaying of the virtual content, such as a fading out of the virtual content, and/or a swiping animation gradually ceasing display of the virtual content (e.g., virtual portions of a XR environment).

In some embodiments, the computer system displays (1002e), via the display generation component, a visual indication of the respective region in the physical environment that is associated with viewing the virtual content (e.g., as described with respect to method 800), wherein the visual indication of the respective region in the physical environment that is associated with viewing the virtual content is displayed at a location (e.g., a world locked location) in the physical environment corresponding to the respective region, such as virtual content 904 as shown in FIG. 9B. For example, the visual indication optionally corresponds to a graphical and/or textual representation of the corresponding virtual content, such as an icon. In some embodiments, the visual indication corresponds to a boundary of a viewing region, thereby illustrating to the user a range of positions within the three-dimensional environment within which the virtual content will be visually prominent, and illustrating where movement is required optionally increase visual prominence of the virtual content. In some embodiments, the visual indication is centered, or nearly centered above the location corresponding to the region of interaction. In some embodiments, in response to detecting the first input and in accordance with a determination that the location of the second viewpoint is within the region of interaction associated with the three-dimensional environment, the computer system maintains the visual prominence of the virtual content and forgoes the display, via the display generation component, of the visual indication of the region of interaction. In some embodiments, the region of interaction is displayed while the second viewpoint of the user is within the region of interaction. In some embodiments, the visual indication has a world-locked position relative to a physical environment of the user. Reducing visual prominence of virtual content if a user viewpoint is outside a region of interaction communicates the possibility of interaction with the virtual content, thus reducing the likelihood non-functional inputs are directed to the virtual content and improving efficiency of interaction with the computer system, and also indicates to the user that the viewpoint of the user has moved away from the region of interaction, thus facilitating movement of the viewpoint of the user back to the region of interaction.

In some embodiments, in response to the detecting the movement of the user to the second physical location in the physical environment and in accordance with a determination that the second physical location is at least partially within the respective region in the physical environment that is associated with viewing the virtual content (1004a), the computer system forgoes (1004b) displaying, via the display generation component, the visual indication of the respective region in the physical environment that is associated with viewing the virtual content, such as forgoing the display of virtual content 904 as shown in FIG. 9B. For example, the computer system optionally detects that a respective portion of the user (e.g., a foot, a torso, a head, a determined center of gravity, a hand, and/or an arm) overlaps and/or is within the respective region of the physical environment. In some embodiments, the computer system is agnostic as to which respective portion of the user is within the respective region in the physical environment. For example, the computer system optionally determines that the user is within the respective region in the physical environment if a foot or if a hand enters the respective region, and in response to the determination, optionally forgoes performance of a same set of one or more operations as described further below regardless of whether the foot or the hand enters the respective region. In some embodiments, the computer system optionally forgoes display of the visual indication of the respective region in the physical environment. In some embodiments, in response to detecting a first respective portion of the user (e.g., a first foot) is within the virtual viewing zone, the computer system initiates display of the virtual viewing zone while a second respective portion of the user remains within the physical viewing area. Forgoing the display of the visual indication if the second position of the user is at least partially within the respective region in the physical environment maintains visual focus on respective virtual content, thereby reducing entry of erroneous inputs caused by the display of the visual indication.

In some embodiments, in response to the detecting the movement of the user to the second physical location in the physical environment and in accordance with a determination that the second physical location is at least partially within the respective region in the physical environment that is associated with viewing the virtual content (1006a) (e.g., as described in step(s) 1004), the computer system forgoes (1006b) reducing the visual prominence of the at least the portion of the virtual content, such as forgoing the reducing in visual prominence of virtual content 916 as shown in FIG. 9A. For example, the computer system optionally forgoes reducing the visual prominence by maintaining respective visual prominence of the at least the portion of the virtual content (e.g., forgoing the reducing of visual prominence described in step(s) 1002). Forgoing the reducing of the visual prominence if the second position of the user is at least partially within the respective region in the physical environment maintains visual focus on and maintains visibility of respective virtual content, thereby reducing entry of erroneous inputs caused by the reducing of the visual prominence.

In some embodiments, the location in the physical environment corresponding to the respective region at which the visual indication is displayed is a first respective world-locked location (e.g., as described in method 800) relative to the physical environment (1008a), such as a location of virtual content 904 as shown in FIG. 9B. For example, while displaying the visual indication at the first respective world-locked location, the computer system optionally detects movement of the user to a third location (e.g., different from the second and/or first location) and optionally maintains display of the visual indication at the first respective world-locked location (e.g., display of the visual indication is modified to reflect an updated field of view and spatial relationship of the user relative to the first respective world-locked location).

In some embodiments, while displaying, via the display generation component, the visual indication at the first respective world-locked location relative to the physical environment, the computer system detects (1008b), via the one or more input devices, an input corresponding to a request to move the visual indication to a second respective world-locked location relative to the physical environment, different from the first respective world-locked location, such as an input from hand 903A as shown in FIGS. 9D and 9D1. For example, the computer system optionally detects an air pinch gesture (e.g., a convergence of an index finger and a thumb of the user) performed with a first portion of the user (e.g., a hand, arm, or finger), while attention of the user is directed to a respective portion of the visual indication. The input optionally corresponds to a selection (e.g., a tap or button click) and movement performed by a pointing device (e.g., a mouse, a stylus, and/or a glove, optionally while maintaining the selection such as maintain contact with surface such as a touch-sensitive surface), or another air gesture (e.g., a squeezing of a hand of the user while attention is directed to the selectable option and scaling of the visual indication in accordance with movement of the hand until a similar squeezing of the hand is detected). In some embodiments, the selection and/or movement has one or more characteristics of the first input described in method 800.

In some embodiments, in response to detecting, via the one or more input devices, the input corresponding to the request to move the visual indication of the respective region in the physical environment that is associated with viewing the virtual content (1008c), the computer system displays (1008d), via, the display generation component, the visual indication of the respective region in the physical environment that is associated with viewing the virtual content at the second respective world-locked location, such as displaying the updated location of virtual content 904 as shown in FIG. 9E in response to input shown in FIGS. 9D and 9D1. For example, the computer system optionally detects movement of the first portion of the user while optionally maintaining the air pinch gesture (e.g., contact between the index finger and the thumb), while maintaining a selection (e.g., a maintaining of a mouse click, and/or after the squeezing hand air gesture was received) and optionally moves the visual indication to the second respective world-locked location in accordance with the movement. In some embodiments, the request to move the visual indication to a second respective world-locked location is a default world-locked location, such as a location based on characteristics of the user's physical environment (e.g., a center of the physical environment, or an open space detected within the physical environment), a location determined relative to the first respective world-locked location, and/or a location of a respective portion of the user (e.g., the user's feet, or a piece of furniture that the user is sitting or standing on or near). Moving the visual indication between respective world-locked locations enables the user to reduce visual conflicts between the visual indication and other physical and/or virtual content.

In some embodiments, while displaying, via the display generation component, the visual indication at the location in the physical environment corresponding to the respective region, such as virtual content 904 as shown in FIG. 9C, and while the user is at the second physical location in the physical environment, wherein the second physical location is outside of the respective region in the physical environment that is associated with viewing the virtual content, such as a location of user 901 as shown in FIG. 9C, the computer system detects (1010a), via the one or more input devices, second movement of the user to a third physical location in the physical environment, different from the second physical location, such as corresponding to virtual content 904 as shown in FIGS. 9D and 9D1 (e.g., similar to as described with respect to the movement of the user to the second physical location described in step(s) 1002 and the reduction of visual prominence of virtual content in step(s) 1004).

In some embodiments, in response to detecting the second movement of the user to the third physical location in the physical environment, in accordance with a determination that the third physical location is at least partially within the respective region in the physical environment that is associated with viewing the virtual content, the computer system increases (1010b) the visual prominence of the at least the portion of the virtual content, such as the increasing of visual prominence of virtual content 916 as shown in FIGS. 9D and 9D1 (e.g., relative to a representation of the physical location). For example, the computer system optionally detects that the respective portion is at least partially within the visual indication as described in step(s) 1004, but optionally with respect to the second movement of the user (e.g., corresponding to movement into the respective region from a location outside the respective region). In some embodiments, the computer system increases the visual prominence of the at least the portion of the virtual content to a level of visual prominence similar to or the same as the visual prominence displayed while the user was at the first physical location in the physical environment within the physical viewing area. In some embodiments, while displaying the visual indication, in response to the second movement of the user to the third location in the physical environment that is at least partially within the physical viewing area, the computer system ceases display of the visual indication described in step(s) 1002. In some embodiments, the increasing of the visual prominence occurs in response to an input other than movement of the user. For example, the computer optionally detects an input (e.g., an air gesture, such as an air pinch gesture, while attention of the user is directed to virtual content, a selection via a cursor device, and/or an input to re-display recently displayed virtual content) while the user of the computer system is outside the respective region. In response to the input other than the movement of the user, the computer system optionally performs one or more operations described with respect to the second of the movement of the user to the third physical location that is at least partially within the respective region. In some embodiments, while displaying the visual indication, in response to the input other than the movement of the user, display of the virtual viewing zone is ceased. Increasing the visual prominence of the at least the portion of the virtual content in response to the second movement of the user if the user moves at least partially into the respective region in the physical environment associated with viewing the virtual content reduces the need for inputs to manually increase the visual prominence and reduces the likelihood that such manual inputs are erroneously received.

In some embodiments, the visual indication of the respective region in the physical environment that is associated with viewing the virtual content includes information associated with the virtual content, such as information associated with virtual content 908A as shown in FIG. 9C (1012). For example, the visual indication optionally includes visual information such as text, color, graphical icons, shape(s), visual effects, and/or animations associated with the virtual content. In some embodiments, the visual information corresponds to respective content included in the virtual content. In some embodiments, the visual information corresponds to metadata about the virtual content, such as a recency of access of the virtual content, characteristics of the virtual content (e.g., if the virtual content is an immersive visual experience or partially immersive visual experience), and/or relationships to respective applications associated with respective computer system(s) (e.g., an operating system of the computer system or another computer system in communication with the computer system). In some embodiments, the virtual content is a simulation of a physical space as described in methods 1000 and/or 1200, where the information associated with the virtual content includes displaying of one or more portions of the simulated physical space, one or more colors included in the one or more portions of the simulated physical space, and/or media that is displayed within the simulated physical space. Displaying the visual indication with information associated with the virtual content reduces the need for input to manually obtain such information.

In some embodiments, the information includes an indication of an application associated with the virtual content, such as an application associated with virtual content 908A as shown in FIG. 9C (1014). For example, the information described in step(s) 1012 optionally includes a graphical or textual representation (e.g., an icon) of an application that provides and/or creates the virtual content. For example, graphical/textual representation optionally is a name of the application, an icon representing the application, respective content included in the virtual content, and or one or more selectable options that are respectively selectable to perform one or more operations associated with the application (e.g., call a friend, open a recently used document, share the application with another computer system, and/or interact with respective content included in the virtual content optionally without display the virtual content in its entirety). In some embodiments, the computer system displays information based on an association with the virtual content and/or the virtual object. For example, in accordance with a determination that the virtual content is associated with a first application associated with the computer system, the computer system displays first information that is associated with the first application and/or the virtual content. In accordance with a determination that the virtual content is associated with a second application, different from the first application, that is associated with the computer system, the computer system displays second information, different from the first information, that is associated with the second application and/or the virtual content. For example, the computer system optionally displays the name of a browser application or a messaging application based on a determination that the visual indication is associated with the browser application or the messaging application. Displaying an indication of the application associated with the virtual content reduces the need for input to manually obtain such information and prevents user input erroneously associated with the virtual content such as an unintended request to view the virtual content.

In some embodiments, the indication of the application includes a visual representation of the application displayed at a respective location above a floor of the physical environment and corresponding to the location in the physical environment corresponding to the respective region in the physical environment that is associated with viewing the virtual content, such as a representation of an application associated with virtual content 908A as shown in FIG. 9C (1016). For example, as described in step(s) 1002 and in step(s) 1012, the visual indication optionally includes a graphical icon representing the application (e.g., a web browsing icon, a branded logo, and/or a representation of a user of a similar or the same application that is in communication with the computer system and/or the application). In some embodiments, the visual indication is displayed at a height (e.g., 0.01, 0.05, 0.1, 0.5, 1, 5, 10, 50, or 100 m) above a respective region (e.g., the floor) of a representation of the physical environment. In some embodiments, the graphical icon is positioned relative to a respective position (e.g., corner, center, and/or edge) of the visual indication. Displaying a visual representation of the application above the floor of the physical environment provides a preview of the virtual content and application without manual input otherwise required to determine the application and indicates where the user should move toward to interact with and/or display the virtual content and/or application.

In some embodiments, the information includes a visual representation having a respective shape displayed at respective region (e.g., floor) of the physical environment corresponding to the location in the physical environment corresponding to the respective region, such as a shape of virtual content 904 as shown in FIG. 9C (1018). For example, the visual representation has a geometric shape as described in step(s) 1002, or another shape (e.g., a cloud shape, an asymmetric shape, and/or another three-dimensional shape). In some embodiments, the visual representation is overlaid over the respective region or is displayed at a height (e.g., 0.01, 0.05, 0.1, 0.5, 1, 5, 10, 50, or 100 m) above the respective region. Displaying the visual representation with a respective shape at the respective region of the physical environment draws the user's visual attention toward the respective region, thereby facilitating visually locating the visual indication and indicates where the user should move to display additional virtual content.

In some embodiments, the respective shape is displayed with a visual characteristic having a respective value based on an application associated with the virtual content, such as a characteristic of virtual content 908A as shown in FIG. 9C (1020). For example, the visual characteristic optionally includes a color, saturation, brightness, visual effect, translucency, border, and/or size with a respective value based on the application associated with the virtual content. For example, visual characteristic optionally corresponds to virtual content included within the application, a color of a visual representation (e.g., icon) associated with the application, and/or a recency of use of the application. For example, the respective shape optionally is displayed with a first color (e.g., green) if the user has recently interacted with the application (e.g., launched the application supplying the virtual content within the last 1, 3, 5, 10, 30, 60, 120 or 360 minutes) or optionally is displayed with a second, different color (e.g., red) if the user has not recently interacted with the application. In some embodiments, in accordance with a determination that the application is a first application, the computer system displays the respective shape with a visual characteristic having a first value (e.g., a first color) based on one or more characteristics associated with the application (e.g., content provided by the application), and in accordance with a determination that the application is a second application, different from the first application, the computer system displays the respective shape with the visual characteristic having a second value (e.g., a second color), different from the first value. Displaying a visual characteristic of the respective shape with a respective value based on the application associated with the virtual content communicates a relationship between the visual content and the application, thus reducing the need for user input to uncover the relationship.

In some embodiments, the respective value is based on respective content associated with the application, such as content associated with virtual content 904 as shown in FIG. 9C (1022). For example, the respective value optionally corresponds to a respective content (e.g., recently received messages, one or more colors of an immersive visual experience (e.g., a simulated physical space and/or a virtual environment), and/or the presence or absence of notifications from the application) associated with the application. In some embodiments, in accordance with a determination that the respective content of an application corresponds to first virtual content, the computer system assigns a first value (e.g., a first color) to the respective value based on one or more characteristics associated with the virtual content (e.g., one or more colors included in the virtual content provided by the application), and in accordance with a determination that the respective content of the application corresponds to second virtual content, different from the first virtual content, the computer system assigns a second value (e.g., a second color), different from the first value, to the respective value. Setting the respective value based on virtual content associated with the application provides a visual preview of what the virtual content is related to without requiring manual input to display the virtual content.

In some embodiments, the respective value is based on a color included in a visual representation of the application, such as a color of virtual content 908A as shown in FIG. 9C (1024). For example, the respective value optionally is determined based on a predominant one or more colors of the visual representation (e.g., an application icon) of the application. The application optionally is a web browsing application, for example, optionally having a predominantly blue application option and the computer system optionally displays the visual representation having the respective shape with a blue color. In some embodiments, one or more colors included in the visual representation are reflected in the display of the visual representation (e.g., included in the visual representation). In some embodiments, in accordance with a determination that a visual representation of the application includes a first color, the computer system assigns a first value (e.g., a first color) to the respective value, and in accordance with a determination that the visual representation of the application includes a second color, different from the first color, the computer system assigns a second value (e.g., a second color) to the respective value, different from the first value. Setting the respective value based on the visual indication associated with the application provides a visual preview of what the respective content is related to without requiring manual input to display the respective content.

In some embodiments, the information includes a simulated lighting effect displayed at respective region (e.g., floor) of the physical environment corresponding to the location in the physical environment corresponding to the respective region, such as a simulated light included in virtual content 904 as shown in FIG. 9C (1026). For example, the simulated lighting effect includes one or more simulated light sources that are optionally not visible in the three-dimensional environment that are oriented toward the respective region of the physical environment. In some embodiments, the simulated light sources are pointed normal to the respective region (e.g., the floor) of the physical environment, and thus shine simulated light over the surface of the respective region (and optionally not shining simulated light over other regions of the physical environment outside of the respective region). In some embodiments, if the visual indication includes a visual representation of the application displayed at a height above the respective region, the simulated lighting effect includes a virtual shadow cast by the visual representation of the application. In some embodiments, the one or more simulated light sources incident upon the visual representation of the application causes a virtual specular highlighting lighting effect to be displayed on a surface of the visual representation. In some embodiments, the specular highlight is modified in response to a shift in the user's viewpoint and the position of the simulated light sources. In some embodiments, a visual appearance of the simulated lighting effect is based on one or more characteristics of the user's physical environment (e.g., within the respective region). For example, in accordance with a determination that one or more characteristics of the respective region of the physical environment have one or more values, the computer system optionally displays the lighting effect with a first visual appearance, and in accordance with a determination that the one or more characteristics of the respective region of the physical environment have one or more second values, different from the one or more first values, the computer system optionally displays the lighting effect with a second visual appearance, different from the first visual appearance. For example, the computer system optionally modifies an appearance of the simulated lighting effect based on the contours of the floor within the respective region of the physical environment (e.g., the floor). If the physical region of the floor is relatively flat, for example, the simulated lighting effect optionally is a virtual shadow that optionally is displayed with a dark center that decreases in brightness uniformly away from the center of the virtual shadow. If the physical region of the floor is slanted, for example, the virtual shadow optionally is displayed with a first portion corresponding to a higher-elevated portion of the floor with at a first brightness, and a second portion corresponding to a lower-elevated portion of the floor with a second brightness that lower (e.g., more dim) than the first brightness. In some embodiments, the respective visual appearances are displayed in a same physical environment (e.g., a same room) that has differing physical characteristics (e.g., the flat and/or the slanted floor). In some embodiments, the respective visual appearances are displayed in different physical environments (e.g., different rooms). Displaying a simulated lighting effect at the respective region of the floor attracts the user's visual attention and illuminates potential physical objects that potentially present spatial conflicts with the user.

In some embodiments, while the user is at the second physical location wherein the second physical location is outside of the respective region in the physical environment that is associated with viewing the virtual content, such as shown by the position of user 901 as shown in FIG. 9C, and while displaying, via the display generation component, the visual indication at the location in the physical environment corresponding to the respective region, such as virtual content 904 as shown in FIG. 9C, the computer system detects (1028a), via the one or more input devices, an input corresponding to a request to recenter respective virtual content based on a current viewpoint of the user, such as an input from hand 903A as shown in FIGS. 9D and 9D1. In some embodiments, the input includes a request to recenter virtual content (e.g., one or more virtual objects) in the three-dimensional environment (e.g., an input corresponding to a request to update the spatial arrangement of the objects relative to the viewpoint of the user to satisfy the one or more criteria that specify a range of distances or a range of orientations of the one or more virtual objects relative to the viewpoint of the user). In some embodiments, the input is directed to a hardware button, or switch in communication with (e.g., incorporated with) the computer system. In some embodiments, the input is an input directed to a selectable option displayed via the display generation component. In some embodiments, the one or more criteria include criteria satisfied when an interactive portion of the virtual content is oriented towards the viewpoint of the user, virtual objects do not obstruct the view of other virtual objects from the viewpoint of the user, the virtual objects are within a threshold distance (e.g., 10, 20, 30, 40, 50, 100, 200, 300, 400, 500, 1000 or 2000 centimeters) of the viewpoint of the user, and/or the virtual objects are within a threshold distance (e.g., 1, 5, 10, 20, 30, 40, 50, 100, 200, 300, 400, 500, 1000 or 2000 centimeters) of each other. In some embodiments, the input is different from an input requesting to update the positions of one or more objects in the three-dimensional environment (e.g., relative to the viewpoint of the user), such as inputs for manually moving the objects in the three-dimensional environment.

In some embodiments, in response to detecting, via the one or more inputs devices, the input corresponding to the request to recenter respective virtual content based on the current viewpoint of the user, the computer system increases (1028b) the visual prominence of the at least the portion of the virtual content, such as shown by the movement of virtual content 904A from as shown in FIGS. 9D and 9D1 to as shown in FIG. 9E (e.g., without the user moving in the physical environment). For example, in addition to the operations and arrangements described above, the visual prominence optionally is increased as described in step(s) 1010. In some embodiments, respective portions of the virtual content are shifted towards the current viewpoint of the user. In some embodiments, the input corresponding to the request to center respective virtual content does not include movement of the user in the physical environment and/or to a modified viewpoint. For example, a virtual pillar that is central when the virtual content is initially loaded, but not visible and/or not centered on the user's viewpoint while the user is at the second physical location is optionally displayed centered at the user's current viewpoint (e.g., second physical location) in response to the recentering input (e.g., without modification of the user's location in the physical environment and/or viewpoint). In some embodiments, in response to detecting the input requesting recentering, the computer system displays the visual indication centered based on the user's current viewpoint (e.g., centered at the user's feet). Increasing the visual prominence of the at least the portion of the virtual content in response to an input corresponding to a request to recenter respective virtual reduces the need for alternative inputs such as movement to recenter the respective virtual content.

In some embodiments, in response to detecting, via the one or more inputs devices, the input corresponding to the request to recenter respective virtual content based on the current viewpoint of the user, such as an input from hand 903A as shown in FIGS. 9D and 9D1, the computer system displays (1030), via the display generation component, a second visual indication corresponding to the respective region of the physical environment with which the user of the computer system is likely to interact, different from visual indication, such as virtual content 904A as shown in FIG. 9C, wherein the displaying includes displaying an animation of the second visual indication appearing at a location corresponding to the second physical location of the user, such as displaying virtual content 904A as shown in FIG. 9C with an animation. In some embodiments, the second visual indication has one or more of the characteristics of the visual indication described in method 800. In some embodiments, in response to detecting the input while the visual indication is visible, the computer system ceases display of the visual indication (as described in step(s) 1002) and initiates display of the second visual indication. For example, the second visual indication optionally includes a gradual fading in (e.g., a ramping down translucency until the second visual indication is visible). In some embodiments, the animation includes moving the visual indication to the location corresponding to (e.g., centered on) the second physical location of the user from the prior location of the visual indication. In some embodiments, the animation includes a visual effect blossoming or emanating from the second physical location outwards. For example, the second visual indication is optionally initially displayed with a first visual appearance (e.g., translucency, size, and/or brightness) and animated to spread outward until the second visual indication has a second appearance (e.g., a second level of translucency, size, and/or brightness). Animating the display of the second visual indication draws the user's attention to the second visual indication, thus suggesting to the user a region of likely interaction and reducing the likelihood the user provides inputs while outside of the region of likely interaction.

In some embodiments, reducing the visual prominence of the at least the portion of the virtual content includes (1032a), in accordance with a determination that the movement of the user to the second physical location is in a first direction relative to the physical environment, such as a direction of user 901 moving as shown in FIG. 9A, initiating the reducing the visual prominence of the at least the portion of the virtual content from the first direction (1032b), and in accordance with a determination that the movement of the user to the second physical location is in a second direction relative to the physical environment, different from the first direction, initiating the reducing the visual prominence of the at least the portion of the virtual content from the second direction, such as shown by the direction of reducing of visual prominence of virtual content 916 as shown in FIG. 9A (1032c). For example, while displaying the virtual content (e.g., an immersive visual experience) the computer system optionally detects movement to the left of the user's current location and initiates a reduction of visual prominence (e.g., a blurring, fading, and/or a modification of translucency) in the leftward direction (e.g., the leftmost portion of the immersive visual experience is displayed with a first level of translucency while the remaining portions of the immersive visual experience are displayed with a second, relatively lesser degree of translucency). In some embodiments, the reducing of the visual prominence from the first direction includes displaying a respective portion of the virtual content (e.g., the leftmost portion) with a gradient of a visual effect. For example, a leftmost, first portion of the virtual content optionally is displayed with a first level of translucency while an adjacent, second portion of the virtual content optionally is displayed with a second, relatively lesser level of translucency, and the remaining portions of the virtual content optionally maintain respective levels of translucency. In some embodiments, the amount of the at least the portion of the virtual content reduced in visual prominence is determined in accordance with the user's position during the movement of the user to the second physical location. For example, while the user remains at a first respective position along the path of the movement toward the second position, the portion of the virtual content reduced in visual prominence optionally is a first amount (e.g., 1%, 5%, 10%, 15%, 20%, 25%, 30%, 40%, 50%, or 75%), and in response to the user moving toward a second respective position along the path closer to the second position, the portion is increased to a second, optionally different amount (e.g., %, 10%, 15%, 20%, 25%, 30%, 40%, 50%, 75%, or 90%). Thus, in response to the movement in a respective direction, in accordance with a determination that the movement meets one or more criteria including a criterion that is satisfied when the user moves in a respective direction, the computer system optionally initiates reducing the visual prominence of the at least the portion of the virtual content initiating from the first direction. Initiating the reducing of the visual prominence from a particular direction based on the movement of the user bolsters user intuition as to how their movement optionally increases (or decreases) display of the virtual content and allows the user to view portions of the physical environment while maintaining display of the virtual content.

In some embodiments, the displaying, via the display generation component, of the visual indication of the respective region in the physical environment that is associated with viewing the virtual content includes displaying the visual indication with a first size relative to the physical environment, such as the size of virtual content 904 as shown in FIG. 9B (1034a) (e.g., 0.01, 0.05, 0.1, 0.5, 1, 5, 10, 50, or 100 m²). In some embodiments, while displaying the visual indication of the respective region in the physical environment that is associated with viewing the virtual content and while a location of the user of the computer system is the second location in the physical environment that is outside the respective region in the physical environment (1034b) (e.g., as described in step(s) 1002), in accordance with a determination that one or more criteria are satisfied including a criterion that is satisfied when the location of the user of the computer system has remained outside of the respective region in the physical environment for a threshold amount of time, such as time 918 as shown in FIG. 9B, (e.g., 0.01, 0.1, 0.25, 0.5, 1, 2.5, 5, or 10 seconds), the computer system changes (1034c) a size of the visual indication from the first size to a second size relative to the physical environment (e.g., 0.01, 0.05, 0.1, 0.5, 1, 5, 10, 50, or 100 m²), wherein the second size is less than the first size, such as the size of virtual content 904 as shown in FIG. 9C. For example, the computer system optionally shrinks the visual indication from the first size to the second size after the user has remained outside (e.g., not overlapping and within) the respective region for the threshold amount of time. In some embodiments, the threshold amount of time is measured relative to the instant that the computer system determines the user has moved to the second location in the physical environment that is outside the respective region. In some embodiments, the threshold amount of time is measured relative to the instant that the computer system determines that the user ceases interaction with respective virtual content (e.g., the attention of the user is no longer directed to the virtual content and/or the user is not directing input toward the virtual content such as one or more air gestures). In some embodiments, the changing of the size of the visual indication includes displaying an animation (e.g., gradually shrinking and/or fading) from the first size to the second size. In some embodiments, until the one or more criteria are satisfied, the computer system maintains display of the visual indication at the first size relative to the physical environment. In some embodiments, in accordance with a determination that the one or more criteria are not satisfied including the criterion that is satisfied when the location of the user of the computer system has remained outside of the respective region for the threshold amount of time, the computer system forgoes changing the size of the visual indication from the first size to the second size relative to the physical environment. Changing the size of the visual indication modifies amount of space the visual indication consumes, thereby reducing the likelihood the user unintentionally moves into the visual indication, reduces visual clutter, and enhances visual focus on the physical environment and/or other respective virtual content.

It should be understood that the particular order in which the operations in method 1000 have been described is merely exemplary and is not intended to indicate that the described order is the only order in which the operations could be performed. One of ordinary skill in the art would recognize various ways to reorder the operations described herein.

FIGS. 11A-11E illustrate examples of a computer system generating alerts associated with physical objects in an environment of a user in accordance with some embodiments.

FIG. 11A illustrates a computer system 101 displaying, via a display generation component (e.g., display generation component 120 of FIG. 1), a three-dimensional environment 1102 from a viewpoint of the user 1126 illustrated in the overhead view (e.g., facing the back wall of the physical environment in which computer system 101 is located). As described above with reference to FIGS. 1-6, the computer system 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user).

As shown in FIG. 11A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 1102 or portions of the physical environment are visible via the display generation component 120 of computer system 101. For example, three-dimensional environment 1102 includes portions of the left and right walls, the ceiling, and the floor in the physical environment of user 1126.

In FIG. 11A, three-dimensional environment 1102 also includes virtual content, such as virtual content 1104. Virtual content 1104 is optionally one or more of a user interface of an application (e.g., messaging user interface, or content browsing user interface), a three-dimensional object (e.g., virtual clock, virtual ball, or virtual car), a virtual environment (e.g., as described with reference to method 1200) or any other element displayed by computer system 101 that is not included in the physical environment of computer system 101.

In FIG. 11A, the physical environment of user 1126 also includes physical objects 1106 and 1108, which are tables. In FIG. 11A, virtual content 1104 is obscuring visibility of physical objects 1106 and 1108 via display generation component 120, because virtual content 1104 is at least partially opaque and is positioned between objects 1106 and 1108, and the viewpoint of user 1126. Additional or alternative details of how virtual content 1104 obscures visibility of portions of the physical environment are provided with reference to method 1200. In FIG. 11A, computer system 101 is also reducing the visual prominence of portions of the environment that are visible outside of virtual content 1104 (e.g., portions of the left and right walls, the ceiling, and the floor in the physical environment of user 1126), as described in more detail with reference to method 1200.

In some embodiments, computer system 101 generates an alert when a physical object whose visibility is at least partially obscured by virtual content 1104 is in conflict with a potential range of motion of user 1126, thereby warning user 1126 of the existence of the physical object and permitting user 1126 to take actions to reduce or avoid the conflict. For example, from FIG. 11A to 11B, computer system 101 detects user 1126 moving or having moved towards objects 1106 and/or 1108 in the physical environment. In FIG. 11B, objects 1106 and 1108 would both otherwise be obscured by virtual content 1104, and are both in conflict with a potential range of motion of user 1126 (e.g., as described in more detail with reference to method 1200). Therefore, in response, computer system 101 generates alerts that indicate that locations of objects 1106 and 1108. It should be understood that while concurrent conflict with the potential range of motion of user 1126, and thus concurrent generation of alerts, is described with reference to FIGS. 11A-11E, in the case of fewer or more conflicts with the potential range of motion of user 1126, computer system would optionally respond analogously with fewer or more of the alerts and/or other operations that are described with reference to FIGS. 11B-11E.

For example, computer system 101 in FIG. 11B has generated an alert that indicates the location of object 1106. In particular, computer system 101 optionally displays visual flashes 1107 and/or other visual elements that emanate from the portion of virtual content 1104 that corresponds to (e.g., obscures) object 1106 relative to the user 1126, such as the left side of virtual content 1104 as shown in FIG. 11B. Computer system 101 optionally additionally or alternatively reduces the visual prominence of a portion of virtual content 1104 that is obscuring object 1106 relative to the user 1126 (e.g., by reducing the opacity of that portion of virtual content 1104 such that object 1106 becomes at least partially visible through that portion of virtual content 1104), such as the left side of virtual content 1104 as shown in FIG. 11B. Computer system 101 optionally additionally or alternatively generates an audio alert (e.g., represented by indication 1107a in the top-down view of the environment) that has directional properties that cause the audio alert to be presented from (or be presented as if coming from) the location of object 1106 relative to the user 1126. Computer system 101 optionally additionally or alternatively at least partially reverses the reduction of visual prominence applied to portions of the environment 1102 that are visible outside of virtual content 1104. Computer system 101 in FIG. 11B has also generated analogous alert(s) with respect to object 1108. In some embodiments, the magnitudes of the alerts for objects 1106 and 1108 differ based on the relative magnitudes of the conflicts of objects 1106 and 1108 with the potential range of motion of user 1126 (e.g., the alert for the object with the greater conflict optionally has a greater magnitude than the alert for the object with the smaller conflict), as described in more detail with reference to method 1200. Additional details relating to the generated alerts and/or operations of computer system 101 are provided with reference to method 1200.

In some embodiments, computer system 101 adjusts the alert for a given object in response to detecting behavior of user 1126 that indicates attention of user 1126 towards the alert and/or reduces the conflict of the object with the potential range of motion of user 1126. For example, in FIG. 11C, computer system 101 detects attention 1150 of the user directed to the alert for object 1106. In response, computer system 101 has decreased the magnitude of one or more of the components of the alert for object 1106. For example, computer system 101 in FIG. 11C has decreased the amount that object 1106 is visible through virtual content 1104, by reducing the size of the portion of virtual content 1104 through which object 1106 is visible and/or by reducing the translucency of the portion of virtual content 1104 through which object 1106 is visible. Computer system 101 optionally additionally or alternatively reduces the visual prominence of the flashes 1107 or other virtual indications that were displayed by computer system 101. Computer system 101 optionally additionally or alternatively reduces the aural prominence of the audio alert that was displayed by computer system 101. In FIG. 11C, behavior of user 1126 does not indicate attention of user 1126 towards the alert for object 1108 and/or does not reduce the conflict of object 1108 with the potential range of motion of user 1126 therefore, computer system 101 has not reduced the prominences of the one or more components of the alert generated by computer system 101 for object 1108.

FIG. 11C1 illustrates similar and/or the same concepts as those shown in FIG. 11C (with many of the same reference numbers). It is understood that unless indicated below, elements shown in FIG. 11C1 that have the same reference numbers as elements shown in FIGS. 11A-11E have one or more or all of the same characteristics. FIG. 11C1 includes computer system 101, which includes (or is the same as) display generation component 120. In some embodiments, computer system 101 and display generation component 120 have one or more of the characteristics of computer system 101 shown in FIGS. 11A-11E and display generation component 120 shown in FIGS. 1 and 3, respectively, and in some embodiments, computer system 101 and display generation component 120 shown in FIGS. 11A-11E have one or more of the characteristics of computer system 101 and display generation component 120 shown in FIG. 11C1.

In FIG. 11C1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 11A-11E.

In FIG. 11C1, display generation component 120 is illustrated as displaying content that optionally corresponds to the content that is described as being displayed and/or visible via display generation component 120 with reference to FIGS. 11A-11E. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 11C1.

Display generation component 120 has a field of view (e.g., a field of view captured by external image sensors 314b and 314c and/or visible to the user via display generation component 120, indicated by dashed lines in the overhead view) that corresponds to the content shown in FIG. 11C1. Because display generation component 120 is optionally a head-mounted device, the field of view of display generation component 120 is optionally the same as or similar to the field of view of the user.

In FIG. 11C1, the user can perform an air pinch gesture to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 11A-11E.

In some embodiments, computer system 101 responds to user inputs as described with reference to FIGS. 11A-11E. It is understood than one or more or all aspects of the present disclosure as shown in, or described with reference to FIGS. 11A-11E and/or described with reference to the corresponding method(s) are optionally implemented on computer system 101 and display generation unit 120 in a manner similar or analogous to that shown in FIG. 11C1.

In some embodiments, user behavior that does not indicate attention towards an alert causes computer system 101 to increase the prominence of that alert. For example, in FIG. 11D, user attention 1150 is not directed to the alert for object 1108. In some embodiments, user attention 1150 is directed to the alert for object 1106—in which case, computer system 101 optionally responds as described with reference to FIG. 11C—but in some embodiments user attention 1150 is not detected or is simply not directed to the alert for object 1108. In response, computer system 101 has increased the magnitude of one or more of the components of the alert for object 1108. For example, computer system 101 in FIG. 11D has increased the amount that object 1108 is visible through virtual content 1104, by increasing the size of the portion of virtual content 1104 through which object 1108 is visible and/or by reducing the translucency of the portion of virtual content 1104 through which object 1108 is visible. Computer system 101 optionally additionally or alternatively increases the visual prominence of the flashes 1109 or other virtual indications that were displayed by computer system 101. Computer system 101 optionally additionally or alternatively increases the aural prominence of the audio alert that was displayed by computer system 101.

As mentioned previously, in some embodiments, additionally or alternatively to user attention, behavior of user 1126 that reduces the conflict of the object with the potential range of motion of user 1126 causes computer system 101 to reduce the magnitude of the alert for that object (e.g., in one or more of the ways described with reference to FIG. 11C), whereas behavior of user 1126 that increases the conflict of the object with the potential range of motion of user 1126 causes computer system 101 to increase the magnitude of the alert for that object (e.g., in one or more of the ways described with reference to FIG. 11D). For example, in FIG. 11E, user 1126 has moved further away from object 1106, optionally following the scenarios in FIG. 11B, 11C and/or 11D. In response, because the behavior of user 1126 has reduced the conflict of object 1106 with the potential range of motion of 1126, computer system 101 has reduced (and/or further reduced) the prominence of the alert for object 1106 (e.g., in one or more of the ways described with reference to FIG. 11C)—and optionally ceases generation of the alert for object 1106, such as shown in FIG. 11E.

In contrast, in FIG. 11E, user 1126 has moved closer to object 1108, optionally following the scenarios in FIG. 11B, 11C and/or 11D. In response, because the behavior of user 1126 has increased the conflict of object 1108 with the potential range of motion of 1126, computer system 101 has increased (and/or further increased) the prominence of the alert for object 1108 (e.g., in one or more of the ways described with reference to FIG. 11D). For example, in FIG. 11E, object 1108 is optionally fully visible through virtual content 1104, because computer system 101 has (further) increased the amount that object 1108 is visible through virtual content 1104, by increasing the size of the portion of virtual content 1104 through which object 1108 is visible and/or by reducing the translucency of the portion of virtual content 1104 through which object 1108 is visible, optionally all the way to being 100% transparent.

FIGS. 12A-12D is a flowchart illustrating a method 1200 of generating alerts associated with physical objects in an environment of a user in accordance with some embodiments. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, 1200 is performed at a computer system in communication with one or more input devices and one or more output generation components including a display generation component. In some embodiments, the computer system has one or more of the characteristics of the computer system of methods 800, 1000 and/or 1400. In some embodiments, the display generation component has one or more of the characteristics of the display generation component of methods 800, 1000 and/or 1400. In some embodiments, the one or more input devices have one or more of the characteristics of the one or more input devices of methods 800, 1000 and/or 1400.

In some embodiments, while displaying, via the display generation component, first virtual content, such as content 1104 in FIG. 11B (e.g., in a three-dimensional environment. In some embodiments, the three-dimensional environment is generated, displayed, or otherwise caused to be viewable by the computer system (e.g., an extended reality (XR) environment such as a virtual reality (VR) environment, a mixed reality (MR) environment, or an augmented reality (AR) environment.). In some embodiments, the three-dimensional environment has one or more of the characteristics of the three-dimensional environments of methods 800, 1000 and/or 1400. In some embodiments, the first virtual content is a user interface of an application on the computer system, such as a content (e.g., movie, television show and/or music) playback application, and the user interface is displaying or otherwise presenting the content; in some embodiments, the first virtual content is a two-dimensional or three-dimensional model of an object such as a tent, a building, or a car; in some embodiments, the first virtual content is a virtual environment, such as an environment that is representative of a corresponding physical environment/location such as a mountain location, a beach location, or a park location. In some embodiments, the virtual environment is interactive such that a user of the computer system can explore the virtual environment by providing inputs via the one or more input devices. In some embodiments, the virtual content has one or more of the characteristics of the virtual content of methods 800, 1000 and/or 1400.), wherein the first virtual content is obscuring a first portion of a physical environment of a user of the computer system, such as content 1104 obscuring objects 1106 and 1108 in FIG. 11B (e.g., In some embodiments, the three-dimensional environment includes virtual content (e.g., content that is not in the physical environment) displayed by the computer system and one or more portions including the first portion of the physical environment of the user and/or the display generation component. In some embodiments, the one or more portions of the physical environment are displayed in the three-dimensional environment via the display generation component (e.g., virtual or video passthrough). In some embodiments, the one or more portions of the physical environment are views of the one or more portions of the physical environment of the computer system visible through a transparent portion of the display generation component (e.g., true or real passthrough). In some embodiments, the first virtual content is displayed in a manner that occludes or otherwise reduces the visibility of the first portion of the physical environment. For example, the first virtual content is optionally closer than, and between, the first portion of the physical environment and the viewpoint of the user from which the three-dimensional environment is visible via the display generation component), in accordance with a determination that a first physical object located at a first location in the first portion of the physical environment is in conflict with a potential range of motion of the user in the physical environment, such as object 1106 in FIG. 11B (e.g., the physical object has the potential to be a hazard for the user if the user moves a portion of their body near the first physical object with respect to the user of the computer system) (In some embodiments, while the first virtual content is obscuring the first portion of the physical environment, the computer system detects the first physical object in the first portion of the physical environment, and the first virtual content is also obscuring, occluding, or otherwise reducing the visibility of the first physical object. In some embodiments, before detecting the first physical object in the first portion of the physical environment, the first physical object was not in the first portion of the physical environment (e.g., was in a second portion of the physical environment, and subsequently moved to the first portion of the physical environment). In some embodiments, visibility of the first physical object was not obscured by virtual content when the first physical object was in the second portion of the physical environment. In some embodiments, the visibility of the first physical object was obscured by virtual content (e.g., the first virtual content) when the first physical object was in the second portion of the physical environment. In some embodiments, the first physical object is a danger or risk to a user of the computer system, such as a stationary object within the physical environment (e.g., a wall of the room in which the user is operating the computer system) or a moving object (e.g., another person in the physical environment such as a person as described with reference to method 1400, a ball rolling in the physical environment and/or a pet in the physical environment) that are optionally positioned in a line of movement of the user of the computer system.), the computer system generates (1202a), via the one or more output generation components, an alert, wherein the alert indicates the first location of the first physical object, such as the alert generated for object 1106 in FIG. 11B. The alert is optionally an audio or visual alert presented to the user of the computer system. In some embodiments, the computer system displays the alert at a location within the three-dimensional environment and/or first virtual content that corresponds to the location of the first physical object within the physical environment. For example, the computer system optionally displays a shadow, indication, flashing light indication and/or additional virtual element that corresponds to the first physical object overlaid on and/or through the portion of the first virtual content that is obscuring the portion of the first physical object in the three-dimensional environment. The alert of the first physical object is optionally displayed in various ways, discussed in greater detail hereinafter. In some embodiments, the computer system reduces or changes the opacity, brightness, color saturation, and/or other visual characteristic of the first virtual content by a first amount to increase the visibility of the alert and/or first physical object through the three-dimensional environment and/or the first virtual content (e.g., increase from 0% visible to 20%, 40%, 60% or 80% visible)).

In some embodiments, while generating the alert via the one or more output generation components (e.g., one or more audio generation components, haptic generation components, and/or display generation components), the computer system detects (1202b) behavior of the user, such as the behavior shown in FIG. 11C, 11D, or 11E.

In some embodiments, in response to detecting the behavior of the user (1202c), in accordance with a determination that the detected behavior of the user of the computer system that was detected while generating the alert meets one or more criteria (e.g., criteria that, when met, are indicative of awareness of the alert by the user, as will be described below), the computer system reduces (1202d) a prominence of the alert, such as shown with respect to the alert for object 1106 in FIGS. 11C and 11C1 (e.g., relative to other audio and/or visual outputs of the computer system, such as the three-dimensional environment). In some embodiments, the computer system reduces a prominence of the alert by decreasing the opacity, brightness, color saturation, and/or other visual characteristic of the alert (e.g., decrease from 80% visible to 60%, 40%, 20%, 5%, or 0% visible). In some embodiments, the computer system additionally or alternatively increases the opacity, brightness, color saturation, and/or other visual characteristic of the first virtual content (e.g., increase from 20% visible to 30%, 50%, 75% or 90% visible).

In some embodiments, in accordance with a determination that the detected behavior of the user of the computer system that was detected while generating the alert does not meet the one or more criteria (e.g., as will be described below), the computer system forgoes reducing (1202e) the prominence of the alert, such as for the alert for object 1108 in FIGS. 11C and 11C1 (e.g., relative to other audio and/or visual outputs of the computer system, such as the three-dimensional environment). In some embodiments, the computer system maintains a prominence of the alert by maintaining the opacity, brightness, color saturation, and/or other visual characteristic of the alert. Displaying an alert when hazard criteria are met and modifying the prominence of the alert based on user awareness of the alert allows a user to safely navigate through the physical environment when needed while reducing interruption of interaction with the virtual content, and reducing the inputs needed to reduce such interruption of interaction with the virtual content.

In some embodiments, in response to detecting the behavior of the user (1204a), in accordance with the determination that the detected behavior of the user of the computer system that was detected while generating the alert does not meet the one or more criteria (e.g., as will be described below with reference to step(s) 1206-1214), the computer system increases (1204b) the prominence of the alert, such as shown for the alert for object 1108 in FIG. 11D (e.g., relative to other audio and/or visual outputs of the computer system, such as the three-dimensional environment). For example, increasing a size, brightness, color saturation, opacity, volume, pitch and/or magnitude of the alert. In some embodiments, the prominence of the alert continues to increase for as long as the behavior of the user does not meet the one or more criteria. Increasing the prominence of the alert when user behavior does not indicate awareness of the alert increases the likelihood that the alert will be noticed by the user, thus increasing the ability of the user to move in their environment without conflicting with their environment.

In some embodiments, the one or more criteria include a criterion that is satisfied when a gaze of the user of the computer system is directed to the alert (1206), such as attention 1150 in FIGS. 11C and 11C1 (and is optionally not satisfied when the gaze of the user is not directed to the alert). Using gaze to indicate awareness of the alert facilitates efficient reduction or removal of the alert without the need for separate inputs to do so, and also increases the likelihood that awareness of the alert has actually occurred.

In some embodiments, the one or more criteria include a criterion that is satisfied when the behavior of the user reduces the conflict of the first physical object with the potential range of motion of the user in the physical environment (1208), such as the movement of the user from FIG. 11D to 11E (and is optionally not satisfied when the behavior of the user does not reduce—or increases—the conflict of the first physical object with the potential range of motion of the user in the physical environment). For example, the criterion is optionally satisfied (or not) based on user action, optionally other than directing gaze towards the alert, as will be described in more detail with reference to step(s) 1210-1214. In some embodiments, if subsequent user action increases the conflict of the first physical object with the potential range of motion of the user in the physical environment, the computer system increases the prominence of the alert again. Using user action to indicate awareness of the alert facilitates efficient reduction or removal of the alert without the need for separate inputs to do so, and also increases the likelihood that awareness of the alert has actually occurred.

In some embodiments, the behavior reduces the conflict of the first physical object with the potential range of motion of the user in the physical environment when a speed of movement of the user towards the first physical object is reduced (1210), such as reducing movement speed towards object 1106 in FIGS. 11C and 11C1. For example, when the alert is first generated, the speed of movement of the user towards the first physical object was optionally a first speed. In some embodiments, if the speed of movement of the user towards the first physical object reduces to a second speed, less than the first speed, while the alert is being generated, the criterion is optionally satisfied. In some embodiments, the reduction in speed must be more than a threshold reduction in speed (e.g., more than a 1, 3, 5, 10, 20, 40, 60, or 90% reduction in speed) for the criterion to be satisfied. Using user movement towards the object to indicate awareness of the alert facilitates efficient reduction or removal of the alert without the need for separate inputs to do so, and also increases the likelihood that awareness of the alert has actually occurred.

In some embodiments, the behavior reduces the conflict of the first physical object with the potential range of motion of the user in the physical environment when movement of the user towards the first physical object is ceased (1212), such as ceasing movement towards object 1106 in FIGS. 11C and 11C1. For example, when the alert is first generated, the speed of movement of the user towards the first physical object was optionally a first speed. In some embodiments, if the speed of movement of the user towards the first physical object reduces to zero the criterion is satisfied. In some embodiments, the speed of movement of the user towards the first physical object must be zero for longer than a time threshold (e.g., 0.1, 0.5, 1, 3, 5, 10, 30 or 60 seconds) for the criterion to be satisfied. Using cessation of user movement towards the object to indicate awareness of the alert facilitates efficient reduction or removal of the alert without the need for separate inputs to do so, and also reduces display clutter or distraction when conflict with the physical object becomes unlikely.

In some embodiments, the behavior reduces the conflict of the first physical object with the potential range of motion of the user in the physical environment when movement of the user is away from the first physical object (1214), such as shown from FIG. 11D to 11E. In some embodiments, the movement of the user away from the first physical object must persist for longer than a time threshold (e.g., 0.1, 0.5, 1, 3, 5, 10, 30 or 60 seconds) for the criterion to be satisfied. Using movement of the user movement away from the object to indicate awareness of the alert facilitates efficient reduction or removal of the alert without the need for separate inputs to do so, and also reduces display clutter or distraction when conflict with the physical object becomes unlikely.

In some embodiments, generating the alert in accordance with the determination that the first physical object located at the first location in the first portion of the physical environment is in conflict with the potential range of motion of the user in the physical environment includes generating the alert with a first prominence (1216a), such as the prominence of the alert for object 1108 in FIG. 11B (e.g., a first size, brightness, color saturation, opacity, volume, pitch and/or magnitude).

In some embodiments, in response to detecting the behavior of the user (1216b), in accordance with a determination that the detected behavior of the user of the computer system that was detected while generating the alert with the first prominence does not meet the one or more criteria because the detected behavior increases the conflict of the first physical object with the potential range of motion of the user in the physical environment, the computer system increases (1216c) the prominence of the alert from the first prominence to a second prominence greater than the first prominence, such as the increased prominence of the alert for object 1108 in FIG. 11D (e.g., a second size, brightness, color saturation, opacity, volume, pitch and/or magnitude, greater than the first size, brightness, color saturation, opacity, volume, pitch and/or magnitude). In some embodiments, user behavior that increases the conflict of the first physical object with the potential range of motion of the user in the physical environment includes the user performing the opposite of one or more of the actions described with reference to step(s) 1206-1214. In some embodiments, the increase in prominence of the alert in accordance with a determination that the detected behavior of the user of the computer system that was detected while generating the alert with the first prominence does not meet the one or more criteria because the detected behavior increases the conflict of the first physical object with the potential range of motion of the user in the physical environment is optionally different from (e.g., greater than) the increase in prominence of the alert described with reference to step(s) 1204. Increasing the prominence of the alert when user behavior indicates increased conflict increases the likelihood that the alert will be noticed by the user, thus increasing the ability of the user to move in their environment without conflicting with their environment.

In some embodiments, the one or more criteria include a criterion that is satisfied when the detected behavior decreases the conflict of the first physical object with the potential range of motion of the user in the physical environment (1218), such as from FIG. 11D to 11E. In some embodiments, user behavior that decreases the conflict of the first physical object with the potential range of motion of the user in the physical environment includes the user performing one or more of the actions described with reference to step(s) 1206-1214. Decreasing the prominence of the alert when user behavior indicates decreased conflict facilitates efficient reduction or removal of the alert without the need for separate inputs to do so, and also reduces display clutter or distraction when conflict with the physical object becomes unlikely.

In some embodiments, generating the alert includes displaying, via the display generation component, second virtual content separate from the first virtual content, wherein the second virtual content was not displayed prior to generating the alert (1220), such as displaying indications 1107 and 1109 in FIG. 11B. In some embodiments, the second virtual content is or includes animated concentric rings or other shapes that animate as if emanating from a location of the virtual content corresponding to the first physical object, and move away from that location as part of the animation. In some embodiments, the second virtual content is displayed concurrently with the first virtual content. In some embodiments, the second virtual content is overlaid on one or more portions of the first virtual content that do or do not correspond to the first physical object. Displaying additional virtual content as part of the alert increases the likelihood that the alert will be noticed by the user, thus increasing the ability of the user to move in their environment without conflicting with their environment.

In some embodiments, generating the alert includes reducing a visual prominence of (e.g., increasing a transparency of, decreasing a color saturation of, and/or decreasing a brightness of) a first portion of the first virtual content corresponding to the first location of the first physical object relative to a second portion of the first virtual object corresponding to a second location in the physical environment (e.g., a portion of the first virtual content that does not correspond to the first physical object) such that the first physical object (and/or the first portion of the physical environment) is at least partially visible through the first portion of the first virtual content (1222), such as shown in the lower left and right regions of content 1104 in FIG. 11B. For example, the computer system at least partially or fully ceases display of the first portion of the first virtual content, allowing the first portion of the first physical environment to be at least partially visible through the first portion of the first virtual content. In some embodiments, the portion of the first virtual content of which the visual prominence is reduced is optionally different depending on the location of the first virtual object relative to the first virtual content. Reducing the visual prominence of the portion of the first virtual content that obscures visibility of the first physical object increases the likelihood that the first physical object will be noticed by the user, thus increasing the ability of the user to move in their environment without conflicting with their environment.

In some embodiments, first audio output associated with the first virtual content is generated concurrently with displaying the first virtual content, such as audio output concurrently with display of content 1104 in FIG. 11B (e.g., if the first virtual content is a virtual environment that simulates a physical place, such as described with reference to methods 800, 1000 and/or 1200, the first audio output is optionally audio that aurally simulates and/or corresponds to the simulated physical space; if the first virtual content is video content, the first audio output is optionally the audio track(s) that accompany the first virtual content), and generating the alert includes changing one or more characteristics (e.g., volume, pitch, and/or directionality) of the first audio output (1224), such as if audio generated with content 1104 is changed in characteristics in FIG. 11B. Changing characteristics of audio output as part of the alert increases the likelihood that the first physical object will be noticed by the user, thus increasing the ability of the user to move in their environment without conflicting with their environment.

In some embodiments, changing the one or more characteristics of the first audio output includes generating second audio output (e.g., one or more beeps and/or tones) having directional characteristics corresponding to the first location of the first physical object (1226), such as audio outputs 1107a and 1109a in FIG. 11B. For example, the second audio output is generated by the computer system such as if it is emanating from the location of the first physical object and/or the location of the first virtual content corresponding to the first virtual object, and is optionally not generated as if it is emanating from a location that does not correspond to the first physical object. Therefore, in some embodiments, the direction from which the second audio output is generated (optionally relative to the first virtual content) is different depending on the location of the first physical object relative to the first virtual content. In some embodiments, the second audio output is or includes audio generated by the first physical object. Generating directional audio as part of the alert increases the likelihood that the first physical object will be noticed by the user, thus increasing the ability of the user to move in their environment without conflicting with their environment.

In some embodiments, changing the one or more characteristics of the first audio output includes reducing an aural prominence of (e.g., reducing a volume, magnitude and/or pitch of) a respective portion of the first audio output, wherein the respective portion of the first audio output has directional characteristics corresponding to the first location of the first physical object (1228), such as reducing the prominence of audio corresponding to the location of object 1106 and/or 1108 in FIG. 11B. In some embodiments, the first audio output is or includes spatial audio; for example, an audio landscape corresponding to a spatial landscape (e.g., the three-dimensional environment) where different portions of the audio that is generated correspond to (e.g., are generated as emanating from) different locations in the audio landscape (and thus corresponding to the different portions of the spatial landscape). For example, if in the three-dimensional environment, a chirping bird is located in a back left location of the room, and a barking dog is located in a front right location in the room, the audio generated for the chirping bird is generated as if emanating from the back left location, and the audio generated for the barking dog is generated as if emanating from the front right location. In some embodiments, the computer system creates an aural hole or a region of the aural landscape corresponding to the first audio output that has no or reduced audio output—that region corresponding to the location of the first physical object—as part of the alert. For example, if the first physical object is located at the back left location corresponding to the chirping bird, the prominence of the audio of the chirping bird is optionally reduced or eliminated, and if the first physical object is located at the front right location corresponding to the barking dog, the prominence of the audio of the barking dog is optionally reduced or eliminated. Portions of the aural landscape of the first audio output that do not correspond to the first physical object are optionally not reduced in aural prominence. The location of the aural hole or reduced-aural prominence region optionally corresponds to the location of the first physical object. Therefore, in some embodiments, the location of the aural hole or reduced-aural prominence region is different depending on the location of the first physical object relative to the first virtual content. Generating a reduced-aural prominence region as part of the alert increases the likelihood that the first physical object will be noticed by the user, thus increasing the ability of the user to move in their environment without conflicting with their environment.

In some embodiments, generating the alert includes (1230a) displaying (1230b), via the display generation component, a virtual lighting effect (e.g., a virtual flashing light effect, or a continuous virtual spotlight effect) from a direction of the display generation component that corresponds to the first location of the first physical object, such as a virtual lighting effect from the location of object 1106 and/or 1108 in FIG. 11B. For example, if the first physical object is located on the right side of the first virtual object and/or to the right of the user in the physical environment, the virtual lighting effect is optionally displayed from the right side (and not the left side) of the three-dimensional environment that is visible via the display generation component, and if the first physical object is located on the left side of the first virtual object and/or to the left of the user in the physical environment, the virtual lighting effect is optionally displayed from the left side (and not the right side) of the three-dimensional environment that is visible via the display generation component. In some embodiments, the virtual lighting effect is displayed as emanating from a particular portion of the virtual content corresponding to the location of the first physical object; for example, if the first physical object is located at a first location relative to the virtual content, the virtual lighting effect is optionally displayed as emanating from the first location, and if the first physical object is located at a second location, different from the first location, relative to the virtual content, the virtual lighting effect is optionally displayed as emanating from the second location. In some embodiments, the virtual lighting effect is applied to one or more portions of the physical environment that are visible via the display generation component at the time the alert is generated and/or one or more portions of virtual content that is displayed via the display generation component at the time the alert is generated. Generating a directional virtual lighting effect as part of the alert increases the likelihood that the first physical object will be noticed by the user, thus increasing the ability of the user to move in their environment without conflicting with their environment.

It should be understood that the particular order in which the operations in method 1200 have been described is merely exemplary and is not intended to indicate that the described order is the only order in which the operations could be performed. One of ordinary skill in the art would recognize various ways to reorder the operations described herein.

FIGS. 13A-13H illustrate examples of a computer system changing the visual prominence of people in a three-dimensional environment based on one or more attention-related factors in accordance with some embodiments.

FIG. 13A illustrates a computer system 101 displaying, via a display generation component (e.g., display generation component 120 of FIG. 1), a three-dimensional environment 1302 from a viewpoint of the user 1326 illustrated in the overhead view (e.g., facing the back wall of the physical environment in which computer system 101 is located). As described above with reference to FIGS. 1-6, the computer system 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user).

As shown in FIG. 13A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 1302 or portions of the physical environment are visible via the display generation component 120 of computer system 101. For example, three-dimensional environment 1302 includes portions of the left and right walls, the ceiling, and the floor in the physical environment of user 1326.

In FIG. 13A, three-dimensional environment 1302 also includes virtual content, such as virtual content 1304. Virtual content 1304 is optionally one or more of a user interface of an application (e.g., messaging user interface, or content browsing user interface), a three-dimensional object (e.g., virtual clock, virtual ball, or virtual car), a virtual environment (e.g., as described with reference to method 1400) or any other element displayed by computer system 101 that is not included in the physical environment of computer system 101.

In FIG. 13A, the physical environment of user 1326 does not include any other people in it other than user 1326. In FIG. 13A, virtual content 1304 is obscuring visibility of portions of the physical environment, such as portions of the back wall and the floor of the physical environment, because virtual content 1304 is at least partially opaque and is positioned between the portions of the back wall and the floor, and the viewpoint of user 1326. Additional or alternative details of how virtual content 1304 obscures visibility of portions of the physical environment are provided with reference to method 1400. In FIG. 13A, computer system 101 is also reducing the visual prominence of portions of the environment that are visible outside of virtual content 1304 (e.g., portions of the left and right walls, the back wall, the ceiling, and the floor in the physical environment of user 1326), as described in more detail with reference to method 1400.

In some embodiments, computer system 101 displays indications of other people in the physical environment of user 1326 when those people are obscured by virtual content 1304 so that user 1326 can become aware of their presence to facilitate interaction between user 1326 and the one or more people and/or to reduce the likelihood of collision between user 1326 and the one or more people. For example, in FIG. 13B, computer system 101 detects person 1306 and person 1308 behind virtual content 1304 relative to the viewpoint of user 1326. In FIG. 13B, user 1326 is not directing attention towards person 1306 or 1308 (e.g., as described in more detail with reference to method 1400), and people 1306 and 1308 are also not directing their attention towards user 1326 (e.g., as described in more detail with reference to method 1400)—for example, as indicated by the lack of arrows between indications 1306, 1308 and 1326 (corresponding to person 1306, person 1308 and user 1326) in the lower-left corner of FIG. 13B. In some embodiments, when computer system 101 detects that a person is obscured by virtual content 1304, even when attention between user 1326 and that person is missing, computer system 101 reduces the visual prominence of one or more portions of virtual content 1304 to increase the visibility of that person in three-dimensional environment 1302. For example, in FIG. 13B, computer system 101 has reduced the visual prominence of (e.g., has reduced the opacity of or the brightness of) portion 1310 of virtual content 1304 corresponding to person 1306, such that person 1306 is at least partially visible through virtual content 1304 in three-dimensional environment 1302. Separately, in FIG. 13B, computer system 101 has reduced the visual prominence of (e.g., has reduced the opacity of or the brightness of) portion 1312 of virtual content 1304 corresponding to person 1308, such that person 1308 is at least partially visible through virtual content 1304 in three-dimensional environment 1302. While multiple people 1306 and 1308 are illustrated in FIGS. 13B-13H, it is understood that computer system 101 optionally similarly responds as described herein to the presence of one person in the physical environment, or the presence of three or more people in the physical environment, where the response of computer system 101 for a given person is optionally as described herein.

In some embodiments, computer system 101 increases the visual prominence of a person in the physical environment of user 1326 in response to detecting that the person is directing their attention to user 1326. For example, in FIG. 13C, computer system 101 has detected that person 1306 is directing their attention to user 1326 (e.g., indicated by the arrow from indication 1306 towards indication 1326 in the lower-left corner of FIG. 13C). For example, computer system 101 has detected that person 1306 is looking at user 1326. Method 1400 describes additional or alternative details relating to how computer system 101 detects or determines that the attention of a person is directed to user 1326. In response, computer system 101 has increased the visual prominence of person 1306 relative to virtual content 1304 in three-dimensional environment 1302, such as by decreasing the opacity of portion 1310 of virtual content 1304 more than in FIG. 13B, which results in person 1306 being more visible through virtual content 1304 in FIG. 13C. In FIG. 13C, person 1308 is not directing attention to user 1326, not is user 1326 directing attention to person 1308—therefore, the visual prominence of person 1308 relative to virtual content 1304 in FIG. 13C is optionally the same as the visual prominence of person 1308 relative to virtual content 1304 in FIG. 13B.

In FIG. 13D, person 1306 and person 1308 have moved relative to virtual content 1304, and therefore, computer system 101 has changed the locations of portions 1310 and 1312 of virtual content 1304 that it is reducing in visual prominence (e.g., increasing in transparency) to continue to correspond to person 1306 and person 1308, respectively, such that person 1306 and person 1308 continue to remain visible through virtual content 1304. Further, in FIG. 13D, in addition to person 1306 continuing to direct their attention towards user 1326 by, for example, looking at user 1326, computer system 101 has detected that person 1308 is directing their attention towards user 1326 by detecting that person 1308 is saying the name of user 1326. Method 1400 describes additional or alternative details relating to how computer system 101 detects or determines that the attention of a person is directed to user 1326. In response, computer system 101 has increased the visual prominence of person 1308 relative to virtual content 1304 in three-dimensional environment 1302, such as by decreasing the opacity of portion 1312 of virtual content 1304 more than in FIG. 13C, which results in person 1308 being more visible through virtual content 1304 in FIG. 13D.

In some embodiments, after increasing the visual prominence of a person relative to virtual content 1304 due to the person directing attention to user 1326—and optionally even while that attention remains directed to user 1326—computer system 101 gradually reduces the visual prominence of that person relative to virtual content 1304 over a time period (e.g., over 0.1, 0.5, 1, 3, 5, 10, 30, 60 or 120 seconds). For example, in FIG. 13E, person 1306 continues to direct their attention to user 1326 (e.g., continuing from FIG. 13C), but computer system has, over the above-described time period, reduced the visual prominence of person 1306 and person 1308 relative to virtual content 1304 (e.g., by increasing the visual prominence of portions 1310 and 1312 of virtual content 1304, such as by increasing the opacity and/or brightness of portions 1310 and 1312 of virtual content 1304).

In some embodiments, computer system 101 increases the visual prominence of a person relative to virtual content 1304 when user 1326 directs attention to that person. For example, in FIG. 13F, the attention 1350 of user 1326 is detected as being directed to person 1308. In response, computer system 101 has increased the visual prominence of person 1308 relative to virtual content 1304 (e.g., by reducing the visual prominence of portion 1312 of virtual content 1304, such as by reducing the opacity and/or brightness of portion 1312 of virtual content 1304). In FIG. 13F, the attention 1350 of user 1326 is not directed to person 1306—as such, computer system 101 has not modified the visual prominence of person 1306 relative to virtual content 1304.

In some embodiments, in response to computer system 101 detecting interaction with virtual content 1304 by user 1326, computer system 101 reduces the visual prominence of person 1306 and person 1308 relative to virtual content 1304—optionally even if the attention of user 1326 is directed to person 1306 and person 1308 and/or the attention of person 1306 and person 1308 are directed to user 1326. For example, from FIG. 13F to FIG. 13G, computer system 101 detects input from hand 1351 of user 1326 for moving virtual content 1304 in three-dimensional environment 1302 (e.g., an air pinch gesture from hand 1351 while attention of user 1326 is directed to virtual content 1304, followed by movement of hand 1351 while maintaining the pinch hand shape). Additional or alternative details of interactions with virtual content 1304 and corresponding inputs are described with reference to method 1400. In response, as shown in FIG. 13G, while the interaction with virtual content 1304 is ongoing, computer system 101 reduces the visual prominence of person 1308 relative to virtual content 1304 (e.g., by increasing the visual prominence of portion 1312 of virtual content 1304, such as by increasing the opacity and/or brightness of portion 1312 of virtual content 1304), even though attention 1350 of user 1326 remains directed to person 1308.

FIG. 13G1 illustrates similar and/or the same concepts as those shown in FIG. 13G (with many of the same reference numbers). It is understood that unless indicated below, elements shown in FIG. 13G1 that have the same reference numbers as elements shown in FIGS. 13A-13H have one or more or all of the same characteristics. FIG. 13G1 includes computer system 101, which includes (or is the same as) display generation component 120. In some embodiments, computer system 101 and display generation component 120 have one or more of the characteristics of computer system 101 shown in FIGS. 13A-13H and display generation component 120 shown in FIGS. 1 and 3, respectively, and in some embodiments, computer system 101 and display generation component 120 shown in FIGS. 13A-13H have one or more of the characteristics of computer system 101 and display generation component 120 shown in FIG. 13G1.

In FIG. 13G1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 13A-13H.

In FIG. 13G1, display generation component 120 is illustrated as displaying content that optionally corresponds to the content that is described as being displayed and/or visible via display generation component 120 with reference to FIGS. 13A-13H. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 13G1.

Display generation component 120 has a field of view (e.g., a field of view captured by external image sensors 314b and 314c and/or visible to the user via display generation component 120, indicated by dashed lines in the overhead view) that corresponds to the content shown in FIG. 13G1. Because display generation component 120 is optionally a head-mounted device, the field of view of display generation component 120 is optionally the same as or similar to the field of view of the user.

In FIG. 13G1, the user is depicted as performing an air pinch gesture (e.g., with hand 1351) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 13A-13H.

In some embodiments, computer system 101 responds to user inputs as described with reference to FIGS. 13A-13H.

In the example of FIG. 13G1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 13A-13H and/or described with reference to the corresponding method(s) are optionally implemented on computer system 101 and display generation unit 120 in a manner similar or analogous to that shown in FIG. 13G1.

In some embodiments, in response to detecting that attention 1350 of user 1326 is not directed to either of person 1306 or person 1308 (e.g., attention 1350 is directed to portions of virtual content 1304 not corresponding to person 1306 or person 1308) and/or that attention of person 1306 and person 1308 is not directed to user 1326, computer system 101 reduces the visual prominence of person 1306 and/or person 1308 relative to virtual content 1304 even further, optionally down to zero (e.g., such that person 1306 and/or person 1308 are no longer visible through virtual content 1304). For example, in FIG. 13H, attention 1350 of user 1326 is directed to a portion of virtual content 1304 that does not correspond to person 1306 and/or person 1308. Further, neither person 1306 nor person 1308 is directing attention to user 1326. Therefore, in response, in FIG. 13H computer system 101 has fully reduced the visual prominences of person 1306 and person 1308 relative to virtual content 1304 such that neither is visible through virtual content 1304.

FIGS. 14A-14H is a flowchart illustrating a method 1400 of changing the visual prominence of people in a three-dimensional environment based on one or more attention-related factors in accordance with some embodiments. In some embodiments, the method 1400 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1400 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1400 are, optionally, combined and/or the order of some operations is, optionally, changed.

In some embodiments, method 1400 is performed at a computer system in communication with a display generation component and one or more input devices. In some embodiments, the computer system has one or more of the characteristics of the computer system of methods 800, 1000, and/or 1200. In some embodiments, the display generation component has one or more of the characteristics of the display generation component of methods 800, 1000, and/or 1200. In some embodiments, the one or more input devices have one or more of the characteristics of the one or more input devices of methods 800, 1000, and/or 1200.

In some embodiments, while displaying, via the display generation component, first virtual content, such as content 1304 in FIG. 13A (e.g., In some embodiments, the first virtual content is displayed in a three-dimensional environment. In some embodiments, the three-dimensional environment is generated, displayed, or otherwise caused to be viewable by the computer system (e.g., an extended reality (XR) environment such as a virtual reality (VR) environment, a mixed reality (MR) environment, or an augmented reality (AR) environment). In some embodiments, the three-dimensional environment has one or more of the characteristics of the three-dimensional environments of methods 800, 1000, and/or 1400. In some embodiments, the first virtual content is a user interface of an application on the computer system, such as a content (e.g., movie, television show and/or music) playback application, and the user interface is displaying or otherwise presenting the content; in some embodiments, the first virtual content is a two-dimensional or three-dimensional model of an object such as a tent, a building, or a car; in some embodiments, the first virtual content is a virtual environment, such as an environment that is representative of a corresponding physical environment/location such as a mountain location, a beach location, or a park location. In some embodiments, the virtual environment is interactive such that a user of the computer system can explore the virtual environment by providing inputs via the one or more input devices. In some embodiments, the virtual content has one or more of the characteristics of the virtual content of methods 800, 1000 and/or 1200.), wherein the first virtual content is obscuring a first portion of a physical environment, the computer system detects (1401a), via the one or more input devices, a first person located in the first portion of the physical environment, such as person 1306 in FIG. 13B (e.g., In some embodiments, the three-dimensional environment includes virtual content (e.g., content that is not in the physical environment) displayed by the computer system and one or more portions of the physical environment of the user and/or the display generation component). In some embodiments, the one or more portions of the physical environment are displayed in the three-dimensional environment via the display generation component (e.g., virtual or video passthrough). In some embodiments, the one or more portions of the physical environment are views of the one or more portions of the physical environment of the computer system visible through a transparent portion of the display generation component (e.g., true or real passthrough). In some embodiments, the first virtual content is displayed in a manner that occludes or otherwise reduces the visibility of the first portion of the physical environment. For example, the first virtual content is optionally closer than, and between, the first portion of the physical environment and the viewpoint of the user from which the three-dimensional environment is visible via the display generation component. In some embodiments, while the first virtual content is obscuring the first portion of the physical environment, the computer system detects the first person in the first portion of the physical environment, and the first virtual content also obscures, occludes, or otherwise reduces the visibility of the first person. In some embodiments, before detecting the first person in the first portion of the physical environment, the first person was not in the first portion of the physical environment (e.g., was in a second portion of the physical environment, and subsequently moved to the first portion of the physical environment). In some embodiments, visibility of the first person was not obscured by virtual content when the first person was in the second portion of the physical environment. In some embodiments, the visibility of the first person was obscured by virtual content (e.g., the first virtual content) when the first person was in the second portion of the physical environment.

In some embodiments, in response to detecting the first person in the first portion of the physical environment (1402b), in accordance with a determination that the first person satisfies one or more criteria, wherein the one or more criteria indicate that the computer system has detected that attention of the first person is directed to a user of the computer system, such as the attention of person 1306 in FIG. 13C (e.g., the satisfaction of the one or more criteria is discussed in greater detail hereinafter), the computer system increases (1402c) a visual prominence of the first person relative to the first virtual content, such as shown with respect to person 1306 in FIG. 13C. In some embodiments, the computer system reduces or changes the opacity, brightness, color saturation, and/or other visual characteristic of the first virtual content relative to the three-dimensional environment less than completely, thus increasing the visibility of the first person through the three-dimensional environment and/or first virtual content (e.g., increase from 0% visible to 20%, 40%, 60% or 80% visible, or increase from 5% visible to 20%, 40%, 60% or 80% visible). In some embodiments, a first portion of the first virtual content is reduced in visual prominence (e.g., the portion of the first virtual content that is obscuring visibility of the person), and a second portion of the first virtual content is not reduced in visual prominence (e.g., the portion of the first virtual content that is not obscuring visibility of the person). Thus, in some embodiments, which portion(s) of the first virtual content that have their prominence reduced are optionally different depending on the location of the person relative to the first virtual content.

In some embodiments, in accordance with a determination that the first person does not satisfy the one or more criteria, the computer system forgoes increasing (1402d) the visual prominence of the first person relative to the first virtual content, such as not increasing the visual prominence of person 1306 from FIG. 13B (e.g., does not increase a visibility of the first portion of the physical environment through the first virtual content). In some embodiments, the visibility (or lack thereof) of the first person in the three-dimensional environment is not changed when the computer system maintains the visual prominence of the first virtual content relative to the three-dimensional environment. Reducing the visual prominence of virtual content allows a user to interact with persons in the physical environment when needed while otherwise maintaining display of the virtual content and reducing distraction for the user.

In some embodiments, increasing the visual prominence of the first person relative to the first virtual content includes increasing the visual prominence of the first person to a first visual prominence relative to the first virtual content (1404a), such as the prominence of person 1306 in FIG. 13C (e.g., increase the visual prominence of the first person such that they are 5, 10, 30, 50, 75, 80, 90 or 100% visible and/or decrease the visual prominence of the first virtual content to 0, 5, 10, 30, 50, 75, 80 or 90% of the visual prominence of the first virtual content before the first person was detected).

In some embodiments, in response to detecting the first person in the first portion of the physical environment and before the first person satisfies the one or more criteria (e.g., before the computer system detects attention of the first person directed towards the user and/or before the computer system detects attention of the user towards the first person), the computer system increases (1404b) the visual prominence of the first person relative to the first virtual content to a second visual prominence relative to the first virtual content, wherein the second visual prominence is less than the first visual prominence, such as the prominence of person 1306 in FIG. 13B (e.g., increase the visual prominence of the first person such that they are 1, 5, 10, 30, 50, 75, 80, or 90% visible and/or decrease the visual prominence of the first virtual content to 5, 10, 30, 50, 75, 80 or 90% of the visual prominence of the first virtual content before the first person was detected). Therefore, in some embodiments, the presence of the first person in the first portion of the physical environment causes the computer system to generate a first, smaller level of breakthrough of the first virtual content for the first person. Reducing the visual prominence of virtual content by an initial smaller amount when a first person is detected in the physical environment conveys the existence of the first person even when they are not looking at the user while reducing distraction for the user caused by the reduction in visual prominence of the virtual content.

In some embodiments, the one or more criteria include a criterion that is satisfied when the computer system has detected that gaze of the first person is directed to the user of the computer system (1406), such as the gaze of person 1306 in FIG. 13C (e.g., the gaze of the first person is within 1, 3, 5, 10, 30, 60, or 90 degrees of being directed towards the user). In some embodiments, the criterion is not satisfied if the gaze of the first person is not within 1, 3, 5, 10, 30, 60, or 90 degrees of being directed towards the user. Determining attention of the first person based on gaze of the first person reduces unwarranted reduction of visual prominence of the virtual content, and also increases the likelihood that interaction with the first person will happen after the reduction in the visual prominence of the virtual content, thereby avoiding instances of reducing the visual prominence of the virtual content unnecessarily.

In some embodiments, the one or more criteria include a criterion that is satisfied when the computer system has detected speech of the first person that satisfies one or more second criteria (1408), such as the speech of person 1308 in FIG. 13D. In some embodiments, the criterion is not satisfied when the computer system has not detected speech of the first person that satisfies the one or more second criteria, or has detected speech of the first person that does not satisfy the one or more second criteria. In some embodiments, the one or more second criteria are satisfied when the first person says the name of the user of the computer system. In some embodiments, the one or more second criteria are satisfied when the first person speaks in a direction towards (e.g., within 1, 3, 5, 10, 30, 60, or 90 degrees of being directed towards) the user of the computer system. In some embodiments, the one or more second criteria are satisfied when the first person says an identifier associated with the first person other than the name of the first person (e.g., “mom”, “dad” or “grandpa”). In some embodiments, the one or more second criteria are satisfied when a volume of speech spoken by the first person is greater than a volume threshold (e.g., greater than 1, 5, 10, 30, 60, 90 or 120 decibels). In some embodiments, the one or more second criteria are not satisfied one or more of the above satisfying events are not detected, such as if the first person makes a sound that is not speech. Determining attention of the first person based on speech of the first person reduces unwarranted reduction of visual prominence of the virtual content, and also increases the likelihood that interaction with the first person will happen after the reduction in the visual prominence of the virtual content, thereby avoiding instances of reducing the visual prominence of the virtual content unnecessarily.

In some embodiments, the one or more criteria include a criterion that is satisfied when the computer system has detected a respective portion of a body of the first person (e.g., head, torso, eyes and/or shoulders) that satisfies one or more second criteria (1410), such as with respect to person 1306 in FIG. 13C (e.g., as will be described with reference to step(s) 1412-1414). In some embodiments, the criterion is not satisfied when the computer system has not detected the respective portion of the body of the first person that satisfies the one or more second criteria, or has detected the respective portion of the body of the first person that does not satisfy the one or more second criteria. Determining attention of the first person based on a portion of the body of the first person reduces unwarranted reduction of visual prominence of the virtual content, and also increases the likelihood that interaction with the first person will happen after the reduction in the visual prominence of the virtual content, thereby avoiding instances of reducing the visual prominence of the virtual content unnecessarily.

In some embodiments, the criterion is satisfied when the computer system detects a distance of the respective portion of the body of the first person from the user of the computer system that is less than a threshold distance (1412), such as if person 1306 in FIG. 13C is within the threshold distance of user 1326 (e.g., 0.1, 0.5, 1, 3, 5, 10, 100 or 1000 meters). For example, the criterion is optionally not satisfied when the first person is greater than the threshold distance of the user. Determining attention of the first person based on a distance of the first person from the user reduces unwarranted reduction of visual prominence of the virtual content, reduces the likelihood of collision with the first person, and also increases the likelihood that interaction with the first person will happen after the reduction in the visual prominence of the virtual content, thereby avoiding instances of reducing the visual prominence of the virtual content unnecessarily.

In some embodiments, the criterion is satisfied when the computer system detects an orientation of the respective portion of the body of the first person (e.g., head, torso, eyes and/or shoulders) relative to the user of the computer system that is within a threshold orientation (1414), such as if person 1306 in FIG. 13C is oriented in this way (e.g., 1, 3, 5, 10, 30, 60, or 90 degrees). For example, the criterion is optionally not satisfied if the respective portion of the first person is not within the threshold orientation of being oriented towards the user. Determining attention of the first person based on an orientation of the first person relative to the user reduces unwarranted reduction of visual prominence of the virtual content, and also increases the likelihood that interaction with the first person will happen after the reduction in the visual prominence of the virtual content, thereby avoiding instances of reducing the visual prominence of the virtual content unnecessarily.

In some embodiments, while displaying, via the display generation component, the first virtual content, the computer system detects (1416a), via the one or more input devices, a respective person (e.g., the first person, or a second person, different from the first person) located in a respective portion of the physical environment that is obscured by the first virtual content (e.g., such as described with reference to the first portion of the physical environment in step(s) 1402), such as person 1306 in FIG. 13B. In some embodiments, in response to detecting the respective person in the respective portion of the physical environment, and in accordance with a determination that the respective person satisfies the one or more criteria (1416b) (e.g., as described with reference to step(s) 1402), in accordance with a determination that a first setting of the computer system has a first value, the computer system increases (1416c) a visual prominence of the respective person relative to the first virtual content (e.g., as described with reference to step(s) 1402), such as shown with respect to person 1306 in FIGS. 13B and/or 13C. In some embodiments, in accordance with a determination that the first setting of the computer system has a second value, different from the first value, the computer system forgoes increasing (1416d) the visual prominence of the respective person relative to the first virtual content, such as not increasing the prominence of person 1306 in FIGS. 13B and/or 13C. For example, in some embodiments, the user of the computer system is able to provide input to change the first setting of the computer system from the first value to the second value. The first value optionally corresponds to a setting that allows breakthrough of people through virtual content based on attention factors associated with the people as described with reference to method 1400, while the second value optionally corresponds to a setting that does not allow breakthrough of people through virtual content based on such attention factors. In some embodiments, the first setting has the second value when the user provides input to the computer system to enable a focus mode that, in addition to preventing attention-based breakthrough, optionally also prevents the computer system from generating one or more notifications in response to detecting notification events (e.g., new incoming emails, new incoming text messages, and/or incoming calls) that the computer system would otherwise generate if the focus mode were not enabled. In some embodiments, the focus mode specifically prevents the computer system from generating notifications for particular applications or associated with particular people and/or sources while allowing notifications for other applications and/or other people and/or sources. Allowing the user of the computer system to control whether attention-based breakthrough occurs reduces undesired reduction of visual prominence of the virtual content, thereby improving interaction between the user and the computer system.

In some embodiments, the computer system displays (1418), via the display generation component, a control user interface for the computer system that includes a selectable option that is selectable to set the first value or the second value for the first setting, such as if computer system 101 were displaying such a user interface in FIG. 13A. In some embodiments, the control user interface is a user interface that includes one or more controls for controlling one of more functionalities of the computer system (e.g., volume settings, brightness settings, and/or Wi-Fi settings). In some embodiments, the control user interface includes a control to toggle the first setting between the first setting and the second setting (e.g., to enable or disable the focus mode). Facilitating control of the first setting in a control center user interface reduces the number of inputs needed to find such a setting and otherwise control the computer system, thereby improving interaction between the user and the computer system.

In some embodiments, increasing the visual prominence of the first person relative to the first virtual content includes modifying a visual appearance of a respective portion of the first virtual content (1420), such as modifying the appearance of portion 1310 of content 1304 in FIG. 13B (e.g., increasing the translucency of the respective portion of the first virtual content, reducing a brightness of the respective portion of the first virtual content and/or increasing an alpha value of the respective portion of the first virtual content), wherein a shape of the respective portion of the first virtual content is asymmetrical along at least one axis, such as the shape of portion 1310 in FIG. 13B (e.g., vertical or horizontal axes relative to the viewpoint of the user and/or gravity, such as an oval shape, a rectangular shape or an avocado shape along the vertical axis). In some embodiments, the respective portion of the first virtual content is the portion of the first virtual content that is obscuring greater visibility of the first person through the first virtual content. In some embodiments, modifying the visual appearance of the respective portion of the first virtual content increases the visibility of the first person through the respective portion of the first virtual content. In some embodiments, the length of the longer axis of the shape of the respective portion of the first virtual content corresponds to, and is optionally aligned with, the height of the first person. Modifying the visual appearance of an asymmetrical portion of the first virtual content increases the likelihood that more of the first person will become visible, thereby facilitating interaction with the first person and/or reducing the likelihood of collision with the first person.

In some embodiments, increasing the visual prominence of the first person relative to the first virtual content includes modifying a visual appearance of a respective portion of the first virtual content (1422a) (e.g., as described with reference to step(s) 1420), such as portion 1310 in FIG. 13C. In some embodiments, while the first person satisfies the one or more first criteria and while the first person has the increased visual prominence relative to the first virtual content (1422b), while the respective portion of the first virtual content is a first respective portion of the first virtual content that corresponds to a first location of the first person relative to the first virtual content (e.g., the respective portion of the first virtual content is on a right side of the first virtual content, because the first person is behind the right side of the first virtual content relative to the viewpoint of the user), the computer system detects (1422c), via the one or more input devices, movement of the first person from the first location relative to the first virtual content to a second location, different from the first location, relative to the first virtual content, such as the movement of person 1306 from FIG. 13C to 13D (e.g., movement of the first person to the middle section of the first virtual content while remaining behind the first virtual content relative to the viewpoint of the user, or movement of the first person to the left side of the first virtual content while remaining behind the first virtual content relative to the viewpoint of the user).

In some embodiments, in response to detecting the movement of the first person from the first location relative to the first virtual content to the second location relative to the first virtual content, the computer system modifies (1422d) a visual appearance of a second respective portion of the first virtual content that corresponds to the second location of the first person relative to the first virtual content, such as shown with respect to content 1304 in FIG. 13D (and optionally at least partially or fully reversing the modification of the visual appearance of the first respective portion of the first virtual content). For example, the second respective portion of the first virtual content is in a middle section of the first virtual content, because the first person has moved to being behind the middle section of the first virtual content relative to the viewpoint of the user, or the second respective portion of the first virtual content is in a left side of the first virtual content, because the first person has moved to being behind the left side of the first virtual content relative to the viewpoint of the user. Moving the portion of the first virtual content whose visual appearance is modified to continue to correspond to the current position of the first person relative to the first virtual content from the viewpoint of the user ensures that visibility of the first person is maintained, thereby facilitating interaction with the first person and/or reducing the likelihood of collision with the first person.

In some embodiments, increasing the visual prominence of the first person relative to the first virtual content includes (1424a) increasing the visual prominence of the first person relative to the first virtual content to a first visual prominence relative to the first virtual content (1424b) (e.g., such as described with reference to step(s) 1404), such as shown with respect to person 1306 in FIG. 13D, and after increasing the visual prominence of the first person relative to the first virtual content to the first visual prominence, gradually (e.g., over a time period such as 0.1, 0.5, 1, 3, 5, 10, 30 or 60 seconds) decreasing the visual prominence of the first person relative to the first virtual content from the first visual prominence to a second visual prominence (less than the first visual prominence) relative to the first virtual content (1424c), such as shown with respect to person 1306 in FIG. 13E. Thus, in some embodiments, the first person initially breaks through the first virtual content with a first magnitude, and subsequently the breakthrough of the first person through the first virtual content gradually decreases. In some embodiments, the visual prominence of the first person gradually decreases to a minimum non-zero prominence (e.g., 5, 10, 30, 50, 75, 80, or 90% prominence). In some embodiments, the visual prominence of the first person gradually decreases to the visual prominence of the first person prior to the breakthrough of the first person (e.g., 0, 5, 10 or 30% prominence). Initially displaying the first person with more visual prominence and subsequently gradually reducing the visual prominence increases the likelihood that the user of the computer system will notice the first person, and subsequently allows for improved visibility of the virtual content without the need for additional inputs.

In some embodiments, while the visual prominence of the first person relative to the first virtual content is the second visual prominence relative to the first virtual content, the computer system detects (1426a), via the one or more input devices, attention of the user of the computer system directed to the first person (optionally for longer than a time threshold, such as 0.1, 0.5, 1, 3, 5, 10, 30 or 60 seconds), such as the attention of user 1326 directed to person 1308 in FIG. 13F. In some embodiments, in response to detecting the attention of the user of the computer system directed to the first person, the computer system increases (1426b) the visual prominence of the first person relative to the first virtual content to a third visual prominence relative to the first virtual content, wherein the third visual prominence is greater than the second visual prominence, such as shown with respect to person 1308 from FIG. 13E to 13F. In some embodiments, the third visual prominence is the same as the first visual prominence. In some embodiments, the third visual prominence is less than or greater than the first visual prominence. Increasing the visual prominence of the first person in response to attention from the user facilitates interaction with the first person without the need for additional inputs.

In some embodiments, the one or more criteria are satisfied based on a degree of attention detected by the computer system (e.g., attention of the user and/or attention of the first person) being greater than a threshold degree of attention (1428), such as attention of user 1326 in FIG. 13F or attention of person 1306 in FIG. 13D. For example, the threshold degree of attention optionally requires one or more of (or more than a threshold number of the following being true, such as at least 2, 3, 4 or 5 of the following being true): attention of the user directed to the first person (optionally for longer than a time threshold, such as 0.1, 0.5, 1, 3, 5, 10, 30 or 60 seconds); attention of the first person directed to the user (optionally for longer than a time threshold, such as 0.1, 0.5, 1, 3, 5, 10, 30 or 60 seconds); orientation of the first person within a range of orientations (e.g., 1, 3, 5, 10, 30, 60, or 90 degrees) of being oriented towards the user; orientation of the user within a range of orientations (e.g., 1, 3, 5, 10, 30, 60, or 90 degrees) of being oriented towards the first person; and/or one or more of the factors described with reference to method 1400. Increasing the visual prominence of the first person based on an attention threshold reduces unwarranted reduction of visual prominence of the virtual content, and also increases the likelihood that interaction with the first person will happen after the reduction in the visual prominence of the virtual content, thereby avoiding instances of reducing the visual prominence of the virtual content unnecessarily.

In some embodiments, increasing the visual prominence of the first person relative to the first virtual content includes increasing the visual prominence of the first person relative to the first virtual content to a first visual prominence relative to the first virtual content (1430a) (e.g., such as described with reference to step(s) 1404). In some embodiments, while displaying, via the display generation component, the first virtual content, the computer system detects (1430b), via the one or more input devices, a respective person (e.g., the first person or a different person) located in a respective portion of the physical environment that is obscured by the first virtual content (e.g., in one or more of the ways described with reference to step(s) 1402), such as person 1306 in FIG. 13B. In some embodiments, in response to detecting the respective person in the respective portion of the physical environment, and in accordance with a determination that the respective person does not satisfy the one or more criteria, the computer system increases (1430c) a visual prominence of the respective person relative to the first virtual content to a second visual prominence relative to the first virtual content, less than the first visual prominence relative to the first virtual content, such as shown with respect to person 1306 in FIG. 13B (e.g., increasing the visual prominence of the respective person relative to the first virtual content optionally has one or more of the characteristics of increasing the visual prominence of the first person relative to the first content). In some embodiments, the computer system provides a relatively smaller increase in visual prominence for any person that is being obscured by the first virtual content, even when the attention-based criteria are not satisfied. In some embodiments, if the attention-based criteria are subsequently satisfied, the computer system optionally increases the visual prominence of the person to the first visual prominence relative to the first virtual content. Increasing the visual prominence of a person regardless of attention-based criteria being satisfied by that person or the user increases the likelihood that the user will notice the person and decreases the likelihood of collision with the person, while reducing disruption of display of the virtual content.

In some embodiments, increasing the visual prominence of the first person relative to the first virtual content includes increasing the visual prominence of the first person relative to the first virtual content to a first visual prominence relative to the first virtual content (1432a) (e.g., as described with reference to step(s) 1404), such as the prominence of person 1308 in FIG. 13E. In some embodiments, while the first person has the first visual prominence relative to the first virtual content, the computer system detects (1432b), via the one or more input devices, input from the user of the computer system, such as input from hand 1351 in FIG. 13F. In some embodiments, the input includes an air gesture, such as an air pinching gesture of the thumb and index finger of a hand of the user coming together and touching, while attention of the user is directed to a portion of content that is visible via the display generation component. In some embodiments, the input includes input from a contact detecting on a touch-sensitive surface in communication with the computer system. In some embodiments, the input includes the hand of a user directly interaction with the first virtual content.

In some embodiments, while (and/or in response to) detecting the input from the user of the computer system, and in accordance with a determination that the input from the user of the computer system satisfies one or more second criteria (e.g., as will be described with reference to step(s) 1434-1440), the computer system reduces (1432c) the visual prominence of the first person relative to the first virtual content, such as shown with respect to person 1308 in FIGS. 13G and 13G1 (e.g., at least partially reversing the increase of the visual prominence of the first person relative to the first virtual content). In some embodiments, if the input from the user of the computer system does not satisfy the one or more second criteria, the visual prominence of the first person relative to the first virtual content is maintained. In some embodiments, the input from the user is detected while attention of the user is directed to the first person and/or while the first person otherwise satisfies the one or more criteria (e.g., the attention-based criteria). In some embodiments, when the input ends (e.g., the fingers of the hand of the user move apart and are no longer touching each other, or the contact on the touch-sensitive surface ends and is no longer detecting on the touch-sensitive surface), the computer system optionally automatically increases the visual prominence of the first person relative to the first virtual content (e.g., to the first visual prominence) if the first person satisfies the one or more criteria after the end of the first input. Increasing the visual prominence of the virtual content in response to certain inputs reduces errors in interaction with the virtual content in connection with the certain inputs without the need for separate inputs to increase the visual prominence of the virtual content.

In some embodiments, the one or more second criteria include a criterion that is satisfied when the input from the user includes input for moving the first virtual content (1434), such as the movement of content 1304 from FIG. 13F to 13G. In some embodiments, an input for moving the first virtual content (optionally in a three-dimensional environment) includes the attention of the user being directed to the first virtual content while a hand of the user performs the air pinch gesture, followed by movement of the hand in the air pinch hand shape (e.g., while the thumb and index finger remain touching)—in which case the first virtual content is optionally moved in a direction and/or with a magnitude corresponding to a direction and/or magnitude of the movement of the hand. In some embodiments, the input for moving the first virtual content (optionally in a three-dimensional environment) includes a click and hold from a mouse directed to the first virtual content, followed by movement of the mouse while the click is held—in which case the first virtual content is optionally moved in a direction and/or with a magnitude corresponding to a direction and/or magnitude of the movement of the mouse. In some embodiments, the criterion is not satisfied when input from the user does not include input moving the first virtual content, such as attention of the user being directed to the first virtual content (e.g., without corresponding to a request to move the first virtual content), or input interacting with second virtual content, different from the first virtual content. Increasing the visual prominence of the virtual content in response to movement input reduces errors in moving the virtual content without the need for separate inputs to increase the visual prominence of the virtual content.

In some embodiments, the one or more second criteria include a criterion that is satisfied when the input from the user includes input for scrolling through the first virtual content (1436), such as if the input from hand 1351 in FIGS. 13G and 13G1 was a scrolling input. In some embodiments, the first virtual content is scrollable content. In some embodiments, the input for scrolling through the first virtual content has one or more of the characteristics described with reference to step(s) 1434, except that the resulting scrolling (rather than movement) optionally has direction and/or magnitude corresponding to a direction and/or magnitude of the movement in the input. In some embodiments, the criterion is not satisfied when input from the user does not include input scrolling through the first virtual content, such as attention of the user being directed to the first virtual content (e.g., without corresponding to a request to scroll through the first virtual content), or input interacting with second virtual content, different from the first virtual content. Increasing the visual prominence of the virtual content in response to scrolling input reduces errors in scrolling the virtual content without the need for separate inputs to increase the visual prominence of the virtual content.

In some embodiments, the one or more second criteria include a criterion that is satisfied when the input from the user includes input interacting with one or more controls associated with the first virtual content (1438), such as if the input from hand 1351 in FIGS. 13G and 13G1 was an input to interact with controls for content 1304. For example, the one or more controls are optionally displayed within and/or overlaid on the first virtual content, or are displayed external to (e.g., not overlaid on) the first virtual content. In some embodiments, the one or more controls are playback controls (e.g., play, pause, and/or skip) when the first virtual content includes media (e.g., video and/or audio content). In some embodiments, the one or more controls are controls for navigating through one or more user interfaces displayed in the first virtual content (e.g., back controls, forward controls, undo controls and/or redo controls). In some embodiments, the one or more controls control a state of and/or what is included in the first virtual content. In some embodiments, an input for interacting with (e.g., selecting) one of the controls includes the attention of the user being directed to a control while a hand of the user performs the air pinch gesture. In some embodiments, the input for interacting with (e.g., selecting) one of the controls includes a click from a mouse directed to the control. In some embodiments, the criterion is not satisfied when input from the user does not include input interacting with controls associated with the first virtual content, such as attention of the user being directed to the first virtual content (e.g., without corresponding to a request to interact with controls associated with the first virtual content), or input interacting with second virtual content, different from the first virtual content. Increasing the visual prominence of the virtual content in response to interaction with controls associated with the virtual content reduces errors in controlling the virtual content without the need for separate inputs to increase the visual prominence of the virtual content.

In some embodiments, the one or more second criteria include a criterion that is satisfied when the input from the user includes a portion of a body of the user (e.g., a hand of the user, a head of the user, the torso of the user and/or the shoulders of the user) being in a respective pose (1440), such as hand 1351 in FIGS. 13G and 13G1 being in the respective pose (e.g., being oriented towards the first virtual content, being in a ready state, and/or being raised (rather than by the side of the user)). In some embodiments, the respective pose is a pose from which input from the portion of the body can be provided to the computer system and/or directed to the first virtual content. In some embodiments, the criterion is not satisfied when the portion of the body of the user is not in the respective pose (e.g., is down by the side of the user, or is raised in front of the user but not in the ready state). Increasing the visual prominence of the virtual content in response to a portion of the user being in a respective pose reduces errors in future interaction with the first virtual content without the need for separate inputs to increase the visual prominence of the virtual content.

In some embodiments, the first virtual content is concurrently visible with a respective portion of an environment via the display generation component, such as shown with content 1304 and the physical environment in FIG. 13E. For example, the respective portion of the environment is optionally a portion of a physical environment of the user, or virtual content (e.g., a virtual environment, such as described with reference to step(s) 1402) other than the first virtual content.

In some embodiments, while the respective portion of the environment is visible with a first visual prominence relative to the environment (1442a) (e.g., as described with reference to step(s) 1404), the computer system detects (1442b), via the one or more input devices, attention of the user of the computer system directed to the first person (optionally for longer than a time threshold, such as 0.1, 0.5, 1, 3, 5, 10, 30 or 60 seconds), such as attention 1350 in FIG. 13F. In some embodiments, in response to detecting the attention of the user directed to the first person, the computer system increases (1442c) a visual prominence of the respective portion of the environment to a second visual prominence relative to the environment (e.g., in one or more of the ways described with reference to step(s) 1402), such as shown with the physical environment in three-dimensional environment 1302 in FIG. 13F. In some embodiments, before the attention of the user was detected as being directed to the first person, the computer system was at least partially obscuring visibility of the respective portion of the environment (e.g., by darkening, tinting, and/or blurring the respective portion of the environment), optionally while not at least partially obscuring visibility of the first virtual content. In some embodiments, in response to detecting the attention of the user directed to the first person, the computer system reduces or eliminates the obstruction of the visibility of the respective portion of the environment (e.g., by reducing or eliminating the darkening, the tinting and/or the blurring of the respective portion of the environment). Increasing the visual prominence of different parts of the environment in response to the attention of the user being directed to the first person facilitates discovery of the different parts of the environment during a time when it is likely that the user is receptive to such discovery, without the need for separate inputs from increasing the visual prominence in that way.

It should be understood that the particular order in which the operations in method 1400 have been described is merely exemplary and is not intended to indicate that the described order is the only order in which the operations could be performed. One of ordinary skill in the art would recognize various ways to reorder the operations described herein. In some embodiments, aspects/operations of methods 800, 1000, 1200, and/or 1400 may be interchanged, substituted, and/or added between these methods. For example, the three-dimensional environments of methods 800, 1000, 1200, and/or 1400, the virtual content of methods 800, 1000, 1200, and/or 1400, and/or increase or decrease prominence of virtual content in methods 800, 1000, 1200, and/or 1400 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-71. (canceled)

72. A method comprising:
at a computer system in communication with a display generation component and one or more input devices:
while displaying, via the display generation component, first virtual content, wherein the first virtual content is obscuring a first portion of a physical environment, detecting, via the one or more input devices, a first person located in the first portion of the physical environment; and
in response to detecting the first person in the first portion of the physical environment:
in accordance with a determination that the first person satisfies one or more criteria, wherein the one or more criteria indicate that the computer system has detected that attention of the first person is directed to a user of the computer system, increasing a visual prominence of the first person relative to the first virtual content; and
in accordance with a determination that the first person does not satisfy the one or more criteria, forgoing increasing the visual prominence of the first person relative to the first virtual content.

73. The method of claim 72, wherein increasing the visual prominence of the first person relative to the first virtual content includes increasing the visual prominence of the first person to a first visual prominence relative to the first virtual content, the method further comprising:
in response to detecting the first person in the first portion of the physical environment and before the first person satisfies the one or more criteria, increasing the visual prominence of the first person relative to the first virtual content to a second visual prominence relative to the first virtual content, wherein the second visual prominence is less than the first visual prominence.

74. The method of claim 72, wherein the one or more criteria include a criterion that is satisfied when the computer system has detected that gaze of the first person is directed to the user of the computer system.

75. The method of claim 72, wherein the one or more criteria include a criterion that is satisfied when the computer system has detected speech of the first person that satisfies one or more second criteria.

76. The method of claim 72, wherein the one or more criteria include a criterion that is satisfied when the computer system has detected a respective portion of a body of the first person that satisfies one or more second criteria.

77. The method of claim 76, wherein the criterion is satisfied when the computer system detects a distance of the respective portion of the body of the first person from the user of the computer system that is less than a threshold distance.

78. The method of claim 76, wherein the criterion is satisfied when the computer system detects an orientation of the respective portion of the body of the first person relative to the user of the computer system that is within a threshold orientation.

79. The method of claim 72, further comprising:
while displaying, via the display generation component, the first virtual content, detecting, via the one or more input devices, a respective person located in a respective portion of the physical environment that is obscured by the first virtual content; and
in response to detecting the respective person in the respective portion of the physical environment, and in accordance with a determination that the respective person satisfies the one or more criteria:
in accordance with a determination that a first setting of the computer system has a first value, increasing a visual prominence of the respective person relative to the first virtual content; and
in accordance with a determination that the first setting of the computer system has a second value, different from the first value, forgoing increasing the visual prominence of the respective person relative to the first virtual content.

80. The method of claim 79, further comprising:
displaying, via the display generation component, a control user interface for the computer system that includes a selectable option that is selectable to set the first value or the second value for the first setting.

81. The method of claim 72, wherein increasing the visual prominence of the first person relative to the first virtual content includes modifying a visual appearance of a respective portion of the first virtual content, wherein a shape of the respective portion of the first virtual content is asymmetrical along at least one axis.

82. The method of claim 72, wherein increasing the visual prominence of the first person relative to the first virtual content includes modifying a visual appearance of a respective portion of the first virtual content, the method further comprising:
while the first person satisfies the one or more first criteria and while the first person has the increased visual prominence relative to the first virtual content:
while the respective portion of the first virtual content is a first respective portion of the first virtual content that corresponds to a first location of the first person relative to the first virtual content, detecting, via the one or more input devices, movement of the first person from the first location relative to the first virtual content to a second location, different from the first location, relative to the first virtual content; and
in response to detecting the movement of the first person from the first location relative to the first virtual content to the second location relative to the first virtual content, modifying a visual appearance of a second respective portion of the first virtual content that corresponds to the second location of the first person relative to the first virtual content.

83. The method of claim 72, wherein increasing the visual prominence of the first person relative to the first virtual content includes:
increasing the visual prominence of the first person relative to the first virtual content to a first visual prominence relative to the first virtual content; and
after increasing the visual prominence of the first person relative to the first virtual content to the first visual prominence, gradually decreasing the visual prominence of the first person relative to the first virtual content from the first visual prominence to a second visual prominence relative to the first virtual content.

84. The method of claim 83, further comprising:
while the visual prominence of the first person relative to the first virtual content is the second visual prominence relative to the first virtual content, detecting, via the one or more input devices, attention of the user of the computer system directed to the first person; and
in response to detecting the attention of the user of the computer system directed to the first person, increasing the visual prominence of the first person relative to the first virtual content to a third visual prominence relative to the first virtual content, wherein the third visual prominence is greater than the second visual prominence.

85. The method of claim 83, wherein the one or more criteria are satisfied based on a degree of attention detected by the computer system being greater than a threshold degree of attention.

86. The method of claim 72, wherein increasing the visual prominence of the first person relative to the first virtual content includes increasing the visual prominence of the first person relative to the first virtual content to a first visual prominence relative to the first virtual content, the method further comprising:
while displaying, via the display generation component, the first virtual content, detecting, via the one or more input devices, a respective person located in a respective portion of the physical environment that is obscured by the first virtual content; and
in response to detecting the respective person in the respective portion of the physical environment, and in accordance with a determination that the respective person does not satisfy the one or more criteria, increasing a visual prominence of the respective person relative to the first virtual content to a second visual prominence relative to the first virtual content, less than the first visual prominence relative to the first virtual content.

87. The method of claim 72, wherein increasing the visual prominence of the first person relative to the first virtual content includes increasing the visual prominence of the first person relative to the first virtual content to a first visual prominence relative to the first virtual content, the method further comprising:
while the first person has the first visual prominence relative to the first virtual content, detecting, via the one or more input devices, input from the user of the computer system; and
while detecting the input from the user of the computer system, and in accordance with a determination that the input from the user of the computer system satisfies one or more second criteria, reducing the visual prominence of the first person relative to the first virtual content.

88. The method of claim 87, wherein the one or more second criteria include a criterion that is satisfied when the input from the user includes input for moving the first virtual content.

89. The method of claim 87, wherein the one or more second criteria include a criterion that is satisfied when the input from the user includes input for scrolling through the first virtual content.

90. The method of claim 87, wherein the one or more second criteria include a criterion that is satisfied when the input from the user includes input interacting with one or more controls associated with the first virtual content.

91. The method of claim 87, wherein the one or more second criteria include a criterion that is satisfied when the input from the user includes a portion of a body of the user being in a respective pose.

92. The method of claim 72, wherein the first virtual content is concurrently visible with a respective portion of an environment via the display generation component, the method further comprising:
while the respective portion of the environment is visible with a first visual prominence relative to the environment, detecting, via the one or more input devices, attention of the user of the computer system directed to the first person; and
in response to detecting the attention of the user directed to the first person, increasing a visual prominence of the respective portion of the environment to a second visual prominence relative to the environment.

93. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while displaying, via the display generation component, first virtual content, wherein the first virtual content is obscuring a first portion of a physical environment, detecting, via the one or more input devices, a first person located in the first portion of the physical environment; and
in response to detecting the first person in the first portion of the physical environment:
in accordance with a determination that the first person satisfies one or more criteria, wherein the one or more criteria indicate that the computer system has detected that attention of the first person is directed to a user of the computer system, increasing a visual prominence of the first person relative to the first virtual content; and
in accordance with a determination that the first person does not satisfy the one or more criteria, forgoing increasing the visual prominence of the first person relative to the first virtual content.

94. A non-transitory computer readable storage medium storing one or more programs, the one or more programs comprising instructions, which when executed by one or more processors of a computer system that is in communication with a display generation component and one or more input devices, cause the computer system to perform a method comprising:
while displaying, via the display generation component, first virtual content, wherein the first virtual content is obscuring a first portion of a physical environment, detecting, via the one or more input devices, a first person located in the first portion of the physical environment; and
in response to detecting the first person in the first portion of the physical environment:
in accordance with a determination that the first person satisfies one or more criteria, wherein the one or more criteria indicate that the computer system has detected that attention of the first person is directed to a user of the computer system, increasing a visual prominence of the first person relative to the first virtual content; and
in accordance with a determination that the first person does not satisfy the one or more criteria, forgoing increasing the visual prominence of the first person relative to the first virtual content.

95-98. (canceled)
